(19) United States
(12) Patent Application Publication
(10) Pub. No.: US 2025/0358077 A1
(43) Pub. Date: Nov. 20, 2025

(54) METHOD AND APPARATUS FOR ENERGY SAVINGS IN WIRELESS COMMUNICATION SYSTEM

(71) Applicant: SAMSUNG ELECTRONICS CO., LTD., Suwon-si (KR)

(72) Inventors: Jaewon LEE, Suwon-si (KR); Youngbum KIM, Suwon-si (KR); Junyung YI, Suwon-si (KR); Hyoungju JI, Suwon-si (KR); Seunghoon CHOI, Suwon-si (KR)

(21) Appl. No.: 19/209,603

(22) Filed: May 15, 2025

(30) Foreign Application Priority Data
May 17, 2024 (KR) 10-2024-0064581

(51) Int. Cl. H04L 5/00; H04W 56/00

(52) U.S. Cl. CPC H04L 5/0055; H04W 56/002

(57) ABSTRACT

The disclosure relates to a 5G or 6G communication system for supporting a higher data transmission rate. The present disclosure relates to a method and apparatus for transmitting an uplink signal of a terminal in a wireless communication system. According to an embodiment of the disclosure, a method performed by a terminal in a wireless communication system, the method comprising: receiving, from a first base station, configuration information on an on-demand SSB; receiving, from the first base station, a first message indicating a reception of the on-demand SSB; transmitting, to the first base station, an acknowledgement message as a response to the first message; and receiving, from a second base station, the on-demand SSB based on the configuration information after at least one slot from a slot in which the acknowledgement message is transmitted.

### CROSS-REFERENCE TO RELATED APPLICATION(S)

This application is based on and claims priority under 35 U.S.C. § 119 to Korean Patent Application No. 10-2024-0064581, filed on May 17, 2024, in the Korean Intellectual Property Office, the disclosure of which is herein incorporated by reference in its entirety.

### BACKGROUND

### 1. Field

The disclosure relates to a wireless communication system and, more particularly, to a method and an apparatus for energy saving of a base station in a wireless communication system.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Embodiments set forth herein are to provide an apparatus and a method capable of effectively providing services in a wireless communication system.

The technical subjects pursued in the disclosure may not be limited to the above-mentioned matters, and other technical subjects which are not mentioned herein may be considered from the following description of various embodiments of the disclosure by those skilled in the art to which the disclosure pertains.

According to an embodiment of the disclosure, a method performed by a terminal in a wireless communication system, the method comprising: receiving, from a first base station, configuration information on an on-demand synchronization signal block (SSB); receiving, from the first base station, a first message indicating a reception of the on-demand SSB; transmitting, to the first base station, an acknowledgement message as a response to the first message; and receiving, from a second base station, the on-demand SSB based on the configuration information after at least one slot from a slot in which the acknowledgement message is transmitted.

According to an embodiment of the disclosure, a method performed by a first base station in a wireless communication system, the method comprising: transmitting, to a terminal, configuration information on an on-demand synchronization signal block (SSB); transmitting, to the terminal, a first message indicating a transmission of the on-demand SSB; and receiving, from the terminal, an acknowledgement message as a response to the first message, wherein the on-demand SSB based on the configuration information is transmitted after at least one slot from a slot in which the acknowledgement message is received.

According to an embodiment of the disclosure, a terminal in a wireless communication system, the terminal comprising: a transceiver; and at least one processor coupled with the transceiver and configured to: receive, from a first base station, configuration information on an on-demand synchronization signal block (SSB), receive, from the first base station, a first message indicating a reception of the on-demand SSB, transmit, to the first base station, an acknowledgement message as a response to the first message, and receive, from a second base station, the on-demand SSB based on the configuration information after at least one slot from a slot in which the acknowledgement message is transmitted.

According to an embodiment of the disclosure, a first base station in a wireless communication system, the base station comprising: a transceiver; and at least one processor coupled with the transceiver and configured to: transmit, to a terminal, configuration information on an on-demand synchronization signal block (SSB), transmit, to the terminal, a first message indicating a transmission of the on-demand SSB, and receive, from the terminal, an acknowledgement message as a response to the first message, wherein the on-demand SSB based on the configuration information is transmitted after at least one slot from a slot in which the acknowledgement message is received.

The aforementioned various embodiments of the disclosure are merely some of preferred embodiments of the disclosure, and various embodiments reflecting technical features of the various embodiments of the disclosure may be derived and understood by those having ordinary skill in the art based on the detailed descriptions to be described below.

Embodiments set forth herein provide an apparatus and a method capable of effectively providing services in a wireless communication system.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a basic structure of a time-frequency resource domain in a 5G system according to an embodiment of the disclosure;

FIG. 2 illustrates a beam sweeping operation and a time domain mapping structure of a synchronization signal according to an embodiment of the disclosure;

FIG. 3 illustrates a random access procedure according to an embodiment of the disclosure;

FIG. 4 illustrates a procedure in which a UE reports UE capability information to a base station according to an embodiment of the disclosure;

FIG. 5 illustrates a CORESET as a time-frequency resource to which a PDCCH is mapped according to an embodiment of the disclosure;

FIG. 6 illustrates mapping of DCI and a DMRS in an REG which is a basic unit of a downlink control channel according to an embodiment of the disclosure;

FIG. 7 illustrates base station beam allocation according to a TCI state configuration according to an embodiment of the disclosure;

FIG. 8 illustrates a hierarchical signaling method for dynamic allocation with regard to a PDCCH according to an embodiment of the disclosure;

FIG. 9 illustrates a TCI indication MAC CE signaling structure for a PDCCH DMRS according to an embodiment of the disclosure;

FIG. 10 illustrates a method in which a base station and a UE transmit/receive data in consideration of a downlink data channel and a rate matching resource according to an embodiment of the disclosure;

FIG. 11 illustrates an aperiodic CSI reporting method in a case where a CSI-RS offset is 0 according to an embodiment of the disclosure;

FIG. 12 illustrates an aperiodic CSI reporting method in a case where a CSI-RS offset is 1 according to an embodiment of the disclosure;

FIG. 13 illustrates a bandwidth part configuration in a 5G communication system according to an embodiment of the disclosure;

FIG. 14 illustrates a DRX in a 5G communication system according to an embodiment of the disclosure;

FIG. 15 illustrates an applicable SCell activation procedure according to an embodiment of the disclosure;

FIG. 16 illustrates a transmission of a normal synchronization signal by an SCell, which has not been transmitting a downlink synchronization signal, when a UE activates the SCell before a configured on-demand synchronization signal end time after an on-demand synchronization signal trigger, according to an embodiment of the disclosure;

FIG. 17 illustrates a case where FIG. 16 is extended to multiple UEs according to an embodiment of the disclosure;

FIG. 18 illustrates a point in time when a UE receives an on-demand downlink synchronization signal after receiving an on-demand downlink synchronization signal trigger according to an embodiment of the disclosure;

FIG. 19 illustrates a situation where occasions of on-demand downlink synchronization signals, normal downlink synchronization signals, and NES downlink synchronization signals are shared, according to an embodiment of the disclosure; and

FIG. 20 illustrates a situation where occasions of on-demand downlink synchronization signals, normal downlink synchronization signals, and NES downlink synchronization signals are not shared, according to an embodiment of the disclosure.

FIG. 21 illustrates a UE transceiving device according to an embodiment of the disclosure;

FIG. 22 illustrates a UE according to an embodiment of the disclosure; and

FIG. 23 illustrates a base station according to an embodiment of the disclosure.

### DETAILED DESCRIPTION

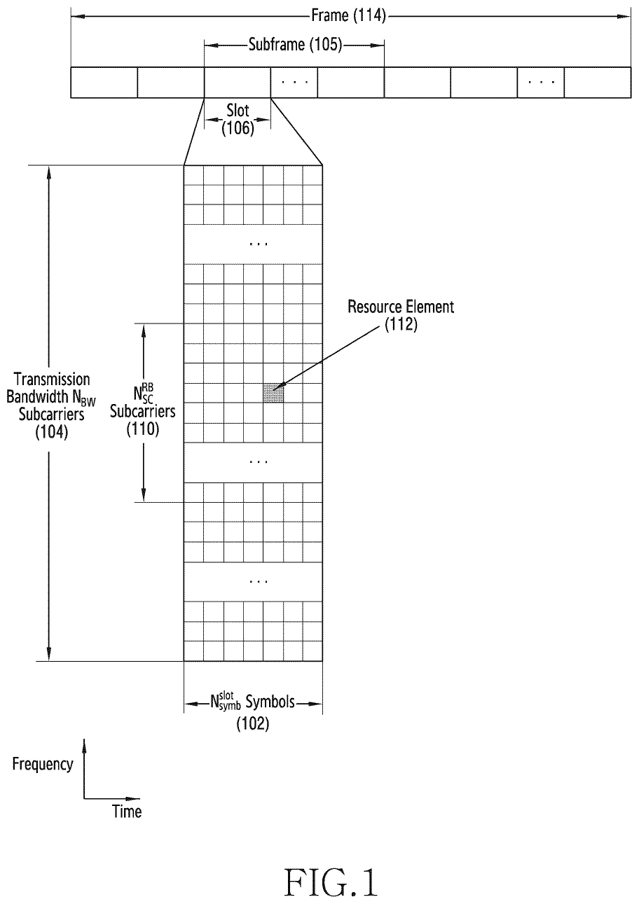

FIGS. 1 through 23, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings. In describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit,” or divided into a larger number of elements, or a “unit.” Moreover, the elements and “units” may be implemented to reproduce one or more CPUs within a device or a security multimedia card. Furthermore, the “unit” in embodiments may include one or more processors.

In the following description of the disclosure, a detailed description of known functions or configurations incorporated herein will be omitted when it is determined that the description may make the subject matter of the disclosure unnecessarily unclear. Hereinafter, embodiments of the disclosure will be described with reference to the accompanying drawings.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description, the terms “physical channel” and “signal” may be interchangeably used with the term “data” or “control signal.” For example, the term “physical downlink shared channel (PDSCH)” refers to a physical channel over which data is transmitted, but the PDSCH may also be used to refer to the “data.” That is, in the disclosure, the expression “transmit ting a physical channel” may be construed as having the same meaning as the expression “transmitting data or a signal over a physical channel.”

In the following description of the disclosure, higher layer signaling refers to a signal transfer scheme from a base station to a terminal via a downlink data channel of a physical layer, or from a terminal to a base station via an uplink data channel of a physical layer. The higher layer signaling may also be understood as radio resource control (RRC) signaling or a media access control (MAC) control element (CE).

In the following description, terms and names defined in the 3GPP new radio (3GPP NR: 5th generation mobile communication standards) will be used for the sake of descriptive convenience. However, the disclosure is not limited by these terms and names, and may be applied in the same way to systems that conform other standards. In addition, the term “terminal” may refer to not only cellular phones, smartphones, IoT devices, and sensors, but also other wireless communication devices.

In the following description, a base station is an entity that allocates resources to terminals, and may be at least one of a gNode B, a gNB, an eNode B, an eNB, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. Of course, examples of the base station and the terminal are not limited to those mentioned above.

In order to process mobile data traffic which has recently increased exponentially, initial standards of new radio (NR) access technology or 5th generation (5G) systems which are next-generation communication systems after long term evolution (LTE) (or evolved universal terrestrial radio access (E-UTRA)) and LTE-advanced (LTE-A) (or E-UTRA evolution) have been completed. While legacy mobile communication systems have focused on voice/data communication, 5G systems aim to satisfy various services and requirements, such as an enhanced mobile broadband (eMBB) service for improving legacy voice/data communication, an ultra-reliable and low latency communication (URLLC) service, and a massive machine type communication (MTC) service supporting massive machine-to-machine communication.

The system transmission bandwidth per single carrier of legacy LTE and LTE-A is limited to a maximum of 20 MHz, but 5G systems aim to provide super-fast data services up to multiple Gbps by using super-broad bandwidths far wider than the same. Accordingly, 5G systems consider super-high-frequency bands ranging from multiple GHz to a maximum of 100 GHz, in which it is relatively easy to secure super-broad-bandwidth frequencies, as candidate frequencies. Additionally, it is possible to secure broad-bandwidth frequencies for 5G systems through frequency rearrangement or allocation among frequency bands ranging from hundreds of MHz to multiple GHz used in legacy mobile communication systems.

Radio waves in ultrahigh frequency bands have millimeter-level wavelengths and thus are also referred to as millimeter waves (mm Wave). However, the pathloss of radio waves in ultrahigh frequency bands increases in proportion to the frequency band, thereby reducing the coverage of the mobile communication systems.

In order to overcome the shortcoming of coverage reduction in ultrahigh frequency bands, a beamforming technology is applied such that the distance reached by radio waves is increased by concentrating the energy radiated by the radio waves at a specific target point by using multiple antennas. That is, signals to which the beamforming technology is applied have a smaller beam width, and radiated energy is concentrated within the smaller beam width, thereby increasing the distance reached by radio waves. The beamforming technology may be applied to each of transmission and reception ends. In addition to the increased coverage, the beamforming technology is also advantageous in that interference is reduced in regions in directions other than the beamforming direction. Appropriate operations of the beamforming technology perform a method for accurately measuring transmitted/received beams and sending feedback. The beamforming technology may be applied to a control channel or a data channel having one-to-one correspondence between a given UE and a given base station. In addition, the beamforming technology may also be applied to a control channel and a data channel for transmitting a common signal transmitted from a base station to multiple UEs in the system, such as a synchronization signal, a physical broadcast channel (PBCH), and system information, in order to increase the coverage. If the beamforming technology is applied to a common signal, a beam sweeping technology is additionally applied such that the signal is transmitted after changing the beam direction, thereby ensuring that the common signal can reach a UE existing at a specific location inside the cell.

As another requirement of 5G systems, an ultra-low latency service is provided such that the transmission delay between the transmission and reception ends is about 1 ms or less. In an attempt to reduce the transmission delay, there is a need for frame structure design based on a shorter transmission time interval (TTI) than LTE and LTE-A. The TTI is the basic time unit for performing scheduling, and legacy LTE and LTE-A have a TTI of Ims, which corresponds to the length of one subframe. For example, the short TTI, on which 5G systems are based in order to meet the requirement regarding the ultra-low latency service, may be 0.5 ms, 0.25 ms, 0.125 ms, or the like, which is shorter than legacy LTE and LTE-A.

The disclosure provides a method and an apparatus for energy saving in a wireless communication system.

A method for transmitting and receiving a signal by a UE in a wireless communication system according to an embodiment of the disclosure includes: synchronizing with a first cell; receiving, from the first cell, a first control signal including information on a cell controllable by the first cell; and based on the first control signal, transmitting data to a second cell. Various embodiments of the disclosure below are merely some of preferred embodiments of the disclosure, and various embodiments reflecting technical features of the various embodiments of the disclosure may be derived and understood by those having ordinary skill in the art based on the detailed descriptions to be described below.

According to an embodiment of the disclosure, the problem of excessive power consumption can be solved and a high energy efficiency can be achieved by defining a signal transmission method of a base station.

Advantageous effects obtainable from various embodiments of the disclosure may not be limited to the above-mentioned effects, and other effects which are not mentioned may be clearly derived and understood, based on the following descriptions, by those skilled in the art to which the disclosure pertains.

FIG. 1 illustrates a basic structure of a time-frequency resource domain in a 5G system according to an embodiment of the disclosure. That is, FIG. 1 illustrates a basic structure of a time-frequency resource domain which is a radio resource domain used to transmit data or control channels in a 5G system.

Referring to FIG. 1, the horizontal axis in FIG. 1 denotes the time domain, and the vertical axis denotes the frequency domain. The minimum transmission unit in the time domain of the 5G system is an orthogonal frequency division multiplexing (OFDM) symbol, a group of

$${N}_{symb}^{slot}$$

symbols 102 may constitute one slot 106, and a group of

$${N}_{slot}^{subframe}$$

slots may constitute one subframe 105. The length of the subframe may be 1.0 ms, and a group of ten subframes may constitute a 10 ms frame 114. The minimum transmission unit in the frequency domain is a subcarrier, and a total of NBW subcarriers 104 may constitute the entire system transmission bandwidth.

The basic unit of resources in the time-frequency domain is a resource element (RE) 112, which may be represented by an OFDM symbol index and a subcarrier index. A resource block (RB) or a physical resource block (PRB) may be defined by

$${N}_{SC}^{RB}$$

consecutive subcarriers 110 in the frequency domain. In the 5G system,

$${N}_{SC}^{RB} = 12 ,$$

and the data rate may increase in proportion to the number of RBs scheduled for a UE.

In the 5G system, a base station may map data in units of RBs, and may generally schedule RBs constituting one slot with regard to a specific UE. That is, the basic time unit to perform scheduling in 5G systems may be a slot, and the basic frequency unit to perform scheduling may be an RB.

The number of OFDM symbols,

$${N}_{symb}^{slot} ,$$

is determined according to the length of a cyclic prefix (CP) which is added to each symbol in order to prevent inter-symbol interference. For example, if a normal CP is applied,

$${N}_{symb}^{slot} = 14$$

and, if an atomic CP is applied,

$${N}_{symb}^{slot} = 12.$$

The extended CP is applied to a system having a longer radio-wave transmission distance than for the normal CP, thereby maintaining inter-symbol orthogonality. In the case of the normal CP, the ratio between the CP length and the symbol length may be maintained at a constant value such that the overhead due to the CP remains constant regardless of the subcarrier spacing. That is, the symbol length may increase if the subcarrier spacing decreases, thereby increasing the CP length. To the contrary, the symbol length may decrease if the subcarrier spacing increases, thereby decreasing the CP length. The symbol length and the CP length may be inversely proportional to the subcarrier spacing.

In order to satisfy various services and requirements in 5G systems, various frame structures may be supported by adjusting the subcarrier spacing. For example,
In terms of the operating frequency band, the larger the subcarrier spacing, the more advantageous for restoration of phase noise in high-frequency bands.
In terms of the transmission time, the larger the subcarrier spacing, the smaller the symbol length in the time domain, and thus the resulting smaller slot length makes it more advantageous to support a super-low-latency service such as URLLC.
In terms of the cell size, the larger the CP length, the larger cell can be supported, meaning that the smaller the subcarrier spacing, the larger cell can be supported. The term “cell” refers to a region covered by one base station in connection with mobile communication.

The subcarrier spacing, the CP length, and the like correspond to information indispensable to OFDM transmission/reception, and a gNB and a UE need to recognize the subcarrier spacing, the CP length, and the like as mutually common values such that efficient transmission/reception is possible. Table 1 describes the relationship between the subcarrier spacing configuration (μ), the subcarrier spacing (Δf), and the CP length supported in the 5G system.

TABLE 1

| μ | Δf = 2^{μ}*15[kHz] | Cyclic prefix |
|---|---|---|
| 0 | 15 | Normal |
| 1 | 30 | Normal |
| 2 | 60 | Normal, |
| | | Extended |
| 3 | 120 | Normal |
| 4 | 240 | Normal |

Table 2 enumerates the number

$$( {N}_{symb}^{slot} )$$

of symbols per one slot, the number

$$( {N}_{slot}^{frame , μ} )$$

of slots per one frame, and the number

$$( {N}_{slot}^{subframe , μ} )$$

of slots per one subframe with regard to each subcarrier spacing configuration (μ) in the case of a normal CP.

TABLE 2

| μ | ${N}_{symb}^{slot}$ | ${N}_{slot}^{frame , μ}$ | ${N}_{slot}^{subframe , μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 3 enumerates the number

$$( {N}_{symb}^{slot} )$$

of symbols per one slot, the number

$$( {N}_{slot}^{frame , μ} )$$

of symbols per one frame, the number

$$( {N}_{slot}^{subframe , μ} )$$

of symbols per one subframe, the number regard to each subcarrier spacing configuration (μ) in the case of an extended CP.

TABLE 3

| μ | ${N}_{symb}^{slot}$ | ${N}_{slot}^{frame , μ}$ | ${N}_{slot}^{subframe , μ}$ |
|---|---|---|---|
| 2 | 12 | 40 | 4 |

It is expected that the 5G system, in the early state of introduction, will at least coexist with legacy LTE and/or LTE-A (hereinafter, referred to as LTE/LTE-A) systems or operate in a dual mode. Accordingly, legacy LTE/LTE-A may provide UEs with stable system operations, and the 5G system may play the role of providing UEs with improved services. Therefore, the frame structure of the 5G system needs to at least include the frame structure of LTE/LTE-A or a necessary parameter set (subcarrier spacing=15 kHz).

For example, a comparison between a frame structure having a subcarrier spacing configuration μ=0 (hereinafter, frame structure A) and a frame structure having a subcarrier spacing configuration μ=1 (hereinafter, frame structure B) shows that, compared with frame structure A, frame structure B has double the subcarrier spacing and the RB size, and has half the slot length and the symbol length. In the case of frame structure B, two slots may constitute one subframe, and 20 subframes may constitute one frame.

To generalize the frame structure of the 5G system, the subcarrier spacing, the CP length, the slot length, and the like, which constitute a necessary parameter set, of respective frame structures are related so as to correspond to integer multiples with each other, thereby providing a high degree of extendibility. In addition, a subframe having a fixed length of about 1 ms may be defined to express a reference time unit unrelated to the frame structure.

The frame structure may be applied according to various scenarios. In terms of the cell size, the larger the CP length, the larger cells can be supported, meaning that frame structure A may support larger cells than frame structure B. In terms of the operating frequency band, the larger the subcarrier spacing, the more advantageous to high-frequency-band phase noise restoration, meaning that frame structure B may support a higher operating frequency than frame structure A. In terms of the service, the smaller the slot length (basic time unit of scheduling), the more advantageous for supporting an ultra-low latency service (for example, URLLC). Therefore, frame structure B may be more appropriate for the URLLC service than frame structure A.

As used in the following description of the disclosure, the uplink (UL) may refer to a radio link via which a UE transmits data or control signals to a base station, and the downlink (DL) may refer to a radio link via which the base station transmits data or control signals to the UE.

In an initial access step in which the UE initially accesses a system, the UE may perform downlink time and frequency domain synchronization and acquire a cell identifier (ID) from asynchronization signal, transmitted by a base station, through a cell search. In addition, the UE may receive a physical broadcast channel (PBCH) by using the acquired cell ID and acquire a master information block (MIB) as mandatory system information from the PBCH. Additionally, the UE may receive system information (system information block (SIB)) transmitted by the base station to acquire cell-common transmission and reception-related control information. The cell-common transmission and reception-related control information may include random-access-related control information, paging-related control information, common control information for various physical channels, etc.

Asynchronization signal is a signal that serves as a reference for a cell search, and for each frequency band, a subcarrier spacing may be applied adaptively to a channel environment, such as phase noise. For a data channel or a control channel, in order to support various services as described above, a subcarrier spacing may be applied differently depending on a service type.

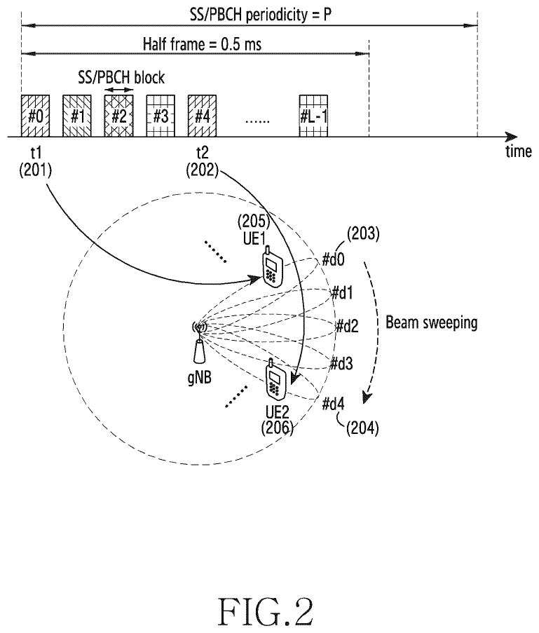

FIG. 2 illustrates a beam sweeping operation and a time domain mapping structure of a synchronization signal according to an embodiment of the disclosure.

For the sake of description, the following elements may be defined.
Primary synchronization signal (PSS): A PSS is a signal that serves as a reference for DL time/frequency synchronization, and provides a part of cell ID information.
Secondary synchronization signal (SSS): An SSS serves as a reference for DL time/frequency synchronization, and provides the other part of the cell ID information. Additionally, the SSS may serve as a reference signal for PBCH demodulation of a PBCH.
Physical broadcast channel (PBCH): A PBCH provides a master information block (MIB) which is essential system information for transmission and reception of a data channel and a control channel of a UE. The mandatory system information may include search space-related control information indicating radio resource mapping information of a control channel, scheduling control information for a separate data channel for transmission of system information, a system frame number (SFN) which is a frame unit index that serves as a timing reference, and other information.
Synchronization signal/PBCH block (SS/PBCH block) or SSB: An SS/PBCH block is configured by N OFDM symbols and may include a combination of a PSS, an SSS, a PBCH, etc. For a system to which a beam sweeping technology is applied, an SS/PBCH block may be a minimum unit to which beam sweeping is applied. In the 5G system, N=4 may be satisfied. A base station may transmit up to a maximum of L SS/PBCH blocks, and the L SS/PBCH blocks may be mapped within a half frame (0.5 ms). In addition, the L SS/PBCH blocks are periodically repeated at predetermined periods P. The base station may inform a user equipment of period P via signaling. If there is no separate signaling of period P, the UE may apply a previously agreed default value.

FIG. 2 illustrates an example in which beam sweeping is applied in units of SS/PBCH blocks over time. In the example of FIG. 2, UE 1 205 may receive an SS/PBCH block by means of a beam emitted in direction #d0 203 by beamforming applied to SS/PBCH block #0 at time point t1 201. In addition, UE 2 206 receives an SS/PBCH block by means of a beam emitted in direction #d4 204 by beamforming applied to SS/PBCH block #4 at time point t2 202. The UE may acquire, from the base station, an optimal synchronization signal via a beam emitted in the direction where the UE is located. For example, it may be difficult for UE 1 205 to acquire time/frequency synchronization and mandatory system information from the SS/PBCH block through the beam emitted in direction #d4 far away from the location of UE 1.

In addition to the initial access procedure, for the purpose of determining whether the radio link quality of a current cell is maintained at a certain level or higher, the UE may also receive the SS/PBCH block. Furthermore, during a handover procedure in which the UE moves access from the current cell to an adjacent cell, the UE may receive an SS/PBCH block of the adjacent cell in order to determine the radio link quality of the adjacent cell and acquire time/frequency synchronization with the adjacent cell.

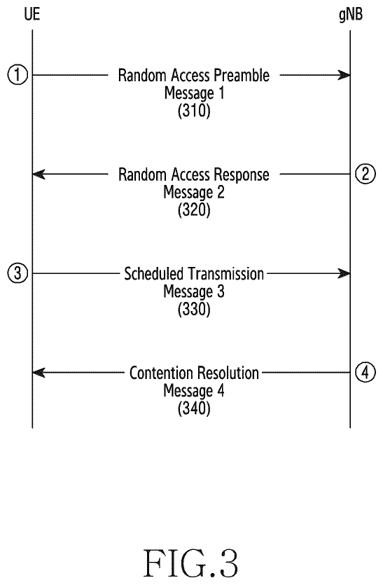

After acquiring an MIB and system information from the base station through the initial access procedure, the UE may perform a random access procedure in order to switch a link to the base station to a connected state (or RRC_CONNECTED state). Upon completing the random access procedure, the UE switches to a connected state in which one-to-one communication between the base station and the UE is possible. Hereinafter, a random access procedure will be described in detail with reference to FIG. 3.

FIG. 3 illustrates a random access procedure according to an embodiment of the disclosure. FIG. 3 illustrates an example of a random access procedure, and the disclosure in not limited thereto. Furthermore, the disclosure is not limited to a 4-step random access procedure as illustrated in FIG. 3, and may be applied to a 2-step random access procedure (transmission/reception of message A (message including information corresponding to message 1 and message 3) and transmission/reception of message B (message including information corresponding to message 2 and message 4)).

Referring to FIG. 3, in a first step 310 of the random access procedure, the UE transmits a random access preamble to the base station. The random access preamble, which is a message initially transmitted by the UE in the random access procedure, may be referred to as message 1. The base station may measure the transmission delay value between the UE and the base station from the random access preamble, and may make uplink synchronization. The UE may arbitrarily select which random access preamble is to be used, from a random access preamble set given by system information in advance. In addition, the initial transmission power of the random access preamble may be determined according to the pathloss between the base station and the UE, which is measured by the UE. Furthermore, the UE may determine the transmission beam direction of the random access preamble from a synchronization signal received from the base station, thereby transmitting the random access preamble.

In a second step 320, the base station transmits an uplink transmission timing adjustment command to the UE, based on the transmission delay value measured from the random access preamble received in the first step 310. The base station may also transmit a command to control power and uplink resources to be used by the UE, as scheduling information. The scheduling information may include control information regarding the UE's uplink transmission beam.

If the UE fails to receive a random access response (RAR) (or message 2) which is scheduling information regarding message 3 from the gNB within a predetermined time in the second step 320, the UE may conduct the first step 310 again. If performing the first step 310 again, the UE may transmit the random access preamble after increasing the transmission power thereof by a predetermined step (power ramping), thereby increasing the probability that the base station will receive the random access preamble.

In a third step 330, the UE transmits uplink data (message 3) including the UE's ID to the base station through a physical uplink shared channel (PUSCH) by using the uplink resource assigned in the second step 320. The transmission timing of the PUSCH for transmitting message 3 may follow the timing control command received from the base station in the second step 320. In addition, the transmission power of the PUSCH for transmitting message 3 may be determined in consideration of a power control command received from the base station in the second step 320 and the power ramping value of the random access preamble. The uplink data channel for transmitting message 3 may refer to the first uplink data signal transmitted to the base station by the UE, after transmission of the random access preamble by the UE.

In a fourth step 340, upon determining that the UE has performed a random access without colliding with other UEs, the base station may transmit data (message 4) including the ID of the UE which has transmitted uplink data in the third step 330 to the corresponding UE. Upon receiving the signal transmitted by the base station in the fourth step 340 from the base station, the UE may determine that the random access is successful. In addition, the UE may transmit HARQ-ACK information to the base station through a physical uplink control channel (PUCCH) to indicate whether message 4 is successfully received or not.

If the base station fails to receive a data signal from the UE due to collision between data transmitted by the UE in the third step 330 and data from another UE, the base station may not transmit data to the UE any longer. In this case, if the UE fails to receive data transmitted from the base station in the fourth step 340 within a predetermined period of time, the UE may determine that the random access procedure is unsuccessful, and may restart from the first step 310.

Upon successfully completing the random access procedure, the UE is switched to a connected state, and one-to-one communication between the base station and the UE becomes possible. The base station may receive UE capability information reported by the UE in the connected state, and may adjust the scheduling with reference to the UE capability information from the UE. The UE may inform the base station whether the UE itself supports a specific function or not, the maximum allowed value of the function supported by the UE, and the like through the UE capability information. Therefore, UE capability information reported to the base station by each UE may have a different value with regard to each UE.

As an example, the UE may report UE capability information including at least one of the following pieces of control information as UE capability information to the gNB:
Control information regarding the frequency band supported by the UE;
Control information regarding the channel bandwidth supported by the UE;
Control information regarding the maximum modulation scheme supported by the UE;
Control information regarding the maximum number of beams supported by the UE;
Control information regarding the maximum number of layers supported by the UE;
Control information regarding CSI reporting supported by the UE;
Control information regarding whether the UE supports frequency hopping;
Control information regarding the bandwidth when carrier aggregation (CA) is supported; and/or
Control information regarding whether cross carrier scheduling is supported when CA is supported.

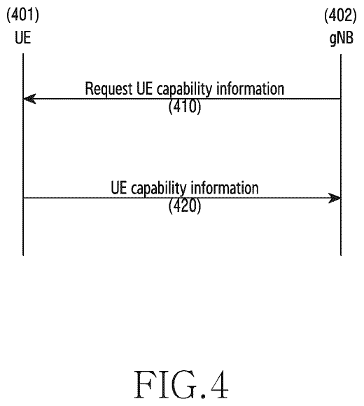

FIG. 4 illustrates a procedure in which a UT reports UE capability information to a base station according to an embodiment of the disclosure.

Referring to FIG. 4, in step 410, the base station 402 may transmit a UE capability information request message to the UE 401. At the UE capability information request of the base station, the UE transmits UE capability information to the base station in step 420.

Through the above-described process, the UE connected to the base station may perform one-to-one communication as a UE in an RRC_CONNECTED state. To the contrary, the UE having no connection may be a UE in an RRC_IDLE state, and operations of the UE in the RRC_IDLE state may be distinguished as follows:
A UE-specific discontinuous reception (DRX) cycle operation configured by the higher layer;
An operation of receiving a paging message from the core network;
Acquiring system information; and/or
A neighboring cell-related measurement operation and cell reselection.

In the 5G system, a new UE state referred to as RRC_INACTIVE has been defined to reduce the energy and time consumed for the UE's initial access. The RRC_INACTIVE UE may perform the following operations in addition to operations performed by an RRC_IDLE UE:
Storing access stratum (AS) information necessary for cell access;
A UE-specific DRX cycle operation configured by the RRC layer;
Configuring a RAN-based notification area (RNA) which may be utilized during a handover by the RRC layer, and periodically performing update; and/or
Monitoring a RAN-based paging message transmitted through an I-RNTI.

Hereinafter, a scheduling method in which the base station transmits downlink data to the UE, or instructs the UE to transmit uplink data, will be described.

Downlink control information (DCI) refers to control information transmitted to from the base station to a UE through the downlink, and may include downlink data scheduling information or uplink data scheduling information regarding a specific UE. In general, the base station may independently channel-code DCI with regard to each UE and may transmit the same to each UE through a physical downlink control channel (PDCCH).

With regard to a UE to be scheduled, the base station may apply and operate a predetermined DCI format according to the purpose, such as whether the same is scheduling information regarding downlink data (downlink assignment), whether the same is scheduling information regarding uplink data (uplink grant), or whether the same is DCI for power control.

The base station may transmit downlink data to the UE through a physical downlink shared channel (PDSCH). Scheduling information such as detailed mapping locations in time and frequency domains of the PDSCH, the modulation scheme, HARQ-related control information, and power control information, may be provided from the base station to the UE through DCI related to downlink data scheduling information among DCI transmitted through a PDCCH.

The UE may transmit uplink data to the gNB through a physical uplink shared channel (PUSCH). Scheduling information such as detailed mapping locations in time and frequency domains of the PUSCH, the modulation scheme, HARQ-related control information, and power control information, may be provided from the base station to the UE through DCI related to uplink data scheduling information among DCI transmitted through a PDCCH.

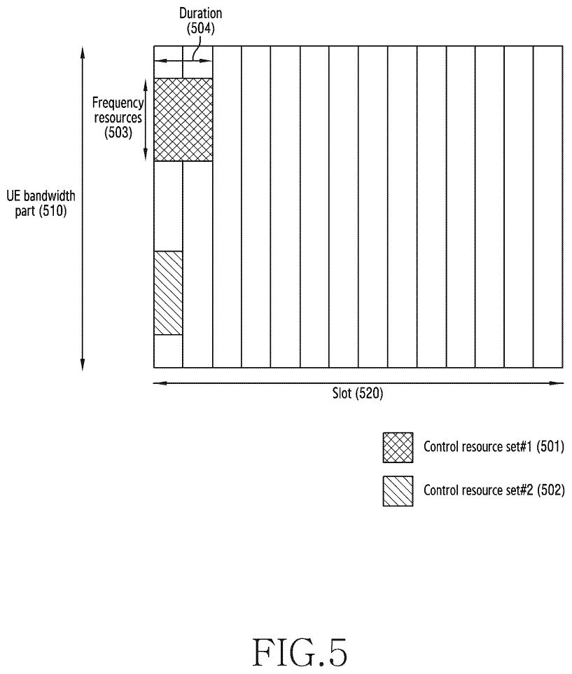

FIG. 5 illustrates a control resource set (CORESET) as a time-frequency resource to which a PDCCH is mapped according to an embodiment of the disclosure.

Referring to FIG. 5, a UE bandwidth part 510 may be configured along the frequency axis, and two control resource sets (control resource set #1 501 and control resource set #2 502) may be configured within one slot 520 along the time axis. The control resource sets 501 and 502 may be configured in a specific frequency resource 503 within the entire UE bandwidth part 510 along the frequency axis. The control resource sets may be each configured as one or multiple OFDM symbols along the time domain, and the number of the OFDM symbols may be defined as a control resource set duration 504.

Control resource set #1 501 may be configured to have a control resource set duration corresponding to two symbols, and control resource set #2 502 may be configured to have a control resource set duration corresponding to one symbol.

The base station may configure one CORESET or multiple CORESETs for the UE through upper layer signaling (for example, system information, master information block (MIB), radio resource control (RRC) signaling). The description that a CORESET is configured for the UE may mean that information such as the CORESET identity, the CORESET's frequency location, and the CORESET's symbol length is provided thereto. Pieces of information provided to the UE by the gNB in order to configure a CORESET may include at least some of the pieces of information included in [Table 4].

TABLE 4

| ControlResourceSet ::= | SEQUENCE { | |
|---|---|---|
| controlResourceSetId | ControlResourceSetId, | |
| frequencyDomainResources | BIT STRING (SIZE (45)), | |
| duration | INTEGER (1..maxCoReSetDuration), | |
| cce-REG-MappingType | CHOICE { | |
| interleaved | SEQUENCE { | |
| reg-BundleSize | ENUMERATED {n2, n3, n6}, | |
| interleaverSize | ENUMERATED {n2, n3, n6}, | |
| shiftIndex | INTEGER(0..maxNrofPhysicalResourceBlocks−1) | OPTIONAL -- |

Need S
},

| | |
|---|---|
| nonInterleaved | NULL |

},

| | |
|---|---|
| precoderGranularity | ENUMERATED {sameAsREG-bundle, allContiguousRBs}, |
| tci-StatesPDCCH-ToAddList | SEQUENCE(SIZE (1..maxNrofTCI-StatesPDCCH)) OF T |

CI-StateId OPTIONAL, -- Cond NotSIB1-initialBWP
tci-StatesPDCCH-ToReleaseList SEQUENCE(SIZE (1..maxNrofTCI-StatesPDCCH)) OF TC
I-StateId OPTIONAL, -- Cond NotSIB1-initialBWP

| | | |
|---|---|---|
| tci-PresentInDCI | ENUMERATED {enabled} | OPTIONAL, -- Need S |
| pdcch-DMRS-ScramblingID | INTEGER (0..65535) | OPTIONAL, -- Need S |

}

The CORESET may be configured by

$${N}_{RB}^{CORESET}$$

RBs in the frequency domain and may be configured by

$${N}_{symb}^{CORESET}$$

∈{1,2,3} symbols in the time domain. An NR PDCCH may be configured by one or multiple control channel elements (CCEs). One CCE may be configured by six resource element groups (REGs), and each REG may be defined as one RB during one OFDM symbol. In one CORESET, REGs may be indexed in the time-first order, starting from REG index 0 in the CORESET's first OFDM symbol/lowest RB.

As a PDCCH-related transmission method, an interleaved type and a non-interleaved type may be supported. The base station may configure, for the UE, whether interleaved or non-interleaved transmission is performed with regard to each CORESET through upper layer signaling. Interleaving may be performed at the REG bundle level. The REG bundle may be defined as one REG or a set of multiple REGs. The UE may determine the CCE-to-REG type in the corresponding CORESET, based on the configuration by the base station regarding whether transmission is of the interleaved type or the non-interleaved type, in a manner as in [Table 5] below.

```
TABLE 5
The CCE-to-REG mapping for a control-resource set can be interleaved or non-inter-
leaved and is described by REG bundles:
  - REG bundle i is defined as REGs {iL, iL + 1, ... , iL + L − 1} where L is the REG
    $bundle size , i = 0 , 1 , … , {N}_{REG}^{CORESET} / L - 1 , and {N}_{RBG}^{CORESET} = {N}_{RB}^{CORESET} {N}_{symb}^{CORESET}$
    is the number of REGs in the CORESET
  - CCE j comprises REG bundles {f(6j/L), f(6j/L + 1), ... , f(6j/L + 6/L − 1)}
    where f(·)is an interleaver
For non-interleaved CCE-to-REG mapping, L = 6 and f(x) = x.
For interleaved CCE-to-REG mapping, L ∈ {2, 6}for
${N}_{symb}^{CORESET} = 1 and L ∈ \{ {N}_{symb}^{CORESET} , 6 \} for {N}_{symb}^{CORESET} ∈ \{ 2 , 3 \} . The interleaver is defined by$
$f ( x ) = ( rC + c + {n}_{shift} ) mod ( {N}_{RBG}^{CORESET} / L )$
x = cR + r
r = 0, 1, ... , R − 1
c = 0, 1, ... , C − 1
$C = {N}_{RBG}^{CORESET} / ( LR )$
where R ∈ {2, 3, 6}.
```

The base station may provide the UE with configuration information regarding to which symbol the PDCCH is mapped in the slot, the transmission period, and the like through signaling.

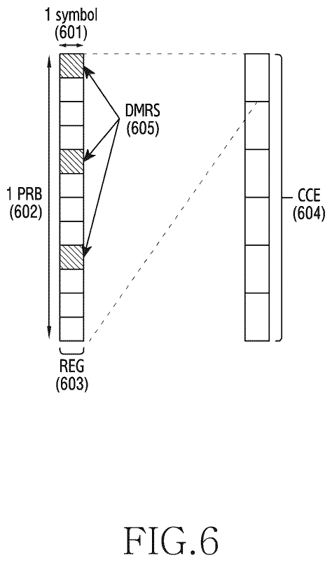

FIG. 6 illustrates mapping of DCI and a DMRS in an REG which is a basic unit of a downlink control channel according to an embodiment of the disclosure.

Referring to FIG. 6, the basic unit of the downlink control channel, that is, the REG 603, may include both REs to which DCI is mapped, and an area to which a reference signal (DMRS 605) for decoding the same is mapped. In addition, three DRMSs 605 may be transmitted inside one REG 603.

Hereinafter, a PDCCH search space will be described. The number of CCEs necessary to transmit a PDCCH may be 1, 2, 4, 8, or 16 according to aggregation levels (ALs), and different number of CCEs may be used to implement link adaption of a downlink control channel. For example, in the case of ALL, one downlink control channel may be transmitted through L CCEs. The UE performs blind decoding for detecting a signal while being no information regarding the downlink control channel, and to this end, a search space indicating a set of CCEs may be defined. The search space is a set of downlink control channel candidates including CCEs which the UE needs to attempt to decode at a given AL, and since 1, 2, 4, 8, or 16 CCEs may constitute a bundle at various ALs, the UE may have multiple search spaces. A search space set may be defined as a set of search spaces at all configured aggregation levels.

The search spaces may be classified into common search spaces (CSSs) and UE-specific search spaces (USSs). A group of UEs or all UEs may search a common search space of the PDCCH in order to receive cell-common control information such as dynamic scheduling regarding system information (SIB) or a paging message. For example, the UE may receive PDSCH scheduling allocation information for reception of system information by searching the common search space for the PDCCH. In the case of a common search space, a group of UEs or all UEs need to receive the PDCCH, and the common search space may thus be defined as a predetermined set of CCEs. Scheduling allocation information regarding a UE-specific PDSCH or PUSCH may be received by searching the UE-specific search space for the PDCCH. The UE-specific search space may be defined UE-specifically as a function of various system parameters and the identity (ID) of the UE.

Configuration information of the search space for the PDCCH may be configured for the UE by the base station through upper layer signaling (e.g., SIB, MIB, or RRC signaling). For example, the base station may provide the UE with configurations such as the number of PDCCH candidates at each aggregation level L, the monitoring cycle regarding the search space, the monitoring occasion with regard to each symbol in a slot regarding the search space, the search space type (common search space or UE-specific search space), a combination of an RNTI and a DCI format to be monitored in the corresponding search space, a control resource set (CORESET) index for monitoring the search space, and the like. For example, parameters of the search space for the PDCCH may include the following pieces of information given in Table 6 below.

TABLE 6

| SearchSpace ::= | SEQUENCE | |
|---|---|---|
| searchSpaceId | SearchSpaceId, | |
| controlResourceSetId | ControlResourceSetId | OPTIONAL, -- Cond SetupOnly |

monitoringSlotPeriodicityAndOffset CHOICE {

| sl1 | NULL, | |
|---|---|---|
| sl2 | INTEGER (0..1), | |
| sl4 | INTEGER (0..3), | |
| sl5 | INTEGER (0..4), | |
| sl8 | INTEGER (0..7), | |
| sl10 | INTEGER (0..9), | |
| sl16 | INTEGER (0..15), | |
| sl20 | INTEGER (0..19), | |
| sl40 | INTEGER (0..39), | |
| sl80 | INTEGER (0..79), | |
| sl160 | INTEGER (0..159), | |
| sl320 | INTEGER (0..319), | |
| sl640 | INTEGER (0..639), | |
| sl1280 | INTEGER (0..1279), | |
| sl2560 | INTEGER (0..2559) | |
| } | OPTIONAL, -- Cond Setup | |
| duration | INTEGER (2..2559) | OPTIONAL, -- Need R |
| monitoringSymbolsWithinSlot | BIT STRING (SIZE (14)) | OPTIONAL, -- Cond Setup |

| | |
|---|---|
| nrofCandidates | SEQUENCE { |
| aggregationLevel1 | ENUMERATED {n0, n1, n2, n3, n4, n5, n6, n8}, |
| aggregationLevel2 | ENUMERATED {n0, n1, n2, n3, n4, n5, n6, n8}, |
| aggregationLevel4 | ENUMERATED {n0, n1, n2, n3, n4, n5, n6, n8}, |
| aggregationLevel8 | ENUMERATED {n0, n1, n2, n3, n4, n5, n6, n8}, |
| aggregationLevel16 | ENUMERATED {n0, n1, n2, n3, n4, n5, n6, n8} |
| } | OPTIONAL, -- Cond Setup |
| searchSpaceType | CHOICE { |
| common | SEQUENCE { |
| dci-Format0-0-AndFormat1-0 | SEQUENCE { |

...

| } | OPTIONAL, -- Need R | |
|---|---|---|
| dci-Format2-0 | SEQUENCE { | |
| nrofCandidates-SFI | SEQUENCE { | |
| aggregationLevel1 | ENUMERATED {n1, n2} | OPTIONAL, -- Need R |
| aggregationLevel2 | ENUMERATED {n1, n2} | OPTIONAL, -- Need R |
| aggregationLevel4 | ENUMERATED {n1, n2} | OPTIONAL, -- Need R |
| aggregationLevel8 | ENUMERATED {n1, n2} | OPTIONAL, -- Need R |
| aggregationLevel16 | ENUMERATED {n1, n2} | OPTIONAL -- Need R |

```
        },
        ...
```

| | |
|---|---|
| } | OPTIONAL, -- Need R |
| dci-Format2-1 | SEQUENCE { |

...

| | |
|---|---|
| } | OPTIONAL, -- Need R |
| dci-Format2-2 | SEQUENCE { |

...

| | |
|---|---|
| } | OPTIONAL, -- Need R |
| dci-Format2-3 | SEQUENCE { |
| dummy1 | ENUMERATED {sl1, sl2, sl4, sl5, sl8, sl10, sl16, sl20} OPTIONAL, - |

- Cond Setup

| | |
|---|---|
| dummy2 | ENUMERATED {n1, n2}, |

...

| | |
|---|---|
| } | OPTIONAL -- Need R |

},

| | |
|---|---|
| ue-Specific | SEQUENCE { |
| dci-Formats | ENUMERATED {formats0-0-And-1-0, formats0-1-And-1-1}, |

```
      ...,
    }
```

| | |
|---|---|
| } | OPTIONAL -- Cond Setup2 |

}

According to configuration information, the base station may configure one or multiple search space sets for the UE. According to some embodiments, the base station may configure search space set 1 and search space set 2 for the UE. In search space set 1, the UE may be configured to monitor DCI format A scrambled by an X-RNTI in a common search space, and in search space set 3, the UE may be configured to monitor DCI format B scrambled by a Y-RNTI in a UE-specific search space.

According to configuration information, one or multiple search space sets may exist in a common search space or a UE-specific search space. For example, search space set #1 and search space set #2 may be configured as a common search space, and search space set #3 and search space set #4 may be configured as a UE-specific search space.

In a common search space, the UE may monitor combinations of DCI formats and RNTIs given below. Obviously, the examples given below are not limiting:
DCI format 0_0/1_0 with CRC scrambled by C-RNTI, CS-RNTI, SP-CSI-RNTI, RA-RNTI, TC-RNTI, P-RNTI, SI-RNTI;
DCI format 2_0 with CRC scrambled by SFI-RNTI;
DCI format 2_1 with CRC scrambled by INT-RNTI;
DCI format 2_2 with CRC scrambled by TPC-PUSCH-RNTI, TPC-PUCCH-RNTI;
DCI format 2_3 with CRC scrambled by TPC-SRS-RNTI;
DCI format 2_4 with CRC scrambled by CI-RNTI;
DCI format 2_5 with CRC scrambled by AI-RNTI;
DCI format 2_6 with CRC scrambled by PS-RNTI; and/or
DCI format 2_7 with CRC scrambled by PEI-RNTI.

In a UE-specific search space, the UE may monitor combinations of DCI formats and RNTIs given below. Obviously, the examples given below are not limiting:
DCI format 0_0/1_0 with CRC scrambled by C-RNTI, CS-RNTI, TC-RNTI; and/or
DCI format 1_0/1_1 with CRC scrambled by C-RNTI, CS-RNTI, TC-RNTI.

The RNTIs enumerated above may follow the definition and usage given below:
Cell RNTI (C-RNTI): used to schedule a UE-specific PDSCH;
Temporary cell RNTI (TC-RNTI): used to schedule a UE-specific PDSCH;
Configured scheduling RNTI (CS-RNTI): used to schedule a semi-statically configured UE-specific PDSCH;
Random access RNTI (RA-RNTI): used to schedule a PDSCH in a random access step
Paging RNTI (P-RNTI): used to schedule a PDSCH in which paging is transmitted;
System information RNTI (SI-RNTI): used to schedule a PDSCH in which system information is transmitted;
Interruption RNTI (INT-RNTI): used to indicate whether a PDSCH is punctured;
Transmit power control for PUSCH RNTI (TPC-PUSCH-RNTI): used to indicate a power control command regarding a PUSCH;
Transmit power control for PUCCH RNTI (TPC-PUCCH-RNTI): used to indicate a power control command regarding a PUCCH; and/or

Transmit power control for SRS RNTI (TPC-SRS-RNTI): used to indicate a power control command regarding an SRS.

The DCI formats enumerated above may follow the definitions given in Table 7 below.

TABLE 7

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and |
| | OFDM symbol(s) where UE may assume no |
| | transmission is intended for the UE |
| 2_2 | Transmission of TPC commands for PUCCH and PUSCH |
| 2_3 | Transmission of a group of TPC commands for |
| | SRS transmissions by one or more UEs |
| 2_4 | Notifying the PRB(s) and OFDM symbol(s) where UE |
| | cancels the corresponding UL transmission from the UE |
| 2_5 | Notifying the availability of soft resources |
| 2_6 | Notifying the power saving information outside |
| | DRX Active Time for one or more UEs |
| 2_7 | Notifying paging early indication and TRS |
| | availability indication for one or more UEs. |
| 3_0 | Scheduling of NR sidelink in one cell |
| 3_1 | Scheduling of LTE sidelink in one cell |
| 4_0 | Scheduling of PDSCH with CRC scrambled by |
| | MCCH-RNTI/G-RNTI for broadcast |
| 4_1 | Scheduling of PDSCH with CRC scrambled by |
| | G-RNTI/GCS-RNTI for multicast |
| 4_2 | Scheduling of PDSCH with CRC scrambled by |
| | G-RNTI/GCS-RNTI for multicast |

The search space at aggregation level L in connection with CORESET p and search space set s may be expressed by the following equation.

$$L \cdot \{ ( {Y}_{p , {n}_{s f}^{μ}} + ⌊ \frac{{m}_{s , {n}_{CI}} \cdot {N}_{C C E , p}}{L \cdot {M}_{s , max}^{( L )}} ⌋ + {n}_{CI} ) mod ⌊ \frac{{N}_{C C E , p}}{L} ⌋ \} + i \qquad [ Equation 1 ]$$

L: aggregation level;
n_{CI}: carrier index;
N_{CCE,p}: total number of CCEs existing in control resource set p;

$$- {n}_{s , f}^{μ} :$$

slot index;

$$- {M}_{s , max}^{( L )}$$

number or run CH candidates at aggregation level L;

$$- {m}_{s , {n}_{CI}} = 0 , … , {M}_{s , max}^{( L )} - 1 :$$

PDCCH candidate index at aggregation level L;
i=0, . . . , L−1;

$${Y}_{p , {n}_{s , f}^{μ}} = ( {A}_{p} \cdot {Y}_{p , {n}_{s , f}^{μ} - 1} ) mod D , {Y}_{p ,} - 1 = {n}_{RNTI} \neq 0 , {A}_{p} = 39827 for pmod 3 = 0 , {A}_{p} = 39829 for pmod 3 = 1 , {A}_{p} = 39839 for pmod 3 = 2 , D = 65537 ;$$

and
n_{RNTI}: UE identity.

The

$${Y}_{p , {n}_{s , f}^{μ}}$$

value muy vunespund w vm the case of a common search space.

The

$${Y}_{p , {n}_{s , f}^{μ}}$$

value changed by the UE's identity (C-RNTI or ID configured for the UE by the base station) and the time index in the case of a UE-specific search space.

Hereinafter, a method of configuring a TCI state with regard to a PDCCH (or PDCCH DMRS) in the 5G communication system will be described.

It may be possible for the base station to configure or indicate a TCI state with regard to a PDCCH (or PDCCH DMRS) via appropriate signaling. According the above description, it may be possible for the base station to configure or indicate a TCI state with regard to a PDCCH (or PDCCH DMRS) via appropriate signaling. A TCI state is for announcing the QCL relation between a PDCCH (or a PDCCH DRMS) and another RS or channel, and the description that a reference antenna port A (reference RS #A) and another target antenna port B (target RS #B) are QCLed with each other means that the UE is allowed to apply some or all of large-scale channel parameters estimated in the antenna port A to channel measurement form the antenna port B. The QCL needs to be associated with different parameters according to the situation such as 1) time tracking influenced by average delay and delay spread, 2) frequency tracking influenced by Doppler shift and Doppler spread, 3) radio resource management (RRM) influenced by average gain, or 4) beam management (BM) influenced by a spatial parameter. According to, four types of QCL relations are supported in NR as in Table 8 below. Obviously, the examples given below are not limiting.

TABLE 8

| QCL type | Large-scale characteristics |
|---|---|
| A | Doppler shift, Doppler spread, |
| | average delay, delay spread |
| B | Doppler shift, Doppler spread |
| C | Doppler shift, average delay |
| D | Spatial Rx parameter |

The spatial RX parameter may refer to some or all of various parameters as a whole, such as angle of arrival (AoA), power angular spectrum (PAS) of AoA, angle of departure (AoD), PAS of AoD, transmit/receive channel correlation, transmit/receive beamforming, and spatial channel correlation.

The QCL relations may be configured for the UE through RRC parameter TCI-state and QCL-info as in Table 9 below. Referring to Table 9, the base station may configure one or more TCI states for the UE, thereby informing of a maximum of two kinds of QCL relations (qcl-Type1, qcl-Type2) regarding the RS that refers to the ID of the TCI state, that is, the target RS. Each piece of QCL information (QCL-Info) that each TCI state may include the serving cell index and the BWP index of the reference RS indicated by the corresponding QCL information, the type and ID of the reference RS, and a QCL type as in Table 8 above.

TABLE 9

| TCI-State ::= | SEQUENCE { | |
|---|---|---|
| tci-StateId | TCI-StateId, | |
| qcl-Type1 | QCL-Info, | |
| qcl-Type2 | QCL-Info | OPTIONAL, -- Need R |

...
}

| QCL-Info ::= | SEQUENCE { | |
|---|---|---|
| cell | ServCellIndex | OPTIONAL, -- Need R |
| bwp-Id | BWP-Id | OPTIONAL, -- Cond |

CSI-RS-Indicated

| | |
|---|---|
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, typeD}, |

...
}

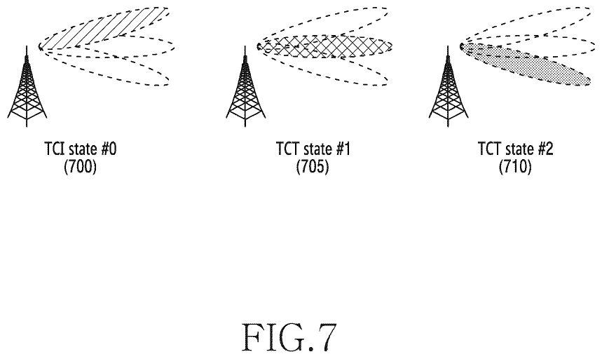

FIG. 7 illustrates base station beam allocation according to a TCI state configuration according to an embodiment of the disclosure.

Referring to FIG. 7, the base station may transfer information regarding N different beams to the UE through N different TCI states. For example, in the case of N=3 as in FIG. 7, the base station may configure qcl-Type2 parameters included in three TCI states 700, 705, and 710 in QCL type D while being associated with CSI-RSs or SSBs corresponding to different beams, thereby notifying that antenna ports referring to the different TCI states 700, 705, and 710 are associated with different spatial Rx parameters (that is, different beams).

Specific TCI state combinations applicable to a PDCCH DMRS antenna port may be given in Table 10 below. The fourth row in Table 10 corresponds to a combination assumed by the UE before RRC configuration, and no configuration is possible after the RRC. Obviously, the examples given below are not limiting.

TABLE 10

| Valid TCI | | | DL RS 2 | qcl-Type2 |
|---|---|---|---|---|
| state | | | (if | (if |
| Configuration | DL RS 1 | qcl-Type1 | configured) | configured) |
| 1 | TRS | QCL- | TRS | QCL- |
| | | TypeA | | TypeD |
| 2 | TRS | QCL- | CSI-RS (BM) | QCL- |
| | | TypeA | | TypeD |
| 3 | CSI-RS | QCL- | | |
| | (CSI) | TypeA | | |
| 4 | SS/PBCH | QCL- | SS/PBCH | QCL- |
| | Block | TypeA | Block | TypeD |

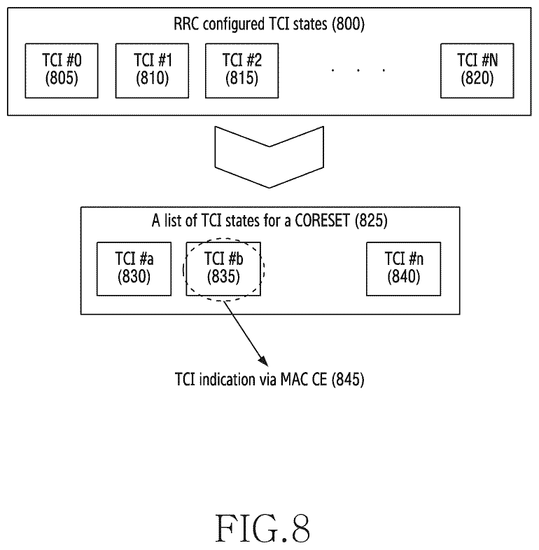

In NR, a hierarchical signaling method as illustrated in FIG. 8 may be supported for dynamic allocation regarding a PDCCH beam.

FIG. 8 illustrates a hierarchical signaling method for dynamic allocation with regard to a PDCCH according to an embodiment of the disclosure.

Referring to FIG. 8, the base station may configure NTCI states 805, 810, . . . , 820 for the UE through RRC signaling 800, and may configure some thereof as TCI states for a CORESET (825). The base station may then indicate one of the TCI states 830, 835, and 840 for the CORESET to the UE through MAC CE signaling (845). The UE may then receive a PDCCH, based on beam information included in the TCI state indicated by the MAC CE signaling.

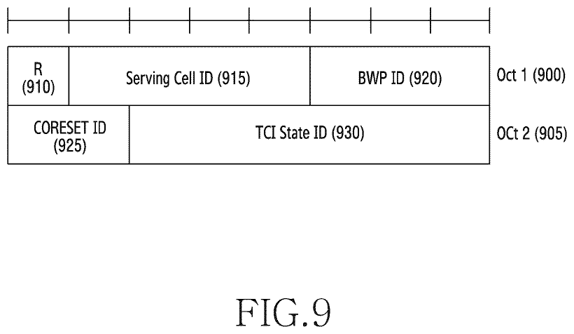

FIG. 9 illustrates a TCI indication MAC CE signaling structure for a PDCCH DMRS according to an embodiment of the disclosure.

Referring to FIG. 9, the TCI indication MAC CE signaling for the PDCCH DMRS may be configured by 2 bytes (16 bits), and include a 1-bit reserved bit 910, a 5-bit serving cell ID 915, a 2-bit BWP ID 920, a 2-bit CORESET ID 925, and a 6-bit TCI state ID 930.

The base station may indicate one of TCI state lists included in a CORESET configuration through MAC CE signaling. Until a different TCI state is indicated for the corresponding CORESET through different MAC CE signaling, the UE may consider that identical QCL information is applied to all of one or more search spaces connected to the CORESET.

The above-described PDCCH beam allocation method may have a problem in that it is difficult to indicate a beam change faster than MAC CE signaling delay, and the same beam is unilaterally applied to each CORESET regardless of search space characteristics, thereby making flexible PDCCH beam operation difficult. Following embodiments of the disclosure provide a more flexible PDCCH beam configuration and operation method. Although multiple distinctive examples will be provided for convenience of description of embodiments of the disclosure, they are not mutually exclusive, and can be combined and applied appropriately for each situation.

The base station may configure one or multiple TCI states for the UE with regard to a specific control resource set, and may activate one of the configured TCI states through a MAC CE activation command. For example, if {TCI state #0, TCI state #1, TCI state #2} are configured as TCI states for control resource set #1, the base station may transmit an activation command to the UE through a MAC CE such that TCI state #0 is assumed as the TCI state regarding control resource set #1. That is, based on the activation command regarding the TCI state received through the MAC CE, the UE may correctly receive the DMRS of the corresponding CORESET, based on QCL information in the activated TCI state.

With regard to a control resource set having a configured index of 0 (control resource set #0), if the UE has failed to receive a MAC CE activation command regarding the TCI state of control resource set #0, the UE may assume that the DMRS transmitted in control resource set #0 has been QCL-ed with a SS/PBCH block (SSB) identified in the initial access process or in a non-contention-based random access process not triggered by a PDCCH command.

With regard to a control resource set having a configured index value (X) other than 0 (control resource set #X), if the UE has no TCI state configured regarding control resource set #X, or if the UE has one or more TCI states configured therefore but has failed to receive a MAC CE activation command for activating one of the TCI states, the UE may assume that the DMRS transmitted in control resource set #X has been QCL-ed with a SS/PBCH block identified in the initial access process.

Next, downlink control information (DCI) in a 5G system will be described in detail.

In a 5G system, scheduling information regarding uplink data (or physical uplink shared channel (PUSCH)) or downlink data (or physical downlink shared channel (PDSCH)) may be transferred from a base station to a UE through DCI. The UE may monitor, with regard to the PUSCH or PDSCH, a fallback DCI format and a non-fallback DCI format. The fallback DCI format may include a fixed field predefined between the base station and the UE, and the non-fallback DCI format may include a configurable field.

The DCI may be subjected to channel coding and modulation processes and then transmitted through a physical downlink control channel (PDCCH) after a channel coding and modulation process. A cyclic redundancy check (CRC) may be attached to the payload of a DCI message, and the CRC may be scrambled by a radio network temporary identifier (RNTI) corresponding to the identity of the UE. Different RNTIs may be used according to the purpose of the DCI message, for example, UE-specific data transmission, power control command, or random access response. That is, the RNTI may not be explicitly transmitted, but may be transmitted while being included in a CRC calculation process. Upon receiving a DCI message transmitted through the PDCCH, the UE may identify the CRC by using the allocated RNTI, and if the CRC identification result is right, the UE may know that the corresponding message has been transmitted to the UE.

For example, DCI for scheduling a PDSCH regarding system information (SI) may be scrambled by an SI-RNTI. DCI for scheduling a PDSCH regarding a random access response (RAR) message may be scrambled by an RA-RNTI. DCI for scheduling a PDSCH regarding a paging message may be scrambled by a P-RNTI. DCI for notifying of a slot format indicator (SFI) may be scrambled by an SFI-RNTI. DCI for notifying of transmit power control (TPC) may be scrambled by a TPC-RNTI. DCI for scheduling a UE-specific PDSCH or PUSCH may be scrambled by a cell RNTI (C-RNTI).

DCI format 0_0 may be used as fallback DCI for scheduling a PUSCH, and in this case, the CRC may be scrambled by a C-RNTI. DCI format 0_0 in which the CRC is scrambled by a C-RNTI may include the following pieces of information given in Table 11 below, for example.

```
TABLE 11
- Identifier for DCI formats - 1 bit
  - The value of this bit field is always set to 0, indicating an UL DCI format
$‐ Frequency domain resource assignment - ⌈ {log}_{2} ( {N}_{RB}^{UL , BWP} ( {N}_{RB}^{UL , BWP} + 1 ) / 2 ) ⌉$
  bits where N_{RB}^{UL,BWP} is defined in subclause 7.3.1.0
  - For PUSCH hopping with resource allocation type 1:
    - N_{UL}_hop MSB bits are used to indicate the frequency offset according to
    Subclause 6.3 of [6, TS 38.214], where N_{UL-hop} = 1 if the higher layer
    parameter frequencyHoppingOffsetLists contains two offset values and N_{UL-hop} =
    2 if the higher layer parameter frequencyHoppingOffsetLists contains four
    offset values
    $‐ ⌈ {log}_{2} ( {N}_{RB}^{UL , BWP} ( {N}_{RB}^{UL , BWP} + 1 ) / 2 ) ⌉ - {N}_{UL \_ hop} bits provides the frequency$
    domain resource allocation according to Subclause 6.1.2.2.2 of [6, TS 38.214]
  - For non-PUSCH hopping with resource allocation type 1:
    $‐ ⌈ {log}_{2} ( {N}_{RB}^{UL , BWP} ( {N}_{RB}^{UL , BWP} + 1 ) / 2 ) ⌉ bits provides the frequency domain$
    resource allocation according to Subclause 6.1.2.2.2 of [6, TS 38.214]
- Time domain resource assignment - 4 bits as defined in Subclause 6.1.2.1 of
  [6, TS 38.214]
- Frequency hopping flag - 1 bit according to Table 7.3.1.1.1-3, as defined in
  Subclause 6.3 of [6, TS 38.214]
- Modulation and coding scheme - 5 bits as defined in Subclause 6.1.4.1 of
  [6, TS 38.214]
- New data indicator - 1 bit
- Redundancy version - 2 bits as defined in Table 7.3.1.1.1-2
- HARQ process number - 4 bits
- TPC command for scheduled PUSCH - 2 bits as defined in Subclause 7.1.1 of
  [5, TS 38.213]
- Padding bits, if required.
- UL/SUL indicator - 1 bit for UEs configured with supplementaryUplink in Serving
  CellConfig in the cell as defined in Table 7.3.1.1.1-1 and the number of bits for
  DCI format 1_0 before padding is larger than the number of bits for DCI format 0_0
  before padding; 0 bit otherwise. The UL/SUL indicator, if present, locates in the
  last bit position of DCI format 0_0, after the padding bit(s).
  - If the UL/SUL indicator is present in DCI format 0_0 and the higher layer
    parameter pusch-Config is not configured on both UL and SUL the UE ignores the
    UL/SUL indicator field in DCI format 0_0, and the corresponding PUSCH
    scheduled by the DCI format 0_0 is for the UL or SUL for which high layer
    parameter pucch-Config is configured;
  - If the UL/SUL indicator is not present in DCI format 0_0 and pucch-Config is
    configured, the corresponding PUSCH scheduled by the DCI format 0_0 is for
    the UL or SUL for which high layer parameter pucch-Config is configured.
  - If the UL/SUL indicator is not present in DCI format 0_0 and pucch-Config is
    not configured, the corresponding PUSCH scheduled by the DCI format 0_0 is
    for the uplink on which the latest PRACH is transmitted.
```

DCI format 0_1 may be used as non-fallback DCI for scheduling a PUSCH, and in this case, the CRC may be scrambled by a C-RNTI. DCI format 1_0 in which the CRC is scrambled by a C-RNTI may include the following pieces of information given in Table 12 below, for example.

```
TABLE 12
- Identifier for DCI formats - 1 bit
  - The value of this bit field is always set to 0, indicating an UL DCI format
- Carrier indicator - 0 or 3 bits, as defined in Subclause 10.1 of [5, TS38.213].
- UL/SUL indicator - 0 bit for UEs not configured with supplementaryUplink in
  ServingCellConfig in the cell or UEs configured with supplementaryUplink in
  ServingCellConfig in the cell but only PUCCH carrier in the cell is configured
  for PUSCH transmission; otherwise, 1 bit as defined in Table 7.3.1.1.1-1.
- Bandwidth part indicator - 0, 1 or 2 bits as determined by the number of UL BWPs
  n_{BWP,RRC} configured by higher layers, excluding the initial UL bandwidth part.
  The bitwidth for this field is determined as ┌log₂(n_{BWP})┐ bits, where
  - n_{BWP} = n_{BWP,RRC} + 1 if n_{BWP,RRC} ≤ 3, in which case the bandwidth part
    indicator is equivalent to the ascending order of the higher layer parameter BWP-Id;
  - otherwise n_{BWP} = N_{BWP,RRC}, in which case the bandwidth part indicator is
    defined in Table 7.3.1.1.2-1;
  If a UE does not support active BWP change via DCI, the UE ignores this bit field.
- Frequency domain resource assignment - number of bits determined by the
  following, where N_{RB}^{UL,BWP} is the size of the active UL bandwidth part:
  - N_{RBG} bits if only resource allocation type 0 is configured, where N_{RBG} is defined
    in Subclause 6.1.2.2.1 of [6, TS 38.214]
  $‐ ⌈ {log}_{2} ( {N}_{RB}^{UL , BWP} ( {N}_{RB}^{UL , BWP} + 1 ) / 2 ) ⌉ bits if only resource allocation type 1 is$
    $configured , or max ( ⌈ {log}_{2} ( {N}_{RB}^{UL , BWP} ( {N}_{RB}^{UL , BWP} + 1 ) / 2 ) ⌉ , {N}_{RBG} ) + 1$
    both resource allocation type 0 and 1 are configured.
  - If both resource allocation type 0 and 1 are configured, the MSB bit is used to
    indicate resource allocation type 0 or resource allocation type 1, where the bit
    value of 0 indicates resource allocation type 0 and the bit value of 1 indicates
    resource allocation type 1.
  - For resource allocation type 0, the N_{RBG} LSBs provide the resource allocation as
    defined in Subclause 6.1.2.2.1 of [6, TS 38.214].
  $‐ For resouce allocation type 1 , the ⌈ {log}_{2} ( {N}_{RB}^{UL , BWP} ( {N}_{RB}^{UL , BWP} + 1 ) / 2 ) ⌉$
    LSBs provide the resource allocation as follows:
    - For PUSCH hopping with resource allocation type 1:
    - N_{UL}_hop MSB bits are used to indicate the frequency offset according to
      Subclause 6.3 of [6, TS 38.214], where N_{UL}_hop = 1 if the higher layer
      parameter frequencyHoppingOffsetLists contains two offset values and
      N_{UL}_hop = 2 if the higher layer parameter frequencyHoppingOffsetLists
      contains four offset values
    $‐ ⌈ {log}_{2} ( {N}_{RB}^{UL , BWP} ( {N}_{RB}^{UL , BWP} + 1 ) / 2 ) ⌉ - {N}_{UL \_ hop} bits provides the frequency$
      domain resource allocation according to Subclause 6.1.2.2.2 of [6, TS 38.214]
  - For non-PUSCH hopping with resource allocation type 1:
    $‐ ⌈ {log}_{2} ( {N}_{RB}^{UL , BWP} ( {N}_{RB}^{UL , BWP} + 1 ) / 2 ) ⌉ bits provides the frequency domain$
      resource allocation according to Subclause 6.1.2.2.2 of [6, TS 38.214]
  If “Bandwidth part indicator” field indicates a bandwidth part other than the
  active bandwidth part and if both resource allocation type 0 and 1 are configured
  for the indicated bandwidth part, the UE assumes resource allocation type 0 for
  the indicated bandwidth part if the bitwidth of the “Frequency domain resource
  assignment” field of the active bandwidth part is smaller than the bitwidth of
  the “Frequency domain resource assignment” field of the indicated bandwidth
  part.
- Time domain resource assignment - 0, 1, 2, 3, or 4 bits as defined in Subclause 6.
  1.2.1 of [6, TS38.21]. The bitwidth for this field is determined as ┌log₂(I)┐ bits,
  where I is the number of entries in the higher layer parameter pusch-TimeDomain
  AllocationList if the higher layer parameter is configured; otherwise I is the
  number of entries in the default table.
- Frequency hopping flag - 0 or 1 bit:
  - 0 bit if only resource allocation type 0 is configured or if the higher layer
    parameter frequencyHopping is not configured;
  - 1 bit according to Table 7.3.1.1.1-3 otherwise, only applicable to resource
    allocation type 1, as defined in Subclause 6.3 of [6, TS 38.214].
- Modulation and coding scheme - 5 bits as defined in Subclause 6.1.4.1 of
  [6, TS 38.214]
- New data indicator - 1 bit
- Redundancy version - 2 bits as defined in Table 7.3.1.1.1-2
- HARQ process number - 4 bits
- 1^{st} downlink assignment index - 1 or 2 bits:
  - 1 bit for semi-static HARQ-ACK codebook;
  - 2 bits for dynamic HARQ-ACK codebook.
- 2^{nd} downlink assignment index - 0 or 2 bits:
  - 2 bits for dynamic HARQ-ACK codebook with two HARQ-ACK sub-codebooks;
  - 0 bit otherwise.
- TPC command for scheduled PUSCH - 2 bits as defined in Subclause 7.1.1 of
```

| | |
|---|---|
| [5 TS 38.213] | [symbol] |

```
$‐ SRS source indicator ‐ ⌈ {log}_{2} ( {\sum }_{k = 1}^{min \{ {LSRS}_{max} \{ \} \} \sum } ( \begin{matrix}{N}_{SRS} \\ k\end{matrix} ) ( ) ) ⌉ or ⌈ {log}_{2} ( {N}_{SRS} ) ⌉$
  bits, where N_{SRS} is the number of configured SRS resources in the SRS resource
  set associated with the higher layer parameter usage of value “codeBook” or “non
```

| | |
|---|---|
| CodeBook,” | [symbol] |

```
  $‐ ⌈ {log}_{2} ( {\sum }_{k = 1}^{min \{ {LSRS}_{max} \{ \} \} \sum } ( \begin{matrix}{N}_{SRS} \\ k\end{matrix} ) ( ) ) ⌉ bits according to Tables 7.3 \text{.1} \text{.1} \text{.2} - 28 / 2$
    9/30/31 if the higher layer parameter txConfig = nonCodebook, where N_{SRS} is
    the number of configured SRS resources in the SRS resource set associated
    with the higher layer parameter usage of value “nonCodeBook” and
    - if UE supports operation with maxMIMO-Layers and the higher layer
    parameter maxMIMO-Layers of PUSCH-ServingCellConfig of the serving cell is
    configured, Lₘₐₓ is given by that parameter
    - otherwise, Lₘₐₓ is given by the maximum number of layers for PUSCH
    supported by the UE for the serving cell for non-codebook based operation.
  - ┌log₂(N_{SRS})┐ bits according to Tables 7.3.1.1.2-32 if the higher layer parameter
    txConfig = codebook, where N_{SRS} is the number of configured SRS resources
    in the SRS resource set associated with the higher layer parameter usage of
    value “codeBook.”
- Precoding information and number of layers - number of bits determined by the
  following:
  - 0 bits if the higher layer parameter txConfig = nonCodeBook,
  - 0 bits for 1 antenna port and if the higher layer parameter txConfig = codebook;
  - 4, 5, or 6 bits according to Table 7.3.1.1.2-2 for 4 antenna ports, if txConfig =
    codebook, and according to whether transform precoder is enabled or disabled,
    and the values of higher layer parameters maxRank, and codebookSubset;
  - 2, 4, or 5 bits according to Table 7.3.1.1.2-3 for 4 antenna ports, if txConfig =
    codebook, and according to whether transform precoder is enabled or disabled,
    and the values of higher layer parameters maxRank, and codebookSubset;
  - 2 or 4 bits according to Table7.3.1.1.2-4 for 2 antenna ports, if txConfig = code
    book, and according to whether transform precoder is enabled or disabled, and
    the values of higher layer parameters maxRank and codebookSubset;
  - 1 or 3 bits according to Table7.3.1.1.2-5 for 2 antenna ports, if txConfig = code
    book, and according to whether transform precoder is enabled or disabled, and
    the values of higher layer parameters maxRank and codebookSubset.
- Antenna ports - number of bits determined by the following
  - 2 bits as defined by Tables 7.3.1.1.2-6, if transform precoder is enabled, dmrs-
    Type = 1, and maxLength = 1;
  - 4 bits as defined by Tables 7.3.1.1.2-7, if transform precoder is enabled, dmrs-
    Type = 1, and maxLength = 2;
  - 3 bits as defined by Tables 7.3.1.1.2-8/9/10/11, if transform precoder is disabled
    dmrs-Type = 1, and maxLength=1, and the value of rank is determined according
    to the SRS resource indicator field if the higher layer parameter txConfig =
    nonCodebook and according to the Precoding information and number of layers
    field if the higher layer parameter txConfig = codebook;
  - 4 bits as defined by Tables 7.3.1.1.2-12/13/14/15, if transform precoder is
    disabled, dmrs-Type = 1, and maxLength = 2, and the value of rank is determined
    according to the SRS resource indicator field if the higher layer parameter
    txConfig = nonCodebook and according to the Precoding information and
    number of layers field if the higher layer parameter txConfig = codebook;
  - 4 bits as defined by Tables 7.3.1.1.2-16/17/18/19, if transform precoder is
    disabled, dmrs-Type = 2, and maxLength = 1, and the value of rank is determined
    according to the SRS resource indicator field if the higher layer parameter
    txConfig = nonCodebook and according to the Precoding information and
    number of layers field if the higher layer parameter txConfig = codebook;
  - 5 bits as defined by Tables 7.3.1.1.2-20/21/22/23, if transform precoder is
    disabled, dmrs-Type = 2, and maxLength = 2, and the value of rank is determined
    according to the SRS resource indicator field if the higher layer parameter
    txConfig = nonCodebook and according to the Precoding information and
    number of layers field if the higher layer parameter txConfig = codebook.
  where the number of CDM groups without data of values 1, 2, and 3 in Tables
  7.3.1.1.2-6 to 7.3.1.1.2-23 refers to CDM groups {0}, {0, 1}, and {0, 1, 2} respectively.
  If a UE is configured with both dmrs-UplinkForPUSCH-MappingTypeA and dmrs-
  UplinkForPUSCH-MappingTypeB, the bitwidth of this field equals max {x_{A}, x_{B}},
  where x_{A} is the “Antenna ports” bitwidth derived according to dmrs-UplinkFor
  PUSCH-MappingTypeA and x_{B} is the “Antenna ports” bitwidth derived according
  to dmrs-UplinkForPUSCH-MappingTypeB. A number of |x_{A} − x_{B}| zeros are
  padded in the MSB of this field, if the mapping type of the PUSCH corresponds
  to the smaller value of x_{A} and x_{B}.
- SRS request - 2 bits as defined by Table 7.3.1.1.2-24 for UEs not configured with
  supplementaryUplink in ServingCellConfig in the cell; 3 bits for UEs configured
  with supplementaryUplink in ServingCellConfig in the cell where the first bit is
  the non-SUL/SUL indicator as defined in Table 7.3.1.1.1-1 and the second and
  third bits are defined by Table 7.3.1.1.2-24. This bit field may also indicate the
  associated CSI-RS according to Subclause 6.1.1.2 of [6, TS 38.214].
- CSI request - 0, 1, 2, 3, 4, 5, or 6 bits determined by higher layer parameter report
  TriggerSize.
- CBG transmission information (CBGTI) - 0 bit if higher layer parameter code
  BlockGroupTransmission for PDSCH is not configured, otherwise, 2, 4, 6, or 8
  bits determined by higher layer parameter maxCodeBlockGroupsPerTransportBlock
  for PUSCH.
-  PTRS-DMRS association - number of bits determined as follows
  - 0 bit if PTRS-UplinkConfig is not configured and transform precoder is disabled,
    or if transform precoder is enabled, or if maxRank = 1;
  - 2 bits otherwise, where Table 7.3.1.1.2-25 and 7.3.1.1.2-26 are used to indicate
    the association between PTRS port(s) and DMRS port(s) for transmission of
    one PT-RS port and two PT-RS ports respectively, and the DMRS ports are
    indicated by the Antenna ports field.
    If “Bandwidth part indicator” field indicates a bandwidth part other than the active
    bandwidth part and the “PTRS-DMRS association” field is present for the indicated
    bandwidth part but not present for the active bandwidth part, the UE assumes
    the “PTRS-DMRS association” field is not present for the indicated bandwidth part.
- beta_offset indicator - 0 if the higher layer parameter betaOffsets = semiStatic;
  otherwise 2 bits as defined by Table 9.3-3 in [5, TS 38.213]
- DMRS sequence initialization - 0 bit if transform precoder is enabled; 1 bit if
  transform precoder is disabled.
- UL-SCH indicator - 1 bit. A value of “1” indicates UL-SCH may be transmitted
  on the PUSCH and a value of “0” indicates UL-SCH may not be transmitted on the
  PUSCH. Except for DCI format 0_1 with CRC scrambled by SP-CSI-RNTI, a
  UE is not expected to receive a DCI format 0 1 with UL-SCH indicator of “0” and
  CSI request of all zero(s).
```

DCI format 1_0 may be used as fallback DCI for scheduling a PDSCH, and in this case, the CRC may be scrambled by a C-RNTI. DCI format 1_0 in which the CRC is scrambled by a C-RNTI may include the following pieces of information given in Table 13 below, for example.

```
TABLE 13
- Identifier for DCI formats - 1 bits
  - The value of this bit field is always set to 1, indicating a DL DCI format
$‐ Frequency domain resource assignment - ⌈ {log}_{2} ( {N}_{RB}^{DL , BWP} ( {N}_{RB}^{DL , BWP} + 1 ) / 2 ) ⌉$
  bits where N_{RB}^{DL,BWP} is given by subclause 7.3.1.0
If the CRC of the DCI format 1_0 is scrambled by C-RNTI and the “Frequency
domain resource assignment” field are of all ones, the DCI format 1_0 is for random
access procedure initiated by a PDCCH order, with all remaining fields set as follows:
- Random Access Preamble index - 6 bits according to ra-PreambleIndex in
  Subclause 5.1.2 of [8, TS 38.321]
- UL/SUL indicator - 1 bit. If the value of the “Random Access Preamble index” is
  not all zeros and if the UE is configured with supplementaryUplink in ServingCell
  Config in the cell, this field indicates which UL carrier in the cell to transmit the
  PRACH according to Table 7.3.1.1.1-1; otherwise, this field is reserved
- SS/PBCH index - 6 bits. If the value of the “Random Access Preamble index” is
  not all zeros, this field indicates the SS/PBCH that may be used to determine the
  RACH occasion for the PRACH transmission; otherwise, this field is reserved.
- PRACH Mask index - 4 bits. If the value of the “Random Access Preamble index”
  is not all zeros, this field indicates the RACH occasion associated with the SS/P
  BCH indicated by “SS/PBCH index” for the PRACH transmission, according to
  Subclause 5.1.1 of [8, TS 38.321]; otherwise, this field is reserved
- Reserved bits - 10 bits
Otherwise, all remaining fields are set as follows:
- Time domain resource assignment - 4 bits as defined in Subclause 5.1.2.1 of
  [6, TS 38.214]
- VRB-to-PRB mapping - 1 bit according to Table 7.3.1.2.2-5
- Modulation and coding scheme - 5 bits as defined in Subclause 5.1.3 of
  [6, TS 38.214]
- New data indicator - 1 bit
- Redundancy version - 2 bits as defined in Table 7.3.1.1.1-2
- HARQ process number - 4 bits
- Downlink assignment index - 2 bits as defined in Subclause 9.1.3 of [5, TS 38.213],
  as counter DAI
- TPC command for scheduled PUCCH - 2 bits as defined in Subclause 7.2.1 of
  [5, TS 38.213]
- PUCCH resource indicator - 3 bits as defined in Subclause 9.2.3 of [5, TS 38.213]
- PDSCH-to-HARQ_feedback timing indicator - 3 bits as defined in Subclause 9.2.
  3 of [5, TS 38.213]
```

DCI format 1_1 may be used as non-fallback DCI for scheduling a PDSCH, and in this case, the CRC may be scrambled by a C-RNTI. DCI format 1_1 in which the CRC is scrambled by a C-RNTI may include the following pieces of information given in Table 14 below, for example.

```
TABLE 14
- Identifier for DCI formats - 1 bits
  - The value of this bit field is always set to 1, indicating a DL DCI format
- Carrier indicator - 0 or 3 bits as defined in Subclause 10.1 of [5, TS 38.213].
- Bandwidth part indicator- 0, 1 or 2 bits as determined by the number of DL BWPs
  n_{BWP,RRC} configured by higher layers, excluding the initial DL bandwidth part.
  The bitwidth for this field is determined as ┌log₂(n_{BWP})┐ bits, where
  - n_{BWP} = n_{BWP,RRC} + 1 if n_{BWP,RRC} ≤ 3, in which case the bandwidth part indicator
    is equivalent to the ascending order of the higher layer parameter BWP-Id;
  - otherwise n_{BWP} = n_{BWP,RRC}, in which case the bandwidth part indicator is defined
    in Table 7.3.1.1.2-1;
  If a UE does not support active BWP change via DCI, the UE ignores this bit field.
- Frequency domain resource assignment - number of bits determined by the following,
  $where {N}_{RB}^{DL , BWP} is the size of the active DL bandwidth part :$
  - N_{RBG} bits if only resource allocation type 0 is configured, where N_{RBG} is defined
    in Subclause 5.1.2.2.1 of [6, TS38.214],
  $‐ ⌈ {log}_{2} ( {N}_{RB}^{DL , BWP} ( {N}_{RB}^{DL , BWP} + 1 ) / 2 ) ⌉ bits if only resource allocation type 1 is$
    configured, or
  $‐ max ( ⌈ {log}_{2} ( {N}_{RB}^{DL , BWP} ( {N}_{RB}^{DL , BWP} + 1 ) / 2 ) ⌉ , {N}_{RBG} ) + 1 bits if both resource a$
    allocation type 0 and 1 are configured.
  - If both resource allocation type 0 and 1 are configured, the MSB bit is used to
    indicate resource allocation type 0 or resource allocation type 1, where the bit
    value of 0 indicates resource allocation type 0 and the bit value of 1 indicates
    resource allocation type 1.
  - For resource allocation type 0, the N_{RBG} LSBs provide the resource allocation as
    defined in Subclause 5.1.2.2.1 of [6, TS 38.214].
  $‐ For resouce allocation type 1 , the ⌈ {log}_{2} ( {N}_{RB}^{DL , BWP} ( {N}_{RB}^{DL , BWP} + 1 ) / 2 ) ⌉$
    provide the resource allocation as defined in Subclause 5.1.2.2.2 of [6, TS 38.214]
  If “Bandwidth part indicator” field indicates a bandwidth part other than the active
  bandwidth part and if both resource allocation type 0 and 1 are configured for the
  indicated bandwidth part, the UE assumes resource allocation type 0 for the indicated
  bandwidth part if the bitwidth of the “Frequency domain resource assignment”
  field of the active bandwidth part is smaller than the bitwidth of the “Frequency
  domain resource assignment” field of the indicated bandwidth part.
- Time domain resource assignment - 0, 1, 2, 3, or 4 bits as defined in Subclause 5.
  1.2.1 of [6, TS 38.214]. The bitwidth for this field is determined as ┌log₂(I)┐ bits,
  where I is the number of entries in the higher layer parameter pdsch-TimeDomain
  AllocationList if the higher layer parameter is configured; otherwise I is the number
  of entries in the default table.
- VRB-to-PRB mapping - 0 or 1 bit:
  - 0 bit if only resource allocation type 0 is configured or if interleaved VRB-to-PRB
    mapping is not configured by high layers;
  - 1 bit according to Table 7.3.1.2.2-5 otherwise, only applicable to resource allocation
    type 1, as defined in Subclause 7.3.1.6 of [4, TS 38.211].
- PRB bundling size indicator - 0 bit if the higher layer parameter prb-BundlingType
  is not configured or is set to “static,” or 1 bit if the higher layer parameter prb-
  BundlingType is set to “dynamic” according to Subclause 5.1.2.3 of [6, TS 38.214].
- Rate matching indicator - 0, 1, or 2 bits according to higher layer parameters rate
  MatchPatternGroup1 and rateMatchPatternGroup2, where the MSB is used to
  indicate rateMatchPatternGroup1 and the LSB is used to indicate rateMatchPattern
  Group2 when there are two groups.
- ZP CSI-RS trigger - 0, 1, or 2 bits as defined in Subclause 5.1.4.2 of [6, TS 38.214].
  The bitwidth for this field is determined as ┌log₂(n_{ZP} + 1)┐ bits, where n_{ZP}
  is the number of aperiodic ZP CSI-RS resource sets configured by higher layer.
For transport block 1:
  - Modulation and coding scheme - 5 bits as defined in Subclause 5.1.3.1 of
    [6, TS 38.214]
  - New data indicator - 1 bit
  - Redundancy version - 2 bits as defined in Table 7.3.1.1.1-2
For transport block 2 (only present if maxNrofCode WordsScheduledByDCI equals 2):
  - Modulation and coding scheme - 5 bits as defined in Subclause 5.1.3.1 of
    [6, TS 38.214]
  - New data indicator - 1 bit
  - Redundancy version - 2 bits as defined in Table 7.3.1.1.1-2
  If “Bandwidth part indicator” field indicates a bandwidth part other than the active
  bandwidth part and the value of maxNrofCode WordsScheduledByDCI for the
  indicated bandwidth part equals 2 and the value of maxNrofCode WordsScheduledBy
  DCI for the active bandwidth part equals 1, the UE assumes zeros are padded when
  interpreting the “Modulation and coding scheme,” “New data indicator,” and
  “Redundancy version” fields of transport block 2 according to Subclause 12 of
  [5, TS 38.213], and the UE ignores the “Modulation and coding scheme,” “New data
  indicator,” and “Redundancy version” fields of transport block 2 for the indicated
  band width part.
- HARQ process number - 4 bits
- Downlink assignment index - number of bits as defined in the following
  - 4 bits if more than one serving cell are configured in the DL and the higher
    layer parameter pdsch-HARQ-ACK-Codebook = dynamic, where the 2 MSB bits
    are the counter DAI and the 2 LSB bits are the total DAI;
  - 2 bits if only one serving cell is configured in the DL and the higher layer
    parameter pdsch-HARQ-ACK-Codebook = dynamic, where the 2 bits are the
    counter DAI;
  - 0 bits otherwise.
- TPC command for scheduled PUCCH - 2 bits as defined in Subclause 7.2.1 of [5,
  TS 38.213]
- PUCCH resource indicator - 3 bits as defined in Subclause 9.2.3 of [5, TS 38.213]
- DSCH-to-HARQ_feedback timing indicator - 0, 1, 2, or 3 bits as defined in
  Subclause 9.2.3 of [5, TS 38.213]. The bitwidth for this field is determined as
  ┌log₂(I)┐ bits, where I is the number of entries in the higher layer parameter
  dl-DataToUL-ACK.
- Antenna port(s) - 4, 5, or 6 bits as defined by Tables 7.3.1.2.2-1/2/3/4, where the
  number of CDM groups without data of values 1, 2, and 3 refers to CDM groups
  {0}, {0, 1}, and {0, 1, 2} respectively. The antenna ports {p₀, .... , pᵥ₋₁} may be deter-
  mined according to the ordering of DMRS port(s) given by Tables 7.3.1.2.2-1/2/3/4.
  If a UE is configured with both dmrs-DownlinkForPDSCH-MappingTypeA and
  dmrs-DownlinkForPDSCH-MappingTypeB, the bitwidth of this field equals
  max{x_{A}, x_{B}}, where x_{A} is the “Antenna ports” bitwidth derived according to dmrs-
  DownlinkForPDSCH-MappingTypeA and x_{B} is the “Antenna ports” bitwidth
  derived according to dmrs-DownlinkForPDSCH-MappingTypeB. A number of
  |x_{A} − x_{B}| zeros are padded in the MSB of this field, if the mapping type of the
  PDSCH corresponds to the smaller value of x_{A} and x_{B}.
- Transmission configuration indication - 0 bit if higher layer parameter tci-Present
  InDCI is not enabled; otherwise 3 bits as defined in Subclause 5.1.5 of
  [6, TS 38.214].
  If “Bandwidth part indicator” field indicates a bandwidth part other than the active
  bandwidth part,
  - if the higher layer parameter tci-PresentInDCI is not enabled for the CORESET
    used for the PDCCH carrying the DCI format 1_1,
  - the UE assumes tci-PresentInDCI is not enabled for all CORESETs in the
    indicated bandwidth part;
  - otherwise,
    - the UE assumes tci-PresentInDCI is enabled for all CORESETs in the indicated
    bandwidth part.
- SRS request - 2 bits as defined by Table 7.3.1.1.2-24 for UEs not configured with
  supplementaryUplink in ServingCellConfig in the cell; 3 bits for UEs configured
  with supplementaryUplink in ServingCellConfig in the cell where the first bit is the
  non-SUL/SUL indicator as defined in Table 7.3.1.1.1-1 and the second and third
  bits are defined by Table 7.3.1.1.2-24. This bit field may also indicate the
  associated CSI-RS according to Subclause 6.1.1.2 of [6, TS 38.214].
- CBG transmission information (CBGTI) - 0 bit if higher layer parameter code
  BlockGroupTransmission for PDSCH is not configured, otherwise, 2, 4, 6, or 8
  bits as defined in Subclause 5.1.7 of [6, TS 38.214] determined by the higher layer
  parameters maxCodeBlockGroupsPerTransportBlock and maxNrofCode
  WordsScheduledByDCI for the PDSCH.
- CBG flushing out information (CBGFI) - 1 bit if higher layer parameter codeBlock
  GroupFlushIndicator is configured as “TRUE,” 0 bit otherwise.
- DMRS sequence initialization - 1 bit.
```

Hereinafter, a time domain resource allocation method regarding a data channel in the 5G communication system will be described.

A base station may configure a table for time domain resource allocation information regarding a physical downlink shared channel (PDSCH) and a physical uplink shared channel (PUSCH) for a UE through upper layer signaling (for example, RRC signaling). A table including a maximum of maxNrofDL-Allocations-16 entries may be configured for the PDSCH, and a table including a maximum of maxNrofUL-Allocations=16 entries may be configured for the PUSCH. In an embodiment, the time domain resource allocation information may include PDCCH-to-PDSCH slot timing (for example, corresponding to a slot-unit time interval between a timepoint at which a PDCCH is received and a timepoint at which a PDSCH scheduled by the received PDCCH is transmitted; labeled K0), PDCCH-to-PUSCH slot timing (for example, corresponding to a slot-unit time interval between a timepoint at which a PDCCH is received and a timepoint at which a PUSCH scheduled by the received PDCCH is transmitted; hereinafter, labeled K2), information regarding the location and length of the start symbol by which a PDSCH or PUSCH is scheduled inside a slot, the mapping type of a PDSCH or PUSCH, and the like. For example, information such as in Table 15 or Table 16 below may be transmitted from the base station to the UE.

TABLE 15
PDSCH-TimeDomainResourceAllocationList information element

PDSCH-TimeDomainResourceAllocationList ::= SEQUENCE (SIZE(1..maxNrofDL-
Allocations)) OF PDSCH-TimeDomainResourceAllocation
PDSCH-TimeDomainResourceAllocation ::= SEQUENCE {

| | | |
|---|---|---|
| k0 | INTEGER(0..32) | OPTIONAL, -- Need SmappingType |

| | |
|---|---|
| ENUMERATED {typeA, typeB},startSymbolAndLength | INTEGER (0..127)} |

TABLE 16
PUSCH-TimeDomainResourceAllocation information element

PUSCH-TimeDomainResourceAllocationList ::= SEQUENCE (SIZE(1..maxNrofUL-
Allocations)) OF PUSCH-TimeDomainResourceAllocation
PUSCH-TimeDomainResourceAllocation ::= SEQUENCE {

| | | |
|---|---|---|
| k2 | INTEGER(0..32) | OPTIONAL, -- Need S |

| | |
|---|---|
| mappingType | ENUMERATED {typeA, typeB}, |
| startSymbolAndLength | INTEGER (0..127)} |

The base station may notify the UF of one of the entries of the table regarding time domain resource allocation information described above through L1 signaling (for example, DCI) (for example, “time domain resource allocation” field in DCI may indicate the same). The UE may acquire time domain resource allocation information regarding a PDSCH or PUSCH, based on the DCI acquired from the base station.

Hereinafter, a frequency domain resource allocation method for a data channel in a 5G communication system will be described.

In 5G, as a method of indicating frequency domain resource allocation information for a downlink data channel (physical downlink shared channel (PDSCH)) and an uplink data channel (physical uplink shared channel (PUSCH)), two types, which are resource allocation type 0 and resource allocation type 1, are supported.

### Resource Allocation Type 0

RB allocation information may be notified from a base station to a UE in the form of a bitmap for a resource block group (RBG). In this case, the RBG may include a set of consecutive virtual RBs (VRBs), and size P of the RBG may be determined based on a value configured as a higher-layer parameter (rbg-Size) and a size value of a bandwidth part defined in Table 17 below.

TABLE 17

| Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

A total number (NRBG) of RBGs of bandwidth part i having a size of

$${N}_{{BWP}_{i}}^{size}$$

may be defined as follows.

$$◼ {N}_{RBG} = [ {N}_{{BWP}_{i}}^{size} + ( {N}_{{BWP}_{i}}^{start} mod P ) ] / P , where$$

$$◆ the size of theh first RBG is {RBG}_{0}^{size} = P - ( {N}_{{BWP}_{i}}^{start} mod P ) ,$$

$$◆ the size of last RBG is {RBG}_{last}^{size} = ( {N}_{BWPi}^{start} + {N}_{{BWP}_{i}}^{start} ) mod P , ( {N}_{BWP}^{start} + {N}_{{BWP}_{i}}^{start} ) mod P > 0 and P otherwise ,$$

if
the size of all other RBGs is P.
Each bit of a bitmap having a size of NRBG bits may correspond to each RBG. RBGs may be indexed in an ascending order of frequency starting from a lowest frequency position of the bandwidth part. With respect to NRBG RBGs in the bandwidth part, RBG #0 to RBG #(NRBG-1) may be mapped from an MSB to an LSB of the RBG bitmap. When a specific bit value in the bitmap is 1, the UE may determine that an RBG corresponding to the bit value has been assigned, and when the specific bit value in the bitmap is 0, the UE may determine that an RBG corresponding to the bit value has not been assigned.

### Resource Allocation Type 1

RB allocation information may be notified as start position and length information of consecutively allocated VRBs to the UE from the base station. In this case, interleaving or non-interleaving may be additionally applied to the consecutively allocated VRBs. A resource allocation field of resource allocation type 1 may include a resource indication value (RIV), and the RIV may include a start point (RBₛₜₐᵣₜ) of the VRBs and a length (L_{RBs}) of the consecutively allocated RBs. More specifically, an RIV in a bandwidth part having a size of N_{BWP}^{size} may be defined as follows.

$$■ if ( {L}_{RBs} - 1 ) \leq ⌊ {N}_{BWP}^{size} / 2 ⌋ then$$

$$◆ RIV = {N}_{BWP}^{size} ( {L}_{RBs} - 1 ) + {RB}_{start}$$

$$else$$

$$◆ RIV = {N}_{BWP}^{size} ( {N}_{BWP}^{size} - {L}_{RBs} - 1 ) + ( {N}_{BWP}^{size} - 1 - {RB}_{start} )$$

$$where {L}_{RBs} \geq 1 and shall not exceed {N}_{BWP}^{size} - {RB}_{start} .$$

For the purpose of supporting transmission/reception with a configured grant for a downlink data channel (physical downlink shared channel (PDSCH)) or an uplink data channel (physical uplink shared channel (PUSCH)), the base station may configure, for the UE in a semi-static manner, various transmission/reception parameters and time and frequency transmission resources for the PDSCH and PUSCH.

More specific descriptions are as follows.

For the purpose of supporting downlink (DL) semi-persistent scheduling (SPS), the base station may configure the following information for the UE via higher-layer signaling (e.g., RRC signaling) as in Table 18.

TABLE 18

| | |
|---|---|
| SPS-Config ::= | SEQUENCE { |
| periodicity | ENUMERATED {ms10, ms20, ms32, ms40, ms64, ms80, ms128, ms160, ms320, |

ms640,
spare6, spare5, spare4, spare3, spare2, spare1},

| nrofHARQ-Processes | INTEGER (1..8), | |
|---|---|---|
| n1PUCCH-AN | PUCCH-ResourceId | OPTIONAL, -- Need M |
| mcs-Table | ENUMERATED {qam64LowSE} | OPTIONAL, -- Need S |

...
}

DL SPS may be configured in a primary cell or a secondary cell, and may be configured in one cell within one cell group.

In 5G, for a transmission method with a configured grant (referred to as a grant-free transmission method, etc.) for a physical uplink shared channel (PUSCH), two types (type-1 PUSCH transmission with a configured grant and type-2 PUSCH transmission with a configured grant) may be supported.

Type-1 PUSCH Transmission with a Configured Grant

In type-1 PUSCH transmission with a configured grant, the base station may configure specific time/frequency resources 600, which allow PUSCH transmission with a configured grant, for the UE via higher-layer signaling, for example, RRC signaling. For example, as illustrated in FIG. 6, time-axis allocation information 601, frequency-axis allocation information 602, periodicity information 603, etc. may be configured for the resources 600. In addition, the base station may configure various parameters for PUSCH transmission (e.g., frequency hopping, DMRS configuration, MCS table, MCS, resource block group (RBG) size, number of repeated transmissions, redundancy version (RV), etc.) for the UE via higher-layer signaling. More specifically, configuration information in [Table 19] below may be included.

TABLE 19
ConfiguredGrantConfig ::= SEQUENCE {

| | |
|---|---|
| frequencyHopping (frequency hopping) | ENUMERATED {model, mode2} |

OPTIONAL, -- Need S

| | |
|---|---|
| cq-DMRS-Config (DMRS configuration) | DMRS-UplinkConfig, |
| mcs-Table | ENUMERATED {qam256, spare1} |

```
      OPTIONAL, -- Need S
  mcs-TableTransformPrecoder (MCS table) ENUMERATED {qam256, spare1}
      OPTIONAL, -- Need O
```

| | |
|---|---|
| uci-OnPUSCH (whether UCI is on PUSCH) | SetupRelease {CG-UCI-OnPUSCH}, |

```
  resourceAllocation (resource allocation type) ENUMERATED
{resourceAllocationType0,
        resourceAllocationType1, dynamicSwitch},
```

| | |
|---|---|
| rbg-Size (RBG size) | ENUMERATED {config2} |

```
      OPTIONAL, -- Need E
  powerControlLoopToUse (closed loop power control) ENUMERATED {n0, n1},
```

| | |
|---|---|
| po-PUSCH-Alpha (power control parameter) | PO-PUSCH-AlphaSetId, |

```
  transformPrecoder (whether transform precoding is applied) ENUMERATED {enabled}
      OPTIONAL, -- Need S
```

| | |
|---|---|
| nrofHARQ-Processes (number of HARQ processes) | INTEGER (1..16), |
| repK (repetition count) | ENUMERATED {n1, n2, n4, n8}, |
| repK-RV (redundancy version) | ENUMERATED {s1-0231, s2-0303, s3-0000} |

OPTIONAL, -- Cond RepK

| | |
|---|---|
| periodicity | ENUMERATED { |

```
      sym2, sym7, sym1x14, sym2x14, sym4x14, sym5x1
      4, sym8x14, sym10x14, sym16x14, sym20x14,
      sym32x14, sym40x14, sym64x14, sym80x14, sym12
      8x14, sym160x14, sym256x14, sym320x14,
      sym512x14,
      sym640x14, sym1024x14, sym1280x14, sym2560x1
      4, sym5120x14,
      sym6, sym1x12, sym2x12, sym4x12, sym5x12, sym
      8x12, sym10x12, sym16x12, sym20x12, sym32x12,
      sym40x12, sym64x12, sym80x12, sym128x12, sym1
      60x12, sym256x12, sym320x12, sym512x12,
      sym640x12,
      sym1280x12, sym2560x12
      },
  configuredGrantTimer (configured grant timer) INTEGER (1..64)
      OPTIONAL, -- Need R
```

| | |
|---|---|
| rrc-ConfiguredUplinkGrant | SEQUENCE { |

```
    timeDomainOffset (time domain offset) INTEGER (0..5119),
    timeDomainAllocation (time domain allocation) INTEGER (0..15),
    frequencyDomainAllocation (frequency domain allocation) BIT STRING (SIZE (18)),
```

| | |
|---|---|
| antennaPort (antenna port) | INTEGER (0..31), |

```
    dmrs-SeqInitialization (DMRS sequence initialization) INTEGER (0..1)
      OPTIONAL, -- Cond NoTransformPrecoder
    precodingAndNumberOfLayers (precoding and number of layers) INTEGER (0..63),
    ars-ResourceIndicator (SRS resource indicator) INTEGER (0..15),
```

| | |
|---|---|
| mcsAndTbs (MCS and TBS) | INTEGER (0..31), |

```
    frequencyHoppingOffset (frequency hopping offset) INTEGER (1.. maxNrofPhysi
      calResources−1)
      OPTIONAL, -- Need M
    pathlossReferenceIndex (Path-loss reference index) INTEGER (0..maxNrofPUSCH-
      PathlossReferenceRSs−1),
  }
      OPTIONAL, -- Need R
  ...
}
```

If configuration information for type-1 PUSCH transmission with a configured grant has been received from the base station, the UE may transmit the PUSCH without a grant of the base station via the periodically configured resources 600. Various parameters (e.g., frequency hopping, DMRS configuration, MCS, resource block group (RBG) size, number of repetitive transmissions, redundancy version (RV), precoding and number of layers, antenna port, frequency-hopping offset, etc.) for PUSCH transmission may all follow configuration values notified by the base station.

Type-2 PUSCH Transmission with a Configured Grant

In type-2 PUSCH transmission with a configured grant, the base station may configure some (e.g., the periodicity information 603) of the information on specific time/frequency resources 600, which allow PUSCH transmission with a configured grant, for the UE via higher-layer signaling (e.g., RRC signaling). In addition, the base station may configure various parameters for PUSCH transmission (e.g., frequency hopping, DMRS configuration, MCS table, resource block group (RBG) size, number of repeated transmissions, redundancy version (RV), etc.) for the UE via higher-layer signaling. More specifically, the base station may configure configuration information in Table 20 below for the UE via higher-laver signaling.

TABLE 20
ConfiguredGrantConfig ::= SEQUENCE {

| | |
|---|---|
| frequencyHopping (frequency hopping) | ENUMERATED {model, mode2} |

OPTIONAL, -- Need S

| | |
|---|---|
| cq-DMRS-Config (DMRS configuration) | DMRS-UplinkConfig, |
| mcs-Table | ENUMERATED {qam256, spare1} |

```
    OPTIONAL, -- Need S
  mcs-TableTransformPrecoder (MCS table) ENUMERATED {qam256, spare1}
    OPTIONAL, -- Need S
```

| | |
|---|---|
| uci-OnPUSCH (whether UCI is on PUSCH) | SetupRelease { CG-UCI-OnPUSCH }, |

```
  resourceAllocation (resource allocation type) ENUMERATED
{ resourceAllocationType0,
      dynamicSwitch },
```

| | |
|---|---|
| rbg-Size (RBG size) | ENUMERATED { config2} |

```
    OPTIONAL, -- Need S
  powerControlLoopToUse (closed loop power control) ENUMERATED { n0, n1},
```

| | |
|---|---|
| po-PUSCH-Alpha (power control parameter) | PO-PUSCH-AlphaSetId, |

```
  transformPrecoder (whether transform precoding is applied) ENUMERATED { enabled}
    OPTIONAL, -- Need S
```

| | |
|---|---|
| nrofHARQ-Processes (number of HARQ processes) | INTEGER (1..16), |
| repK (repetition count) | ENUMERATED { n1, n2, n4, n8}, |
| repK-RV (redundancy version) | ENUMERATED { s1-0231, s2-0303, s3-0000} |

OPTIONAL, -- Cond RepK

| | |
|---|---|
| periodicity | ENUMERATED { |

```
    sym2, sym7, sym1x14, sym2x14, sym4x14, sym5x1
    4, sym8x14, sym10x14, sym16x14, sym20x14,
    sym32x14, sym40x14, sym64x14, sym80x14, sym12
    8x14, sym160x14, sym256x14, sym320x14,
    sym512x14,
    sym640x14, sym1024x14, sym1280x14, sym2560x1
    4, sym5120x14,
    sym6, sym1x12, sym2x12, sym4x12, sym5x12, sym
    8x12, sym10x12, sym16x12, sym20x12, sym32x12,
    sym40x12, sym64x12, sym80x12, sym128x12, sym1
    60x12, sym256x12, sym320x12, sym512x12,
    sym640x12,
    sym1280x12, sym2560x12
    },
  configuredGrantTimer (configured grant timer) INTEGER (1..64)
    OPTIONAL, -- Need R
  }
```

The base station may transmit DCI including a specific DCI field value to the UE for the purpose of scheduling activation or scheduling release for DL SPS and UL grant Type 2.

More specific descriptions are as follows.

The base station may configure a configured scheduling-RNTI (CS-RNTI) for the UE, and the UE may monitor a DCI format in which a CRC is scrambled by the CS-RNTI. If the CRC of the DCI format that the UE has received is scrambled by the CS-RNTI, a new data indicator (NDI) is configured to be “0,” and the DCI field satisfies Table 21 below, the UE may consider the DCI as an instruction activating transmission/reception for DL SPS or UL grant Type 2.

TABLE 21

| | DCI format | DCI format | DCI format |
|---|---|---|---|
| | 0_0/0_1 | 1_0 | 1_1 |
| HARQ process | set to all “0”s | set to all “0”s | set to all “0”s |
| number | | | |
| Redundancy | set to “00” | set to “00” | For the enabled |
| version | | | transport block: |
| | | | set to “00” |

The base station may configure a configured scheduling-RNTI (CS-RNTI) for the UE, and the UE may monitor a DCI format in which a CRC is scrambled by the CS-RNTI. If the CRC of the DCI format that the UE has received is scrambled by the CS-RNTI, a new data indicator (NDI) is configured to be “0,” and the DCI field satisfies Table 22 below, the UE may consider the DCI as an instruction releasing transmission/reception for DL SPS or UL grant Type 2.

TABLE 22

| | DCI format 0_0 | DCI format 1_0 |
|---|---|---|
| HARQ process number | set to all “0”s | set to all “0”s |
| Redundancy version | set to “00” | set to “00” |
| Modulation and | set to all “1”s | set to all “1”s |
| coding scheme | | |
| Frequency domain | set to all “1”s | set to all “1”s |
| resource assignment | | |

The DCI indicating release for DL SPS or UL grant Type 2 follows a DCI format corresponding to DCI format 0_0 or DCI format 1_0, and DCI format 0_0 or 1_0 does not include a carrier indicator field (CIF), so that, in order to receive a release command for DL SPS or UL grant Type 2 for a specific cell, the UE may always monitor a PDCCH in the cell in which DL SPS or UL grant Type 2 is configured. Even if the specific cell is configured with cross-carrier scheduling, the UE may always monitor DCI format 1_0 or DCI format 0_0 in the cell in order to receive a release command for DL SPS or UL grant Type 2 configured in the cell.

Hereinafter, a carrier aggregation and scheduling method in the 5G communication system will be described in detail.

The UE may be configured with multiple cells (or component carriers (CCs)) from the base station, and may be configured with whether to perform cross-carrier scheduling on the cells configured for the UE. If cross-carrier scheduling has been configured for a specific cell (cell A or a scheduled cell), PDCCH monitoring for cell A may not be performed in cell A, but may be performed in another cell (cell B or a scheduling cell) indicated by the cross-carrier scheduling. In this case, the scheduled cell (cell A) and the scheduling cell (cell B) may be configured by different numerologies. The numerology may include a subcarrier spacing, a cyclic prefix, and the like. If the numerologies of cell A and cell B are different from each other, the following minimum scheduling offset may be additionally considered between the PDCCH and the PDSCH when the PDCCH of cell B schedules the PDSCH of cell A.

### Cross-Carrier Scheduling Method

If a subcarrier spacing (μB) of cell B is smaller than a subcarrier spacing (μA) of cell A, a PDSCH may be scheduled from a subsequent PDSCH slot located X symbols after the last symbol of a PDCCH received from cell B. Here, X may vary according to μB, wherein X=4 symbols may be defined when μB=15 kHz, X=4 symbols may be defined when μB=30 kHz, and X=8 symbols may be defined when μB-60 KHz.
If the subcarrier spacing (μB) of cell B is greater than the subcarrier spacing (μA) of cell A, a PDSCH may be scheduled from a time point that is X symbols after the last symbol of a PDCCH received from cell B. Here, X may vary according to μB, wherein X=4 symbols may be defined when μB=30 kHz, X=8 symbols may be defined when μB=60 kHz, and X=12 symbols may be defined when μB=120 KHz.

Hereinafter, a rate matching operation and a puncturing operation will be described in detail.

If time and frequency resource A to transmit symbol sequence A overlaps time and frequency resource B, a rate matching or puncturing operation may be considered as an operation of transmitting/receiving channel A in consideration of resource C (region in which resource A and resource B overlap). Specific operations may follow the following description.

### Rate Matching Operation

The base station may transmit channel A after mapping the same only to remaining resource domains other than resource C (area overlapping resource B) among the entire resource A which is to be used to transmit symbol sequence A to the UE. For example, if symbol sequence A is configured as {symbol #1, symbol #2, symbol #3, symbol4}, if resource A is {resource #1, resource #2, resource #3, resource #4}, and if resource B is {resource #3, resource #5}, the UE may receive symbol sequence A based on an assumption that the same has been successively mapped to remaining resources {resource #1, resource #2, resource #4} other than {resource #3} (corresponding to resource C) among resource A. Consequently, the base station may transmit symbol sequence {symbol #1, symbol #2, symbol #3} after mapping the same to {resource #1, resource #2, resource #4}, respectively.

The UE may assess resource A and resource B from scheduling information regarding symbol sequence A from the base station, thereby assessing resource C (region in which resource A and resource B overlap). The UE may receive symbol sequence A, based on an assumption that symbol sequence A has been mapped and transmitted in the remaining area other than resource C among the entire resource A. For example, if symbol sequence A is configured as {symbol #1, symbol #2, symbol #3, symbol4}, if resource A is {resource #1, resource #2, resource #3, resource #4}, and if resource B is {resource #3, resource #5}, the UE may receive symbol sequence A based on an assumption that the same has been successively mapped to remaining resources {resource #1, resource #2, resource #4} other than {resource #3} (corresponding to resource C) among resource A. Consequently, the UE may perform a series of following receiving operations based on an assumption that symbol sequence {symbol #1, symbol #2, symbol #3} has been transmitted after being mapped to {resource #1, resource #2, resource #4}, respectively.

### Puncturing Operation

If there is resource C (region overlapping resource B) among the entire resource A which is to be used to transmit symbol sequence A to the UE, the base station may map symbol sequence A to the entire resource A, but may not perform transmission in the resource area corresponding to resource C, and may perform transmission with regard to only the remaining resource area other than resource C among resource A. For example, if symbol sequence A is configured as {symbol #1, symbol #2, symbol #3, symbol4}, if resource A is {resource #1, resource #2, resource #3, resource #4}, and if resource B is {resource #3, resource #5}, the UE may assume that symbol sequence A {symbol #1, symbol #2, symbol #3, symbol4} is mapped to resource A {resource #1, resource #2, resource #3, resource #4}, respectively, but {symbol #3} mapped to {resource #3} (corresponding to resource C) is not transmitted, and based on the assumption that symbol sequence {symbol #1, symbol #2, symbol #4} corresponding to remaining resources {resource #1, resource #2, resource #4} other than {resource #3} (corresponding to resource C) among resource A has been mapped and transmitted, the UE may receive the same. Consequently, the base station may transmit symbol sequence {symbol #1, symbol #2, symbol #4} after mapping the same to {resource #1, resource #2, resource #4}, respectively.

The UE may assess resource A and resource B from scheduling information regarding symbol sequence A from the base station, thereby assessing resource C (region in which resource A and resource B overlap). The UE may receive symbol sequence A, based on an assumption that symbol sequence A has been mapped to the entire resource A but transmitted only in the remaining area other than resource C among the resource area A. For example, if symbol sequence A is configured as {symbol #1, symbol #2, symbol #3, symbol4}, if resource A is {resource #1, resource #2, resource #3, resource #4}, and if resource B is {resource #3, resource #5}, the UE may assume that symbol sequence A {symbol #1, symbol #2, symbol #3, symbol4} is mapped to resource A {resource #1, resource #2, resource #3, resource #4}, respectively, but {symbol #3} mapped to {resource #3} (corresponding to resource C) is not transmitted, and based on the assumption that symbol sequence {symbol #1, symbol #2, symbol #4} corresponding to remaining resources {resource #1, resource #2, resource #4} other than {resource #3} (corresponding to resource C) among resource A has been mapped and transmitted, the UE may receive the same. Consequently, the UE may perform a series of following receiving operations based on an assumption that symbol sequence {symbol #1, symbol #2, symbol #4} has been transmitted after being mapped to {resource #1, resource #2, resource #4}, respectively.

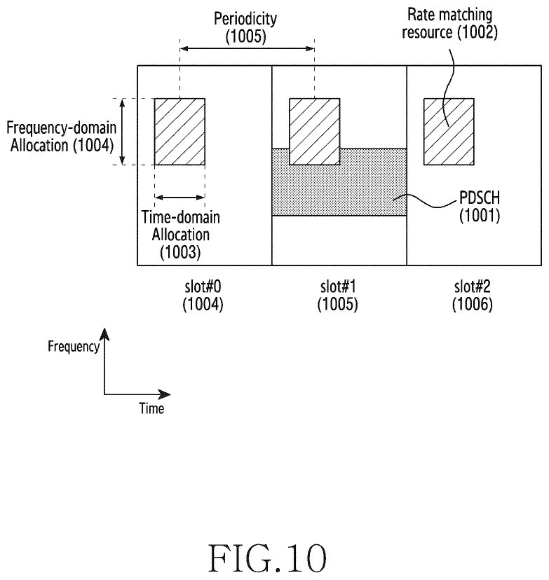

FIG. 10 illustrates a method in which a base station and a UE transmit/receive data inconsideration of a downlink data channel and a rate matching resource according to an embodiment of the disclosure.

Referring to FIG. 10, a downlink data channel (PDSCH) 1001 and a rate matching resource 1002 are illustrated. The base station may configure one or multiple rate matching resources 1002 for the UE through higher layer signaling (for example, RRC signaling). Rate matching resource 1002 configuration information may include time-domain resource allocation information 1003, frequency-domain resource allocation information 1004, and periodicity information 1005. A bitmap corresponding to the frequency-domain resource allocation information 1004 will hereinafter be referred to as “first bitmap,” a bitmap corresponding to the time-domain resource allocation information 1003 will be referred to as “second bitmap,” and a bitmap corresponding to the periodicity information 1005 will be referred toas “third bitmap.” If all or some of time and frequency resources of the scheduled PDSCH 1001 overlap a configured rate matching resource 1002, the base station may rate-match and transmit the data channel 1001 in a rate matching resource 1002 part, and the UE may perform reception and decoding after assuming that the data channel 1001 has been rate-matched in a rate matching resource 1002 part.

The base station may dynamically notify the UE, through DCI, of whether the PDSCH will be rate-matched in the configured rate matching resource part through an additional configuration (for example, corresponding to “rate matching indicator” inside DCI format described above). Specifically, the base station may select some from the configured rate matching resources and group them into a rate matching resource group, and may indicate, to the UE, whether the PDSCH is rate-matched with regard to each rate matching resource group through DCI by using a bitmap type. For example, if four rate matching resources RMR #1, RMR #2, RMR #3, and RMR #4 are configured, the base station may configure a rate matching groups RMG #1={RMR #1, RMR #2}, RMG #2={RMR #3, RMR #4}, and may indicate, to the UE, whether rate matching occurs in RMG #1 and RMG #2, respectively, through a bitmap by using two bits inside the DCI field. For example, in a case where rate matching is to be conducted, the base station may indicate this case by “1,” and in a case where rate matching is not to be conducted, the base station may indicate this case by “0.”

5G supports granularity of “RB symbol level” and “RE level” as a method for configuring the above-described rate matching resources for a UE. More specifically, the following configuration method may be followed.

### RB Symbol Level

The UE may have a maximum of four RateMatchPatterns configured per each bandwidth part through upper layer signaling, and one RateMatchPattern may include the following contents.
may include, in connection with a reserved resource inside a bandwidth part, a resource having time and frequency resource domains of the corresponding reserved resource configured as a combination of an RB-level bitmap and a symbol-level bitmap in the frequency domain. The reserved resource may span one or two slots. According to an embodiment, the span may be consecutive symbols within a slot, and may be consecutive symbols in which the PDCCH can be monitored. A time domain pattern (periodicity AndPattern) may be additionally configured wherein time and frequency domains including respective RB-level and symbol-level bitmap pairs are repeated.
may include a resource area corresponding to a time domain pattern configured by time and frequency domain resource areas configured by a control resource set inside a bandwidth part and a search space configuration in which corresponding resource areas are repeated.

### RE Level

The UE may have the following contents configured through upper layer signaling.
configuration information (lte-CRS-ToMatchAround) regarding a RE corresponding to a LTE CRS (Cell-specific Reference Signal or common reference signal) pattern, which may include LTE CRS's port number (nrofCRS-Ports) and LTE-CRS-vshift(s) value (v-shift), location information (carrierFreqDL) of a center subcarrier of a LTE carrier from a reference frequency point (for example, reference point A), the LTE carrier's bandwidth size (carrierBandwidthDL) information, subframe configuration information (mbsfn-SubframConfigList) corresponding to a multicast-broadcast single-frequency network (MBSFN), and the like. The UE may determine the position of the CRS inside the NR slot corresponding to the LTE subframe, based on the above-mentioned pieces of information.
may include configuration information regarding a resource set corresponding to one or multiple zero power (ZP) CSI-RSs inside a bandwidth part.

Hereinafter, a method of measuring and reporting a channel state in the 5G communication system will be described in detail.

Channel state information (CSI) may include a channel quality indicator (channel quality information (CQI)), a precoding matrix index (precoding matrix indicator (PMI)), a CSI-RS resource indicator (CRI), an SS/PBCH block resource indicator (SSBRI), a layer indicator (LI), a rank indicator (RI), a reference signal received power (L1-RSRP), and/or the like. A base station may control time and frequency resources for the aforementioned CSI measurement and report of a UE.

For the aforementioned CSI measurement and report, the UE may be configured, via higher-layer signaling, with setting information for N (N≥1) CSI reports (CSI-ReportConfig), setting information for M (M≥1) RS transmission resources (CSI-ResourceConfig), and list information of one or two trigger states (CSI-AperiodicTriggerStateList, CSI-SemiPersistentOnPUSCH-TriggerStateList).

The configuration information for CSI measurement and reporting described above may be, more specifically, as described in [Table 23] to [Table 29] below.

TABLE 23
The IE CSI-ReportConfig is used to configure a periodic or semi-persistent report sent on PUCCH on the cell
in which the CSI-ReportConfig is included, or to configure a semi-persistent or aperiodic report sent on
PUSCH triggered by DCI received on the cell in which the CSI-ReportConfig is included (in this case, the
cell on which the report is sent is determined by the received DCI). See TS 38.214 [19], clause 5.2.1.
CSI-ReportConfig information element

-- ASN1START
-- TAG-CSI-REPORTCONFIG-START

| CSI-ReportConfig ::= | SEQUENCE { | |
|---|---|---|
| reportConfigId | CSI-ReportConfigId, | |
| carrier | ServCellIndex | OPTIONAL, -- Need S |

| resourcesForChannelMeasurement | CSI-ResourceConfigId, | |
|---|---|---|
| csi-IM-ResourcesForInterference | CSI-ResourceConfigId | OPTIONAL, -- Need R |
| nzp-CSI-RS-ResourcesForInterference | CSI-ResourceConfigId | OPTIONAL, -- Need R |

| | |
|---|---|
| reportConfigType | CHOICE { |
| periodic | SEQUENCE { |
| reportSlotConfig | CSI-ReportPeriodicityAndOffset, |
| pucch-CSI-ResourceList | SEQUENCE (SIZE (1..maxNrofBWPs)) OF PUCCH-CSI- |

Resource
},

| | |
|---|---|
| semiPersistentOnPUCCH | SEQUENCE { |
| reportSlotConfig | CSI-ReportPeriodicityAndOffset, |
| pucch-CSI-ResourceList | SEQUENCE (SIZE (1..maxNrofBWPs)) OF PUCCH-CSI- |

Resource
},

| | |
|---|---|
| semiPersistentOnPUSCH | SEQUENCE { |
| reportSlotConfig | ENUMERATED {sl5, sl10, sl20, sl40, sl80, sl160, sl320}, |
| reportSlotOffsetList | SEQUENCE (SIZE (1.. maxNrofUL-Allocations)) OF |

INTEGER(0..32),

| | |
|---|---|
| p0alpha | P0-PUSCH-AlphaSetId |

},

| | |
|---|---|
| aperiodic | SEQUENCE { |

| | |
|---|---|
| reportSlotOffsetList | SEQUENCE (SIZE (1..maxNrofUL-Allocations)) OF |

```
INTEGER(0..32)
    }
  },
```

| reportQuantity | CHOICE { | |
|---|---|---|
| none | NULL, | |
| cri-RI-PMI-CQI | NULL, | |
| cri-RI-i1 | NULL, | |
| cri-RI-i1-CQI | SEQUENCE { | |
| pdsch-BundleSizeForCSI | ENUMERATED {n2, n4} | OPTIONAL -- |

Need S
},

| | |
|---|---|
| cri-RI-CQI | NULL, |
| cri-RSRP | NULL, |
| ssb-Index-RSRP | NULL, |
| cri-RI-LI-PMI-CQI | NULL |

},

| | |
|---|---|
| reportFreqConfiguration | SEQUENCE { |

| | |
|---|---|
| cqi-FormatIndicator | ENUMERATED { widebandCQI, subbandCQI } |

OPTIONAL, -- Need R

| | |
|---|---|
| pmi-FormatIndicator | ENUMERATED { widebandPMI, subbandPMI } |

OPTIONAL, -- Need R

| | |
|---|---|
| csi-ReportingBand | CHOICE { |
| subbands3 | BIT STRING(SIZE(3)), |
| subbands4 | BIT STRING(SIZE(4)), |
| subbands5 | BIT STRING(SIZE(5)), |
| subbands6 | BIT STRING(SIZE(6)), |
| subbands7 | BIT STRING(SIZE(7)), |
| subbands8 | BIT STRING(SIZE(8)), |
| subbands9 | BIT STRING(SIZE(9)), |
| subbands10 | BIT STRING(SIZE(10)), |
| subbands11 | BIT STRING(SIZE(11)), |
| subbands12 | BIT STRING(SIZE(12)), |
| subbands13 | BIT STRING(SIZE(13)), |
| subbands14 | BIT STRING(SIZE(14)), |
| subbands15 | BIT STRING(SIZE(15)), |
| subbands16 | BIT STRING(SIZE(16)), |
| subbands17 | BIT STRING(SIZE(17)), |
| subbands18 | BIT STRING(SIZE(18)), |

...,

| | |
|---|---|
| subbands19-v1530 | BIT STRING(SIZE(19)) |

} OPTIONAL -- Need S

| | |
|---|---|
| } | OPTIONAL, -- Need R |
| timeRestrictionForChannelMeasurements | ENUMERATED {configured, notConfigured}, |

| | |
|---|---|
| timeRestrictionForInterferenceMeasurements | ENUMERATED {configured, |

notConfigured},

| codebookConfig | CodebookConfig | OPTIONAL, -- Need R |
|---|---|---|
| dummy | ENUMERATED {n1, n2} | OPTIONAL, -- Need R |
| groupBasedBeamReporting | CHOICE { | |
| enabled | NULL, | |
| disabled | SEQUENCE { | |
| nrofReportedRS | ENUMERATED {n1, n2, n3, n4} | OPTIONAL -- Need |

```
S
    }
  },
```

| | | |
|---|---|---|
| cqi-Table | ENUMERATED {table1, table2, table3, spare1} | OPTIONAL, - |

- Need R

| | |
|---|---|
| subbandSize | ENUMERATED {value1, value2}, |

| | |
|---|---|
| non-PMI-PortIndication | SEQUENCE (SIZE (1..maxNrofNZP-CSI-RS- |

```
ResourcesPerConfig)) OF PortIndexFor8Ranks OPTIONAL, -- Need R
  ...,
  [[
```

| | |
|---|---|
| semiPersistentOnPUSCH-v1530 | SEQUENCE { |
| reportSlotConfig-v1530 | ENUMERATED {sl4, sl8, sl16} |

| | |
|---|---|
| } | OPTIONAL -- Need R |

]]
}
CSI-ReportPeriodicityAndOffset ::= CHOICE {

| | |
|---|---|
| slots4 | INTEGER(0..3), |
| slots5 | INTEGER(0..4), |
| slots8 | INTEGER(0..7), |
| slots10 | INTEGER(0..9), |
| slots16 | INTEGER(0..15), |
| slots20 | INTEGER(0..19), |
| slots40 | INTEGER(0..39), |
| slots80 | INTEGER(0..79), |
| slots160 | INTEGER(0..159), |
| slots320 | INTEGER(0..319) |

}

| | |
|---|---|
| PUCCH-CSI-Resource ::= | SEQUENCE { |
| uplinkBandwidthPartId | BWP-Id, |
| pucch-Resource | PUCCH-ResourceId |

}

| PortIndexFor8Ranks ::= | CHOICE { | |
|---|---|---|
| portIndex8 | SEQUENCE{ | |
| rank1-8 | PortIndex8 | OPTIONAL, -- Need R |

| | | |
|---|---|---|
| rank2-8 | SEQUENCE(SIZE(2)) OF PortIndex8 | OPTIONAL, -- Need R |
| rank3-8 | SEQUENCE(SIZE(3)) OF PortIndex8 | OPTIONAL, -- Need R |
| rank4-8 | SEQUENCE(SIZE(4)) OF PortIndex8 | OPTIONAL, -- Need R |
| rank5-8 | SEQUENCE(SIZE(5)) OF PortIndex8 | OPTIONAL, -- Need R |
| rank6-8 | SEQUENCE(SIZE(6)) OF PortIndex8 | OPTIONAL, -- Need R |
| rank7-8 | SEQUENCE(SIZE(7)) OF PortIndex8 | OPTIONAL, -- Need R |
| rank8-8 | SEQUENCE(SIZE(8)) OF PortIndex8 | OPTIONAL -- Need R |

},

| portIndex4 | SEQUENCE{ | |
|---|---|---|
| rank1-4 | PortIndex4 | OPTIONAL, -- Need R |

| | | |
|---|---|---|
| rank2-4 | SEQUENCE(SIZE(2)) OF PortIndex4 | OPTIONAL, -- Need R |
| rank3-4 | SEQUENCE(SIZE(3)) OF PortIndex4 | OPTIONAL, -- Need R |
| rank4-4 | SEQUENCE(SIZE(4)) OF PortIndex4 | OPTIONAL -- Need R |

},

| portIndex2 | SEQUENCE{ | |
|---|---|---|
| rank1-2 | PortIndex2 | OPTIONAL, -- Need R |

| | | |
|---|---|---|
| rank2-2 | SEQUENCE(SIZE(2)) OF PortIndex2 | OPTIONAL -- Need R |

},

| | |
|---|---|
| portIndex1 | NULL |

}

| | |
|---|---|
| PortIndex8::= | INTEGER (0..7) |
| PortIndex4::= | INTEGER (0..3) |
| PortIndex2::= | INTEGER (0..1) |

-- TAG-CSI-REPORTCONFIG-STOP
-- ASN1STOP

CSI-ReportConfig field descriptions

carrier
Indicates in which serving cell the CSI-ResourceConfig indicated below are to be found. If
the field is absent, the resources are on the same serving cell as this report configuration.
codebookConfig
Codebook configuration for Type-1 or Type-II including codebook subset restriction.
cqi-FormatIndicator
Indicates whether the UE may report a single (wideband) or multiple (subband) CQI. (see TS
38.214 [19], clause 5.2.1.4).
cqi-Table
Which CQI table to use for CQI calculation (see TS 38.214 [19], clause 5.2.2.1).
csi-IM-ResourcesForInterference
CSI IM resources for interference measurement. csi-ResourceConfigId of a CSI-
ResourceConfig included in the configuration of the serving cell indicated with the field
“carrier” above. The CSI-ResourceConfig indicated here contains only CSI-IM resources. The
bwp-Id in that CSI-ResourceConfig is the same value as the bwp-Id in the CSI-
ResourceConfig indicated by resourcesForChannelMeasurement.
csi-ReportingBand
Indicates a contiguous or non-contiguous subset of subbands in the bandwidth part which CSI
may be reported for. Each bit in the bit-string represents one subband. The right-most bit in
the bit string represents the lowest subband in the BWP. The choice determines the number
of subbands (subbands3 for 3 subbands, subbands4 for 4 subbands, and so on) (see TS 38.214
[19], clause 5.2.1.4). This field is absent if there are less than 24 PRBs (no sub band) and
present otherwise, the number of sub bands can be from 3 (24 PRBs, sub band size 8) to 18
(72 PRBs, sub band size 4).
dummy
This field is not used in the specification. If received it may be ignored by the UE.
groupBasedBeamReporting
Turning on/off group beam based reporting (see TS 38.214 [19], clause 5.2.1.4)
non-PMI-PortIndication
Port indication for RI/CQI calculation. For each CSI-RS resource in the linked
ResourceConfig for channel measurement, a port indication for each rank R, indicating which
R ports to use. Applicable only for non-PMI feedback (see TS 38.214 [19], clause 5.2.1.4.2).
The first entry in non-PMI-PortIndication corresponds to the NZP-CSI-RS-Resource
indicated by the first entry in nzp-CSI-RS-Resources in the NZP-CSI-RS-ResourceSet
indicated in the first entry of nzp-CSI-RS-ResourceSetList of the CSI-ResourceConfig whose
CSI-ResourceConfigId is indicated in a CSI-MeasId together with the above CSI-
ReportConfigId; the second entry in non-PMI-PortIndication corresponds to the NZP-CSI-
RS-Resource indicated by the second entry in nzp-CSI-RS-Resources in the NZP-CSI-RS-
ResourceSet indicated in the first entry of nzp-CSI-RS-ResourceSetList of the same CSI-
ResourceConfig, and so on until the NZP-CSI-RS-Resource indicated by the last entry in nzp-
CSI-RS-Resources in the in the NZP-CSI-RS-ResourceSet indicated in the first entry of nzp-
CSI-RS-ResourceSetList of the same CSI-ResourceConfig. Then the next entry corresponds
to the NZP-CSI-RS-Resource indicated by the first entry in nzp-CSI-RS-Resources in the
NZP-CSI-RS-ResourceSet indicated in the second entry of nzp-CSI-RS-ResourceSetList of
the same CSI-ResourceConfig and so on.
nrofReportedRS
The number (N) of measured RS resources to be reported per report setting in a non-group-
based report. N <= N_max, where N_max is either 2 or 4 depending on UE capability.
(see TS 38.214 [19], clause 5.2.1.4) When the field is absent the UE applies the value 1
nzp-CSI-RS-ResourcesForInterference
NZP CSI RS resources for interference measurement. csi-ResourceConfigId of a CSI-
ResourceConfig included in the configuration of the serving cell indicated with the field
“carrier” above. The CSI-ResourceConfig indicated here contains only NZP-CSI-RS
resources. The bwp-Id in that CSI-ResourceConfig is the same value as the bwp-Id in the CSI-
ResourceConfig indicated by resourcesForChannelMeasurement.
p0alpha
Index of the p0-alpha set determining the power control for this CSI report transmission (see
TS 38.214 [19], clause 6.2.1.2).
pdsch-BundleSizeForCSI
PRB bundling size to assume for CQI calculation when reportQuantity is CRI/RI/i1/CQI. If
the field is absent, the UE assumes that no PRB bundling is applied (see TS 38.214 [19],
clause 5.2.1.4.2).
pmi-FormatIndicator
Indicates whether the UE may report a single (wideband) or multiple (subband) PMI. (see TS
38.214 [19], clause 5.2.1.4).
pucch-CSI-ResourceList
Indicates which PUCCH resource to use for reporting on PUCCH.
reportConfigType
Time domain behavior of reporting configuration
reportFreqConfiguration
Reporting configuration in the frequency domain. (see TS 38.214 [19], clause 5.2.1.4).
reportQuantity
The CSI related quantities to report. Corresponds to L1 parameter “ReportQuantity” (see TS
38.214 [19], clause 5.2.1).
reportSlotConfig
Periodicity and slot offset (see TS 38.214 [19], clause 5.2.1.4).
reportSlotConfig-v1530
Extended value range for reportSlotConfig for semi-persistent CSI on PUSCH. If the field is
present, the UE may ignore the value provided in the legacy field
(semiPersistentOnPUSCH.reportSlotConfig).
reportSlotOffsetList
Timing offset Y for semi persistent reporting using PUSCH. This field lists the allowed offset
values. This list may have the same number of entries as the pusch-TimeDomainAllocationList
in PUSCH-Config. A particular value is indicated in DCI. The network indicates in the DCI
field of the UL grant, which of the configured report slot offsets the UE may apply. The DCI
value 0 corresponds to the first report slot offset in this list, the DCI value 1 corresponds to
the second report slot offset in this list, and so on. The first report is transmitted in slot n + Y,
second report in n + Y + P, where P is the configured periodicity.
Timing offset Y for aperiodic reporting using PUSCH. This field lists the allowed offset
values. This list may have the same number of entries as the pusch-TimeDomainAllocationList
in PUSCH-Config. A particular value is indicated in DCI. The network indicates in the DCI
field of the UL grant, which of the configured report slot offsets the UE may apply. The DCI
value 0 corresponds to the first report slot offset in this list, the DCI value 1 corresponds to
the second report slot offset in this list, and so on (see TS 38.214 [19], clause 5.2.3).
resourcesForChannelMeasurement
Resources for channel measurement. csi-ResourceConfigId of a CSI-ResourceConfig
included in the configuration of the serving cell indicated with the field “carrier” above. The
CSI-ResourceConfig indicated here contains only NZP-CSI-RS resources and/or SSB
resources. This CSI-ReportConfig is associated with the DL BWP indicated by bwp-Id in that
CSI-ResourceConfig.
subbandSize
Indicates one out of two possible BWP-dependent values for the subband size as indicated in
TS 38.214 [19], table 5.2.1.4-2. If csi-ReportingBand is absent, the UE may ignore this field.
timeRestrictionForChannelMeasurements
Time domain measurement restriction for the channel (signal) measurements (see TS 38.214
[19], clause 5.2.1.1)
timeRestrictionForInterferenceMeasurements
Time domain measurement restriction for interference measurements (see TS 38.214 [19],
clause 5.2.1.1)

TABLE 24
The IE CSI-ResourceConfig defines a group of one or more NZP-CSI-
RS-ResourceSet, CSI-IM-ResourceSet and/or CSI-SSB-ResourceSet.
CSI-ResourceConfig information element

-- ASN1START
-- TAG-CSI-RESOURCECONFIG-START

| | |
|---|---|
| CSI-ResourceConfig ::= | SEQUENCE { |
| csi-ResourceConfigId | CSI-ResourceConfigId, |
| csi-RS-ResourceSetList | CHOICE { |
| nzp-CSI-RS-SSB | SEQUENCE { |
| nzp-CSI-RS-ResourceSetList | SEQUENCE (SIZE (1..maxNrofNZP-CSI-RS- |

ResourceSetsPerConfig)) OF NZP-CSI-RS-ResourceSetId

| | |
|---|---|
| | OPTIONAL, -- Need R |
| csi-SSB-ResourceSetList | SEQUENCE (SIZE (1..maxNrofCSI-SSB- |

ResourceSetsPerConfig)) OF CSI-SSB-ResourceSetId

OPTIONAL -- Need R

},

| | |
|---|---|
| csi-IM-ResourceSetList | SEQUENCE (SIZE (1..maxNrofCSI-IM-ResourceSetsPerConfig)) |

OF CSI-IM-ResourceSetId
},

| | |
|---|---|
| bwp-Id | BWP-Id, |
| resourceType | ENUMERATED { aperiodic, semiPersistent, periodic }, |

...
}
-- TAG-CSI-RESOURCECONFIG-STOP
-- ASN1STOP

CSI-ResourceConfig field descriptions

bwp-Id
The DL BWP which the CSI-RS associated with this CSI-ResourceConfig are located in (see
TS 38.214 [19], clause 5.2.1.2
csi-ResourceConfigId
Used in CSI-ReportConfig to refer to an instance of CSI-ResourceConfig
csi-RS-ResourceSetList
Contains up to maxNrofNZP-CSI-RS-ResourceSetsPerConfig resource sets if
ResourceConfigType is “aperiodic” and 1 otherwise (see TS 38.214 [19], clause 5.2.1.2)
csi-SSB-ResourceSetList
List of SSB resources used for beam measurement and reporting in a resource set (see TS
38.214 [19], section FFS_Section)
resourceType
Time domain behavior of resource configuration (see TS 38.214 [19], clause 5.2.1.2). It does
not apply to resources provided in the csi-SSB-ResourceSetList.

TABLE 25
The IE NZP-CSI-RS-ResourceSet is a set of Non-Zero-Power (NZP)
CSI-RS resources (their IDs) and set-specific parameters.
NZP-CSI-RS-ResourceSet information element

-- ASN1START
-- TAG-NZP-CSI-RS-RESOURCESET-START

| | |
|---|---|
| NZP-CSI-RS-ResourceSet ::= | SEQUENCE { |
| nzp-CSI-ResourceSetId | NZP-CSI-RS-ResourceSetId, |
| nzp-CSI-RS-Resources | SEQUENCE (SIZE (1..maxNrofNZP-CSI-RS-ResourcesPerSet)) |

OF NZP-CSI-RS-ResourceId,

| | | |
|---|---|---|
| repetition | ENUMERATED { on, off } | OPTIONAL, -- Need S |
| aperiodicTriggeringOffset | INTEGER(0..6) | OPTIONAL, -- Need S |
| trs-Info | ENUMERATED {true} | OPTIONAL, -- Need R |

...
}
-- TAG-NZP-CSI-RS-RESOURCESET-STOP
-- ASN1STOP

NZP-CSI-RS-ResourceSet field descriptions

aperiodicTriggeringOffset
Offset X between the slot containing the DCI that triggers a set of aperiodic NZP CSI-RS
resources and the slot in which the CSI-RS resource set is transmitted. The value 0
corresponds to 0 slots, value 1 corresponds to 1 slot, value 2 corresponds to 2 slots, value 3
corresponds to 3 slots, value 4 corresponds to 4 slots, value 5 corresponds to 16 slots, value 6
corresponds to 24 slots. When the field is absent the UE applies the value 0.
nzp-CSI-RS-Resources
NZP-CSI-RS-Resources associated with this NZP-CSI-RS resource set (see TS 38.214 [19],
clause 5.2). For CSI, there are at most 8 NZP CSI RS resources per resource set
repetition
Indicates whether repetition is on/off. If the field is set to “OFF” or if the field is absent, the
UE may not assume that the NZP-CSI-RS resources within the resource set are transmitted
with the same downlink spatial domain transmission filter and with same NrofPorts in every
symbol (see TS 38.214 [19], clauses 5.2.2.3.1 and 5.1.6.1.2). Can only be configured for CSI-
RS resource sets which are associated with CSI-ReportConfig with report of L1 RSRP or “no
report”
trs-Info
Indicates that the antenna port for all NZP-CSI-RS resources in the CSI-RS resource set is
same. If the field is absent or released the UE applies the value “false” (see TS 38.214 [19],
clause 5.2.2.3.1).

TABLE 26
The IE CSI-SSB-ResourceSet is used to configure one SS/PBCH block resource
set which refers to SS/PBCH as indicated in ServingCellConfigCommon.
CSI-SSB-ResourceSet information element

-- ASN1START
-- TAG-CSI-SSB-RESOURCESET-START

| | |
|---|---|
| CSI-SSB-ResourceSet ::= | SEQUENCE { |
| csi-SSB-ResourceSetId | CSI-SSB-ResourceSetId, |
| csi-SSB-ResourceList | SEQUENCE (SIZE(1..maxNrofCSI-SSB-ResourcePerSet)) OF SS |

B-Index,
...
}
-- TAG-CSI-SSB-RESOURCESET-STOP
-- ASN1STOP

TABLE 27
The IE CSI-IM-ResourceSet is used to configure a set of one or more CSI Interference
Management (IM) resources (their IDs) and set-specific parameters.
CSI-IM-ResourceSet information element

-- ASN1START
-- TAG-CSI-IM-RESOURCESET-START

| | |
|---|---|
| CSI-IM-ResourceSet ::= | SEQUENCE { |
| csi-IM-ResourceSetId | CSI-IM-ResourceSetId, |
| csi-IM-Resources | SEQUENCE (SIZE(1..maxNrofCSI-IM-ResourcesPerSet)) OF CSI- |

IM-ResourceId,
...
}
-- TAG-CSI-IM-RESOURCESET-STOP
-- ASN1STOP

CSI-IM-ResourceSet field descriptions

csi-IM-Resources
CSI-IM-Resources associated with this CSI-IM-ResourceSet (see TS 38.214 [19], clause 5.2)

TABLE 28
The CSI-AperiodicTriggerStateList IE is used to configure the UE with a list of aperiodic trigger states. Each
codepoint of the DCI field “CSI request” is associated with one trigger state. Upon reception of the
value associated with a trigger state, the UE will perform measurement of CSI-RS (reference signals) and aperiodic
reporting on L1 according to all entries in the associatedReportConfigInfoList for that trigger state.
CSI-AperiodicTriggerState List information element

-- ASN1START
-- TAG-CSI-APERIODICTRIGGERSTATELIST-START
CSI-AperiodicTriggerStateList ::= SEQUENCE (SIZE (1..maxNrOfCSI-AperiodicTriggers))
OF CSI-AperiodicTriggerState

| | |
|---|---|
| CSI-AperiodicTriggerState ::= | SEQUENCE { |

| | |
|---|---|
| associatedReportConfigInfoList | SEQUENCE |

(SIZE(1..maxNrofReportConfigPerAperiodicTrigger)) OF CSI-AssociatedReportConfigInfo,
...
}

| | |
|---|---|
| CSI-AssociatedReportConfigInfo ::= | SEQUENCE { |
| reportConfigId | CSI-ReportConfigId, |
| resourcesForChannel | CHOICE { |
| nzp-CSI-RS | SEQUENCE { |
| resourceSet | INTEGER (1..maxNrofNZP-CSI-RS-ResourceSetsPerConfig), |
| qcl-info | SEQUENCE (SIZE(1..maxNrofAP-CSI-RS-ResourcesPerSet)) OF TCI- |

StateId OPTIONAL -- Cond Aperiodic
},

| | |
|---|---|
| csi-SSB-ResourceSet | INTEGER (1..maxNrofCSI-SSB-ResourceSetsPerConfig) |

},

| | |
|---|---|
| csi-IM-ResourcesForInterference | INTEGER(1..maxNrofCSI-IM-ResourceSetsPerConfig) |

OPTIONAL, -- Cond CSI-IM-ForInterference

| | | |
|---|---|---|
| nzp-CSI-RS-ResourcesForInterference | INTEGER | (1..maxNrofNZP-CSI-RS- |

ResourceSetsPerConfig) OPTIONAL, -- Cond NZP-CSI-RS-ForInterference
...
}
-- TAG-CSI-APERIODICTRIGGERSTATELIST-STOP
-- ASN1STOP

CSI-AssociatedReportConfigInfo field descriptions

csi-IM-ResourcesForInterference
CSI-IM-ResourceSet for interference measurement. Entry number in csi-IM-ResourceSetList
in the CSI-ResourceConfig indicated by csi-IM-ResourcesForInterference in the CSI-
ReportConfig indicated by reportConfigId above (1 corresponds to the first entry, 2 to the
second entry, and so on). The indicated CSI-IM-ResourceSet may have exactly the same
number of resources like the NZP-CSI-RS-ResourceSet indicated in nzp-CSI-RS-
ResourcesforChannel.
csi-SSB-ResourceSet
CSI-SSB-ResourceSet for channel measurements. Entry number in csi-SSB-ResourceSetList
in the CSI-ResourceConfig indicated by resourcesForChannelMeasurement in the CSI-
ReportConfig indicated by reportConfigId above (1 corresponds to the first entry, 2 to the
second entry, and so on).
nzp-CSI-RS-ResourcesForInterference
NZP-CSI-RS-ResourceSet for interference measurement. Entry number in nzp-CSI-RS-
ResourceSetList in the CSI-ResourceConfig indicated by nzp-CSI-RS-
ResourcesForInterference in the CSI-ReportConfig indicated by reportConfigId above (1
corresponds to the first entry, 2 to the second entry, and so on).
qcl-info
List of references to TCI-States for providing the QCL source and QCL type for each NZP-
CSI-RS-Resource listed in nzp-CSI-RS-Resources of the NZP-CSI-RS-ResourceSet
indicated by nzp-CSI-RS-ResourcesforChannel. Each TCI-StateId refers to the TCI-State
which has this value for tci-StateId and is defined in tci-StatesToAddModList in the PDSCH-
Config included in the BWP-Downlink corresponding to the serving cell and to the DL BWP
to which the resourcesForChannelMeasurement (in the CSI-ReportConfig indicated by
reportConfigId above) belong to. First entry in qcl-info-forChannel corresponds to first entry
in nzp-CSI-RS-Resources of that NZP-CSI-RS-ResourceSet, second entry in qcl-info-
forChannel corresponds to second entry in nzp-CSI-RS-Resources, and so on (see TS 38.214
[19], clause 5.2.1.5.1)
reportConfigId
The reportConfigId of one of the CSI-ReportConfigToAddMod configured in CSI-
MeasConfig
resourceSet
NZP-CSI-RS-ResourceSet for channel measurements. Entry number in nzp-CSI-RS-
ResourceSetList in the CSI-ResourceConfig indicated by resourcesForChannelMeasurement
in the CSI-ReportConfig indicated by reportConfigId above (1 corresponds to the first entry,
2 to the second entry, and so on).

| Conditional Presence | Explanation |
|---|---|
| Aperiodic | The field is mandatory present if the NZP-CSI-RS-Resources |
| | in the associated resourceSet have the resourceType aperiodic. |
| | The field is absent otherwise. |
| CSI-IM-ForInterference | This field is optional need M if the CSI-ReportConfig |
| | identified by reportConfigId is configured with csi-IM- |
| | ResourcesForInterference; otherwise it is absent. |
| NZP-CSI-RS- | This field is optional need M if the CSI-ReportConfig |
| ForInterference | identified by reportConfigId is configured with nzp-CSI-RS- |
| | ResourcesForInterference; otherwise it is absent. |

TABLE 29
The CSI-SemiPersistentOnPUSCH-TriggerStateList IE is used to configure
the UE with list of trigger states for semi-persistent reporting of
channel state information on L1. See also TS 38.214, clause 5.2.
CSI-SemiPersistentOnPUSCH-TriggerStateList information element

-- ASN1START
-- TAG-CSI-SEMIPERSISTENTONPUSCHTRIGGERSTATELIST-START
CSI-SemiPersistentOnPUSCH-TriggerStateList ::= SEQUENCE(SIZE (1..maxNrOfSemiPersi
stentPUSCH-Triggers)) OF CSI-SemiPersistentOnPUSCH-TriggerState

| | |
|---|---|
| CSI-SemiPersistentOnPUSCH-TriggerState ::= | SEQUENCE { |
| associatedReportConfigInfo | CSI-ReportConfigId, |

...
}
-- TAG-CSI-SEMIPERSISTENTONPUSCHTRIGGERSTATELIST-STOP
-- ASN1STOP

With respect to the aforementioned CSI report settings (CSI-ReportConfig), each report setting CSI-ReportConfig may be associated with one downlink (DL) bandwidth part identified by a higher-layer parameter bandwidth part identifier (bwp-id) given by CSI resource setting CSI-ResourceConfig associated with the corresponding report setting. As time domain reporting for each report setting CSI-ReportConfig, “aperiodic,” “semi-persistent,” and “periodic” schemes may be supported, and these schemes may be configured for the UE by the base station via a reportConfigType parameter configured from a higher layer. A semi-persistent CSI report method may support a “PUCCH-based semi-persistent (semi-PersistentOnPUCCH)” method and a “PUSCH-based semi-persistent (semi-PersistentOnPUSCH)” method. For the periodic or semi-persistent CSI report method, a PUCCH or PUSCH resource in which CSI is to be transmitted may be configured for the UE by the base station via higher-layer signaling. A periodicity and a slot offset of the PUCCH or PUSCH resource in which CSI is to be transmitted may be given by a numerology of an uplink (UL) bandwidth part configured for CSI report transmission. For the aperiodic CSI report method, a PUSCH resource in which CSI is to be transmitted may be scheduled for the UE by the base station via LI signaling (e.g., aforementioned DCI format 0_1).

With respect to the aforementioned CSI resource settings (CSI-ResourceConfig), each CSI resource setting CSI-ReportConfig may include S (≥1) CSI resource sets (e.g., given via a higher-layer parameter of csi-RS-ResourceSetList). A CSI resource set list may include a non-zero power (NZP) CSI-RS resource set and an SS/PBCH block set or may include a CSI-interference measurement (CSI-IM) resource set. Each CSI resource setting may be positioned in a downlink (DL) bandwidth part identified by higher-layer parameter bwp-id and may be connected to CSI report setting in the same downlink bandwidth part. A time domain operation of a CSI-RS resource in CSI resource setting may be configured to be one of “aperiodic,” “periodic,” or “semi-persistent” from the higher-layer parameter resourceType. With respect to the periodic or semi-persistent CSI resource setting, the number of CSI-RS resource sets may be limited to S (S=1), and the configured periodicity and slot offset may be given based on numerology of the downlink bandwidth part identified by bwp-id. One or more CSI resource settings for channel or interference measurement may be configured for the UE by the base station via higher-layer signaling, and may include, for example, the following CSI resources.
CSI-IM resource for interference measurement
NZP CSI-RS resource for interference measurement
NZP CSI-RS resource for channel measurement

With respect to CSI-RS resource sets associated with a resource setting in which the higher-layer parameter of resourceType is configured to be “aperiodic,” “periodic,” or “semi-persistent,” a trigger state of CSI report setting having reportType configured to be “aperiodic,” and a resource setting for channel or interference measurement on one or multiple component cells (CCs) may be configured via the higher-layer parameter of CSI-AperiodicTriggerStateList.

Aperiodic CSI reporting of the UE may be performed using a PUSCH, periodic CSI reporting may be performed using a PUCCH, and semi-persistent CSI reporting may be performed using a PUSCH when triggered or activated via DCI, and may be performed using a PUCCH after activated via a MAC control element (MAC CE). As described above, CSI resource setting may also be configured to be aperiodic, periodic, or semi-persistent. A combination of CSI reporting setting and CSI resource setting may be supported based on Table 30 below.

TABLE 30

| CSI-RS | Periodic CSI | Semi-Persistent CSI | Aperiodic CSI |
|---|---|---|---|
| Configuration | Reporting | Reporting | Reporting |
| Periodic CSI-RS | No dynamic | For reporting on | Triggered by DCI; |
| | triggering/activation | PUCCH, the UE | additionally, |
| | | receives an activation | activation command |
| | | command [10, TS | [10, TS 38.321] |
| | | 38.321]; for reporting | possible as defined in |
| | | on PUSCH, the UE | Subclause 5.2.1.5.1. |
| | | receives triggering | |
| | | on DCI | |
| Semi-Persistent | Not Supported | For reporting on | Triggered by DCI; |
| CSI-RS | | PUCCH, the UE | additionally, |
| | | receives an activation | activation command |
| | | command [10, TS | [10, TS 38.321] |
| | | 38.321]; for reporting | possible as defined in |
| | | on PUSCH, the UE | Subclause 5.2.1.5.1. |
| | | receives triggering | |
| | | on DCI | |
| Aperiodic | Not Supported | Not Supported | Triggered by DCI; |
| CSI-RS | | | additionally, |
| | | | activation command |
| | | | [10, TS 38.321] |
| | | | possible as defined in |
| | | | Subclause 5.2.1.5.1. |

Aperiodic CSI reporting may be triggered by a “CSI request” field in DCI format 0_1 described above, which corresponds to scheduling DCI for a PUSCH. The UE may monitor a PDCCH, may acquire DCI format 0_1, and may acquire scheduling information of a PUSCH and a CSI request indicator. The CSI request indicator may be configured to have NTS (=0, 1, 2, 3, 4, 5, or 6) bits, and may be determined by higher-layer signaling (reportTriggerSize). One trigger state among one or multiple aperiodic CSI report trigger states which may be configured via higher-layer signaling (CSI-AperiodicTriggerStateList) may be triggered by the CSI request indicator.
If all bits in the CSI request field are 0, this may indicate that CSI reporting is not requested.
If the number M of configured CSI trigger states in CSI-AperiodicTriggerStateLite is greater than 2NTS-1, M CSI trigger states may be mapped to 2NTs-1 trigger states according to a predefined mapping relation, and one trigger state among the 2NTS-1 trigger states may be indicated by the CSI request field.
If the number M of configured CSI trigger states in CSI-AperiodicTriggerStateLite is less than or equal to 2NTS-1, one of the M CSI trigger states may be indicated by the CSI request field.

Table 31 below shows an example of a relationship between a CSI request indicator and a CSI trigger state that may be indicated by a corresponding indicator.

TABLE 31

| CSI request | CSI trigger | CSI- | CSI- |
|---|---|---|---|
| field | state | ReportConfigId | ResourceConfigId |
| 00 | no CSI request | N/A | N/A |
| 01 | CSI trigger state#1 | CSI report#1 | CSI resource#1, |
| | | CSI report#2 | CSI resource#2 |
| 10 | CSI trigger state#2 | CSI report#3 | CSI resource#3 |
| 11 | CSI trigger state#3 | CSI report#4 | CSI resource#4 |

The UE may measure a CSI resource in a CSI trigger state triggered via the CSI request field, and then generate CSI (including, for example, at least one of the CQI, PMI, CRI, SSBRI, LI, RI, or L1-RSRP described above) based on the measurement. The UE may transmit the acquired CSI by using the PUSCH scheduled via corresponding DCI format 0_1. If one bit corresponding to an uplink data indicator (UL-SCH indicator) in DCI format 0_1 indicates “1,” the UE may multiplex uplink data (UL-SCH) and the acquired CSI on the PUSCH resource scheduled by DCI format 0_1 so as to transmit the same. If one bit corresponding to the uplink data indicator (UL-SCH indicator) in DCI format 0_1 indicates “0,” the UE may map only CSI, without uplink data (UL-SCH), to the PUSCH resource scheduled by DCI format 0_1 so as to transmit the same.

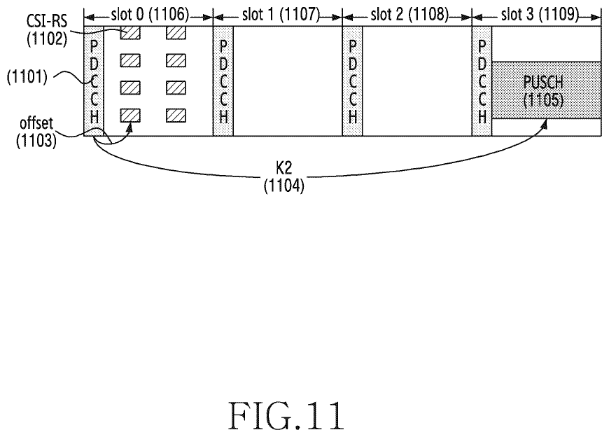

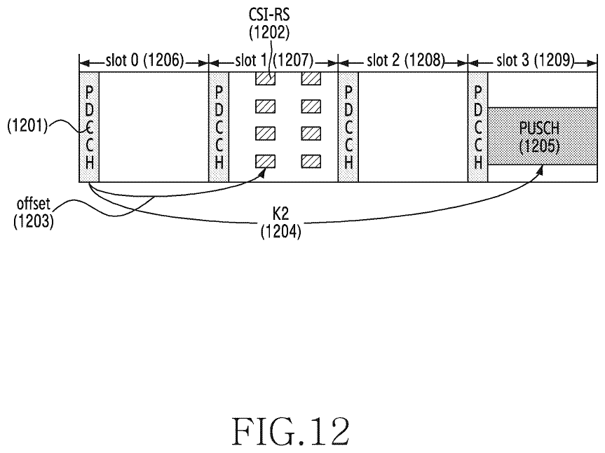

FIGS. 11 and 12 illustrate aperiodic CSI reporting methods in a case where a CSI-RS offset is 0 according to an embodiment of the disclosure.

Referring to FIG. 11, the UE may acquire DCI format 0_1 by monitoring a PDCCH 1101, and may acquire scheduling information and CSI request information for a PUSCH 1105 therefrom. The UE may acquire resource information of a CSI-RS 1102 to be measured, from a received CSI request indicator. The UE may determine a time point at which the UE needs to measure a resource of the CSI-RS 1102, based on a time point at which DCI format 0_1 is received, and a parameter for an offset (e.g., aforementioned aperiodicTriggeringOffset) in a CSI resource set configuration (e.g., an NZP CSI-RS resource set configuration (NZP-CSI-RS-ResourceSet)). More specifically, the UE may be configured with an offset value X of the parameter, aperiodicTriggeringOffset, in the NZP-CSI-RS resource set configuration from a base station via higher-layer signaling, and the configured offset value X may refer to an offset between a slot in which DCI triggering aperiodic CSI reporting is received, and a slot in which the CSI-RS resource is transmitted. For example, aperiodicTriggeringOffset parameter values and offset values X may have mapping relationships as shown in Table 32 below.

TABLE 32

| aperiodicTriggeringOffset | Offset X | |
|---|---|---|
| 0 | 0 | slot |
| 1 | 1 | slot |
| 2 | 2 | slots |
| 3 | 3 | slots |
| 4 | 4 | slots |
| 5 | 16 | slots |
| 6 | 24 | slots |

Referring to FIG. 12, the above-described offset value may be configured as X=0. In this case, the UE may receive the CSI-RS 1102 in a slot (corresponding to slot 0 in FIG. 11) in which DCI format 0_1 triggering aperiodic CSI reporting is received, and may report CSI information, which is measured based on the received CSI-RS, to the base station via the PUSCH 1105. The UE may acquire, from DCI format 0_1, scheduling information (information corresponding to each field of DCI format 0_1 described above) on the PUSCH 1105 for CSI reporting. For example, in DCI format 0_1, the UE may acquire information on a slot in which the PUSCH 1105 is to be transmitted, from time domain resource allocation information for the PUSCH 1105 described above. In the example of FIG. 11, the UE acquires 3 as a K2 value corresponding to a slot offset value for PDCCH-to-PUSCH, and accordingly, the PUSCH 1105 may be transmitted in slot 3 1109, which is spaced 3 slots apart from slot 0 1106, i.e., a time point at which the PDCCH 1101 has been received.

In the example of FIG. 12, the UE may acquire DCI format 0_1 by monitoring a PDCCH 1201, and may acquire scheduling information and CSI request information for a PUSCH 1205 therefrom. The UE may acquire resource information of a CSI-RS 1202 to be measured, from a received CSI request indicator. The example of FIG. 12 shows an example in which the above-described offset value for the CSI-RS is configured as X=1. In this case, the UE may receive the CSI-RS 1202 in a slot (corresponding to slot 0 in FIG. 12) in which DCI format 0_1 triggering aperiodic CSI reporting is received, and may report CSI information, which is measured based on the received CSI-RS, to the base station via the PUSCH 1205.

Next, a bandwidth part (BWP) configuration in the 5G communication system will be described in detail with reference to the accompanying drawings.

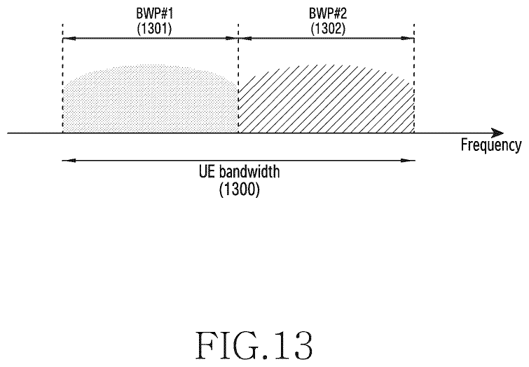

FIG. 13 illustrates a bandwidth part configuration in a 5G communication system according to an embodiment of the disclosure.

Referring to FIG. 13, a UE bandwidth 1300 is configured to include two bandwidth parts, that is, bandwidth part #1 (BWP #1) 1301 and bandwidth part #2 (BWP #2) 1302. A base station may configure one or multiple bandwidth parts for a UE, and may configure the following pieces of information with regard to each bandwidth part as given in Table 33 below. Obviously, the examples given below are not limiting.

TABLE 33

| | |
|---|---|
| BWP ::= | SEQUENCE { |
| bwp-Id | BWP-Id, |
| locationAndBandwidth | INTEGER (1..65536), |
| subcarrierSpacing | ENUMERATED {n0, n1, n2, n3, n4, n5}, |
| cyclicPrefix | ENUMERATED { extended } |

}

The base station may transfer the configuration information to the UE through upper layer signaling, for example, radio resource control (RRC) signaling. One configured bandwidth part or at least one bandwidth part among multiple configured bandwidth parts may be activated. Whether or not the configured bandwidth part is activated may be transferred from the base station to the UE semi-statically through RRC signaling, or dynamically through downlink control information (DCI).

Before a radio resource control (RRC) connection, an initial bandwidth part (BWP) for initial access may be configured for the UE by the base station through a master information block (MIB). More specifically, the UE may receive configuration information regarding a control resource set (CORESET) and a search space which may be used to transmit a PDCCH for receiving system information (which may correspond to remaining system information (RMSI) or system information block 1 (SIB1) necessary for initial access through the MIB in the initial access step. Each of the control resource set and the search space configured through the MIB may be considered identity (ID) 0. The base station may notify the UE of configuration information, such as frequency allocation information, time allocation information, and numerology, regarding control resource region #0 through the MIB. In addition, the base station may notify the UE of configuration information regarding the monitoring cycle and occasion with regard to control resource set #0, that is, configuration information regarding search space #0, through the MIB. The UE may consider that a frequency domain configured by control resource set #0 acquired from the MIB is an initial bandwidth part for initial access. In this case, the identity (ID) of the initial bandwidth part may be considered 0.

The bandwidth part-related configuration supported by 5G may be used for various purposes.

According to an embodiment, if the bandwidth supported by the UE is smaller than the system bandwidth, this may be supported through the bandwidth part configuration. For example, the base station may configure the frequency location (configuration information 2) of the bandwidth part for the UE, so that the UE can transmit/receive data at a specific frequency location within the system bandwidth.

The base station may configure multiple bandwidth parts for the UE for the purpose of supporting different numerologies. For example, in order to support a UE's data transmission/reception using both a subcarrier spacing of 15 kHz and a subcarrier spacing of 30 kHz, two bandwidth parts may be configured as subcarrier spacings of 15 kHz and 30 kHz, respectively. Different bandwidth parts may be subjected to frequency division multiplexing (FDM), and if data is to be transmitted/received at a specific subcarrier spacing, the bandwidth part configured as the corresponding subcarrier spacing may be activated.

In addition, according to an embodiment, the base station may configure bandwidth parts having different sizes of bandwidths for the UE for the purpose of reducing power consumed by the UE. For example, if the UE supports a substantially large bandwidth, for example, 100 MHz, and always transmits/receives data with the corresponding bandwidth, a substantially large amount of power consumption may occur. Particularly, it may be substantially inefficient from the viewpoint of power consumption to unnecessarily monitor the downlink control channel with a large bandwidth of 100 MHz in the absence of traffic. In order to reduce power consumed by the UE, the base station may configure a bandwidth part of a relatively small bandwidth (for example, a bandwidth part of 20 MHz) for the UE. The UE may perform a monitoring operation in the 20 MHz bandwidth part in the absence of traffic, and may transmit/receive data with the 100 MHz bandwidth part as instructed by the base station if data has occurred.

In connection with the bandwidth part configuring method, UEs, before being RRC-connected, may receive configuration information regarding the initial bandwidth part through an MIB in the initial access step. To be more specific, a UE may have a control resource set (CORESET) configured for a downlink control channel which may be used to transmit downlink control information (DCI) for scheduling a system information block (SIB) from the MIB of a physical broadcast channel (PBCH). The bandwidth of the control resource set configured by the MIB may be considered as the initial bandwidth part, and the UE may receive, through the configured initial bandwidth part, a physical downlink shared channel (PDSCH) through which an SIB is transmitted. The initial bandwidth part may be used not only for the purpose of receiving the SIB, but also for other system information (OSI), paging, random access, or the like.

If a UE has one or more bandwidth parts configured therefor, the base station may indicate, to the UE, to change the bandwidth parts by using a bandwidth part indicator field inside DCI. As an example, referring to FIG. 13, if the currently activated bandwidth part of the UE is bandwidth part #1 1301, the base station may indicate bandwidth part #2 1302 with a bandwidth part indicator inside DCI, and the UE may change the bandwidth part to bandwidth part #2 1302 indicated by the bandwidth part indicator inside received DCI.

As described above, DCI-based bandwidth part changing may be indicated by DCI for scheduling a PDSCH or a PUSCH, and thus, upon receiving a bandwidth part change request, the UE needs to be able to receive or transmit the PDSCH or PUSCH scheduled by the corresponding DCI in the changed bandwidth part with no problem. To this end, requirements for the delay time (TBWP) provided during a bandwidth part change are specified in standards, and may be defined given in Table 34 below, for example.

TABLE 34

| | |
|---|---|
| NR Slot | BWP switch delay T_{BWP} (slots) |

| μ | length (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 17 |

^{Note 1}
Depends on UE capability.
Note 2:
If the BWP switch involves changing of SCS, the BWP switch delay is determined by the larger one between the SCS before BWP switch and the SCS after BWP switch.

The requirements for the bandwidth part change delay time support type 1 or type 2, depending on the capability of the UE. The UE may report the supportable bandwidth part change delay time type to the base station.

If the UE has received DCI including a bandwidth part change indicator in slot n, according to the above-described requirement regarding the bandwidth part change delay time, the UE may complete a change to the new bandwidth part indicated by the bandwidth part change indicator at a timepoint not later than slot n+TBWP, and may transmit/receive a data channel scheduled by the corresponding DCI in the newly changed bandwidth part. According to an embodiment, if the base station wants to schedule a data channel by using the new bandwidth part, the base station may determine time domain resource allocation regarding the data channel, based on the UE's bandwidth part change delay time (TBWP). That is, when scheduling a data channel by using the new bandwidth part, the base station may schedule the corresponding data channel after the bandwidth part change delay time, in connection with the method for determining time domain resource allocation regarding the data channel. Accordingly, the UE may not expect that the DCI that indicates a bandwidth part change will indicate a slot offset (K0 or K2) value smaller than the bandwidth part change delay time (TBWP).

If the UE has received DCI (for example, DCI format 1_1 or 0_1) indicating a bandwidth part change, the UE may perform no transmission or reception during a time interval from the third symbol of the slot used to receive a PDCCH including the corresponding DCI to the start point of the slot indicated by a slot offset (K0 or K2) value indicated by a time domain resource allocation indicator field in the corresponding DCI. For example, if the UE has received DCI indicating a bandwidth part change in slot n, and if the slot offset value indicated by the corresponding DCI is K, the UE may perform no transmission or reception from the third symbol of slot n to the symbol before slot n+K (for example, the last symbol of slot n+K−1).

Subsequently, a method of configuring transmission/reception-related parameters for each bandwidth part in 5G will be described.

A UE may be configured with one or multiple bandwidth parts from a base station, and may additionally be configured with parameters (e.g., configuration information relating to uplink/downlink data channels and control channels) to be used for transmission and reception for each configured bandwidth part. For example, referring to FIG. 13, when the UE is configured with bandwidth part #1 1301 and bandwidth part #2 1302, the UE may be configured with transmission/reception parameter #1 for bandwidth part #1 1301 and may be configured with transmission/reception parameter #2 for bandwidth part #2 1302. When bandwidth part #1 1301 is activated, the UE may perform transmission to and reception from the base station based on transmission/reception parameter #1, and when bandwidth part #2 1302 is activated, the UE may perform transmission to and reception from the base station based on transmission/reception parameter #2.

More specifically, the following parameters may be configured for the UE from the base station.

First, information in Table 35 may be configured for an uplink bandwidth part.

TABLE 35
BWP-Uplink ::= SEQUENCE {

| | |
|---|---|
| bwp-Id (bandwidth part identifier) | BWP-Id, |

bwp-Common (cell-specific or common parameter) BWP-UplinkCommon OPTIONAL, -
- Cond SetupOtherBWP

| | |
|---|---|
| bwp-Dedicated (UE-specific parameter) | BWP-UplinkDedicated OPTIONAL, -- Cond |

```
SetupOtherBWP
}
BWP-UplinkCommon ::= SEQUENCE {
  genericParameters (general parameter) BWP,
  rach-ConfigCommon (random access-related common parameter) SetupRelease { RACH-
ConfigCommon } OPTIONAL, -- Need M
  pusch-ConfigCommon (PUSCH-related common parameter) SetupRelease { PUSCH-
ConfigCommon } OPTIONAL, -- Need M
  pucch-ConfigCommon (PUCCH-related common parameter) SetupRelease { PUCCH-
ConfigCommon } OPTIONAL, -- Need M
}
BWP-UplinkDedicated ::= SEQUENCE {
  pucch-Config (PUCCH-related UE-specific parameter) SetupRelease { PUCCH-Config }
OPTIONAL, -- Need M
  pusch-Config (PUSCH-related UE-specific parameter) SetupRelease { PUSCH-Config }
OPTIONAL, -- Need M
  configuredGrantConfig (Configured grant-related parameter) SetupRelease
{ ConfiguredGrantConfig } OPTIONAL, -- Need M
```

| | |
|---|---|
| srs-Config (SRS-related parameter)) SetupRelease { SRS-Config } | OPTIONAL, -- Need |

M
beamFailureRecoveryConfig (beam failure recovery-related parameter)) SetupRelease
{ BeamFailureRecoveryConfig } OPTIONAL, -- Cond SpCellOnly
}

According to [Table 35], the base station may configure, for the UE, cell-specific (or cell-common or common) transmission-related parameters (e.g., parameters relating to a random-access channel (RACH), an uplink control channel (physical uplink control channel (PUCCH), and an uplink data channel (physical uplink shared channel) (corresponding to BWP-UplinkCommon). In addition, the base station may configure, for the UE, UE-specific (or UE-dedicated) transmission-related parameters (e.g., parameters relating to PUCCH, PUSCH, uplink transmission with a configured grant (configured grant PUSCH), and a sounding reference signal (SRS)) (corresponding to BWP-UplinkDedicated).

Subsequently, the following information may be configured as in Table 36 for a downlink bandwidth part.

TABLE 36
BWP-Downlink ::= SEQUENCE {

| | |
|---|---|
| bwp-Id (bandwidth part identifier) | BWP-Id, |

bwp-Common (cell-specific or common parameter) BWP-DownlinkCommon
OPTIONAL, -- Cond SetupOtherBWP

| | |
|---|---|
| bwp-Dedicated (UE-specific parameter) | BWP-DownlinkDedicated OPTIONAL, -- Cond |

```
SetupOtherBWP
}
BWP-DownlinkCommon ::= SEQUENCE {
  genericParameters (general parameter) BWP,
  pdcch-ConfigCommon (PDCCH-related common parameter) SetupRelease { PDCCH-
ConfigCommon } OPTIONAL, -- Need M
  pdsch-ConfigCommon (PDSCH-related common parameter) SetupRelease { PDSCH-
ConfigCommon } OPTIONAL, -- Need M
}
BWP-DownlinkDedicated ::= SEQUENCE {
  pdcch-Config (PDCCH-related UE-specific parameter) SetupRelease { PDCCH-Config }
OPTIONAL, -- Need M
  pdsch-Config (PDSCH-related UE-specific parameter) SetupRelease { PDSCH-Config }
OPTIONAL, -- Need M
  sps-Config (SPS-related parameter) SetupRelease { SPS-Config } OPTIONAL, -- Need
M
  radioLinkMonitoringConfig (RLM-related parameter) SetupRelease
{ RadioLinkMonitoringConfig } OPTIONAL, -- Cond SpCellOnly
}
```

According to [Table 36], the base station may configure, for the UE, cell-specific (or cell-common or common) reception-related parameters (e.g., parameters relating to a downlink control channel (physical downlink control channel (PDCCH)) and a downlink data channel (physical downlink shared channel)) (corresponding to BWP-DownlinkCommon). The base station may configure, for the UE, UE-specific (or UE-dedicated) reception-related parameters (e.g., parameters relating to PDCCH, PDSCH, downlink data transmission with a configured grant (semi-persistent scheduled PDSCH), and radio link monitoring (RLM)) (corresponding to BWP-UplinkDedicated).

Hereinafter, discontinuous reception (DRX) configurations in the 5G communication system will be described in detail.

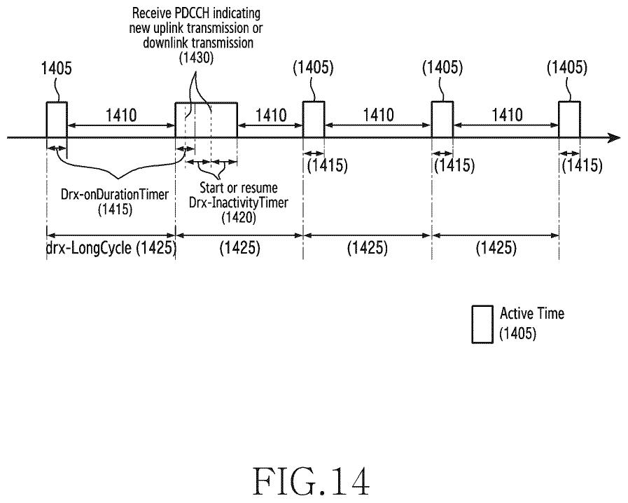

FIG. 14 illustrates discontinuous reception (DRX) in a 5G communication system according to an embodiment of the disclosure.

DRX refers to an operation in which a UE currently using a service discontinuously receives data in an RRC-connected state in which a radio link is established between the base station and the UE. If the DRX is applied, the UE may turn on a receiver at a specific timepoint so as to monitor a control channel, and may turn off the receiver if there is no data received for a predetermined period of time, thereby reducing power consumed by the UE. The DRX operation may be controlled by a MAC layer device, based on various parameters and timers.

Referring to FIG. 14, Active time 1405 refers to a time during which the UE wakes up at each DRX cycle and monitors the PDCCH. The Active time 1405 may be defined as follows:
drx-onDuration Timer or drx-InactivityTimer ordrx-RetransmissionTimerDL or drx-RetransmissionTimerUL or ra-ContentionResolutionTimer is running;
a Scheduling Request is sent on PUCCH and is pending; or
a PDCCH indicating a new transmission addressed to the C-RNTI of the MAC entity has not been received after successful reception of a Random Access Response for the Random Access Preamble not selected by the MAC entity among the contention-based Random Access Preamble.

drx-onDurationTimer, drx-InactivityTimer, drx-RetransmissionTimerDL, drx-RetransmissionTimerUL, ra-ContentionResolutionTimer, and the like are timers having values configured by the base station, and may include functions which configure the UE to monitor the PDCCH in a situation in which a predetermined condition is satisfied.

drx-onDurationTimer 1415 is a parameter for configuring the minimum time during which the UE is awake at the DRX cycle. drx-InactivityTimer 1420 is a parameter for configuring a time during which the UE is additionally awake upon receiving a PDCCH indicating new uplink transmission or downlink transmission (1430). drx-RetransmissionTimerDL is a parameter for configuring the maximum time during which the UE is awake in order to receive downlink retransmission in a downlink HARQ procedure. drx-RetransmissionTimerUL is a parameter for configuring the maximum time during which the UE is awake in order to receive an uplink retransmission grant in an uplink HARQ procedure. drx-onDurationTimer, drx-Inactivity Timer, drx-RetransmissionTimerDL, and drx-RetransmissionTimerUL may be configured as, for example, time, the number of subframes, the number of slots, and the like. ra-ContentionResolutionTimer is a parameter for monitoring the PDCCH in a random access procedure.

inActive time 1410 refers to a time configured such that the PDCCH is not monitored during the DRX operation or a time configured such that the PDCCH is not received, and the inActive time 1410 may be obtained by subtracting the Active time 1405 from the entire time during which the DRX operation is performed. If the UE does not monitor the PDCCH during the Active time 1405, the UE may enter a sleep or inActive state, thereby reducing power consumption.

The DRX cycle may refer to the cycle at which the UE wakes up and monitors the PDCCH. That is, the DRX cycle refers to the time interval between when the UE monitors a PDCCH and when the next PDCCH is monitored, or the cycle at which on-duration occurs. There are two kinds of DRX cycles: a short DRX cycle and a long DRX cycle. The short DRX cycle may be optionally applied.

The long DRX cycle 1425 is the longer cycle between two DRX cycles configured for the UE. While operating at long DRX, the UE restarts the drx-onDuration Timer 1415 at a timepoint at which the long DRX cycle 1425 has elapsed from the start point (for example, start symbol) of the drx-onDurationTimer 1415. If operating at the long DRX cycle 1425, the UE may start the drx-onDurationTimer 1415 in a slot after drx-SlotOffset in a subframe satisfying Equation 1 below. Here, drx-SlotOffset may refer to a delay before the drx-onDuration Timer 1415 is started. The drx-SlotOffset may be configured, for example, as time, the number of slots, or the like.

$$[ ( SFN \times 10 ) + subframe number ] modulo ( drx - LongCycle ) = drx - StartOffset \qquad [ Equation 2 ]$$

where, drx-LongCycleStartOffset may be used to define the long DRX cycle 1425, and drx-StartOffset may be used to define a subframe to start the long DRX cycle 1425. drx-LongCycleStartOffset may be configured as, for example, time, the number of subframes, the number of slots, or the like.

The short DRX cycle is the shorter cycle between two DRX cycles configured for the UE. While operating at the long DRX cycle 1425, if a predetermined event, for example, reception of a PDCCH indicating new uplink or downlink transmission (14300 occurs, the UE may start or restart the drx-InactivityTimer 1420, and if the drx-Inactivity Timer 1420 is expired or a DRX command MAC CE is received, may operate at the short DRX cycle. In FIG. 14, as an example, the UE may start the drx-ShortCycleTimer at a time point when the previous drx-onDuration Timer 1415 or drx-InactivityTimer 1420 is expired, and operate at the short DRX cycle until the drx-ShortCycleTimer is expired. If a PDCCH indicating new uplink or downlink transmission is received (1430), the UE may also expect additional uplink or downlink transmission in the future and thus extend the Active time 1405 or delay arrival of the InActive time 1410. While operating at the short DRX cycle, the UE may start the drx-onDurationTimer 1415 again at a time point when the short DRX cycle has elapsed from the start point of the previous on duration. Subsequently, if the drx-ShortTimer is expired, the UE may operate the long DRX cycle 1425 again.

If operating at the long DRX cycle, the UE may start the drx-onDuration Timer 1415 in a slot after drx-SlotOffset in a subframe satisfying Equation 3 below. Here, drx-SlotOffset refers to a delay before the drx-onDurationTimer 1415 is started. For example, drx-SlotOffset may be configured as time, the number of slots, or the like.

$$[ ( SFN \times 10 ) + ( subframe number ] modulo ( drx - ShortCycle ) = ( drx - StartOffset ) modulo ( drx - ShortCycle ) \qquad [ Equation 3 ]$$

where, drx-ShortCycle and drx-StartOffset may be used to define a subframe to start the short DRX cycle. drx-ShortCycle and drx-StartOffset may be configured as, for example, time, the number of subframes, the number of slots, or the like.

The DRX operation has been described above with reference to FIG. 14. According to an embodiment, the UE may reduce power consumption thereof by performing the DRX operation. However, even when performs the DRX operation, the UE may not always receive a PDCCH associated with the UE in the Active time 1405. Therefore, an embodiment of the disclosure may provide a signal for controlling the operation of the UE for the purpose of power saving of the UE.

In the 5G system, a new UE state referred to as RRC_INACTIVE has been defined to reduce the energy and time consumed for the UE's initial access. The RRC_INACTIVE UE may perform the following processes in addition to operations performed by an RRC_IDLE UE. Obviously, the examples given below are not limiting:
Storing access stratum (AS) information necessary for cell access;
A UE-specific DRX cycle operation configured by the RRC layer;
Configuring a radio access network (RAN)-based notification area (RNA) which may be used during a handover by the RRC layer, and periodically performing update; and/or
Monitoring a RAN-based paging message transmitted through an inactive-radio network temporary identifier (I-RNTI).

The UE in the RRC_CONNECTED state may receive an RRC release indication from the gNB and may change from the RRC_CONNECTED state to an RRC_INACTIVE/RRC_IDLE state.

The UE in the RRC_INACTIVE/RRC_IDLE state may perform a random access, complete the entire random access procedure, and change from the RRC_INACTIVE/RRC_IDLE state to the RRC_CONNECTED state.

Hereinafter, descriptions will be provided for a scheduling method in which a base station transmits downlink data to a UE or indicates the UE to transmit uplink data.

Downlink control information (DCI) may be control information transmitted by the base station to the UE via a downlink. Downlink control information (DCI) may include downlink data scheduling information or uplink data scheduling information for a predetermined UE. In general, a base station may independently channel-code DCI for each UE, and then transmit the DCI to each UE via a physical downlink control channel (PDCCH) that is a downlink physical control channel.

For a UE for scheduling, a base station may perform operation by applying a predetermined DCI format according to purposes, such as whether scheduling information is for downlink data (downlink assignment), whether scheduling information is for uplink data (uplink grant), or whether DCI is for power control.

The base station may transmit downlink data to the UE via a physical downlink shared channel (PDSCH) that is a physical channel for downlink data transmission. The base station may inform the UE of scheduling information, such as power control information, HARQ-related control information, a modulation scheme, and a specific mapping position in the time and frequency domains of a PDSCH, via DCI related to downlink data scheduling information in the DCI transmitted via a PDCCH.

The UE may transmit uplink data to the base station via a physical uplink shared channel (PUSCH) that is a physical channel for uplink data transmission. The base station may inform the UE of scheduling information, such as power control information, HARQ-related control information, a modulation scheme, and specific mapping positions in the time and frequency domains of the PUSCH, via DCI related to uplink data scheduling information in the DCI transmitted via the PDCCH.

The RRC_IDLE/RRC_INACTIVE UE may perform the aforementioned DRX operation and may receive a paging message. The UE may monitor one paging occasion (PO) during a DRX cycle. The PO may be a set of PDCCH monitoring occasions, and may include multiple time slots (or subframes or OFDM symbols) in which paging control information may be transmitted and received. A paging frame (PF) may be one radio frame (10 ms), and may include one or multiple POs or a start point (e.g., an offset) of PO.

PF and PO may be determined by the following equations.

A system frame number (SFN) for a PF may be determined by (SFN+PF_offset) mod T=(T div N)*(UE_ID mod N), where PF_offset is an offset for PF determination, Tis a DRX cycle, and N is the number of PFs per DRX cycle (e.g., cell common or cell specific), which may be determined by a higher signal, such as system information, and UE_ID is a UE_ID (e.g., 5G-S-TMSI) and may be determined by a core network.

PFs determined by N may refer to paging frames commonly applied to UEs within a cell and, for convenience hereinafter, may be referred to as cell common PFs.

i_s indicating a PO index may be determined by i_s=floor (UE_ID/N) mod Ns, where Ns may refer to the number of POs in one PF, and may be determined by a higher signal, such as system information.

For example, when it is assumed that PF_offset=3, T=128, N=T/4=32, and Ns=4, and UE_ID is one in which UE_ID mod 32 is 1, and floor (UE_ID/32) mod 4 is 1, parameter values may be determined by the following equations.

$$( SFN + 3 ) mod 128 = ( 128 div 32 ) * ( UE\_ID mod 32 ) = 4 * 1 = 4 ,$$

$$i\_s = floor ( UE\_ID / 32 ) mod 4 = 1.$$

Accordingly, the PF which is a paging frame that the UE having UE_ID needs to receive may be determined to be a radio frame in which the SFN is 1, 129, 257, . . . among cell common PFs, and the PO may be determined to be an (i_s+1)th PO among four POs in the PF.

Hereinafter, more specific details are provided regarding paging early indication (PEI) reception. In order to reduce power consumption of the UE while monitoring and receiving a paging control channel and a paging data channel at each DRX cycle, the UE may receive a PEI.

According to various embodiments of the disclosure, the UE may monitor or receive one PEI occasion (PEI-O) before paging reception during the DRX cycle. When the UE receives a PEI and the PEI indicates a paging occasion and a subgroup to which the UE belongs, the UE belonging to the subgroup may monitor the associated paging occasion (PO). If the UE is unable to detect the PEI at the PEI occasion, or the PEI does not indicate the paging occasion and the subgroup to which the UE belongs, the UE does not need to monitor the associated paging occasion (PO), thereby reducing UE power consumption.

The UE may determine a PEI occasion in the following manner. The PEI occasion may be separated backward by a subframe offset based on a radio frame of a reference point separated forward by pei-FrameOffset based on a PF including an associated PO. The UE may monitor a PEI in the PEI occasion determined in the manner described above. Here, the pei-FrameOffset, the subframe offset, etc. may be determined by a higher signal, such as system information.

Hereinafter, embodiments of the disclosure will be described in detail in conjunction with the accompanying drawings. The contents of the disclosure may be applied to FDD, TDD, and/or XDD (and/or SBFD) systems. As used herein, upper signaling (or upper layer signaling) is a method for transferring signals from a base station to a UE by using a downlink data channel of a physical layer, or from the UE to the base station by using an uplink data channel of the physical layer, and may also be referred to as “RRC signaling,” “PDCP signaling,” or “medium access control (MAC) control element (MAC CE).”

Hereinafter, for the sake of descriptive convenience, a cell, a transmission point, a panel, a beam, and/or a transmission direction which can be distinguished through an upper layer/L1 parameter such as a TCI state or spatial relation information, a cell ID, a TRP ID, or a panel ID may be described as a TRP, a beam, or a TCI state as a whole. Therefore, during actual application, a TRP, a beam, or a TCI state may be appropriately replaced with one of the above terms.

Hereinafter, embodiments of the disclosure will be described in detail in conjunction with the accompanying drawings. In the following description, a base station is an entity that allocates resources to terminals, and may be at least one of a gNode B, a gNB, an eNode B, an eNB, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the following description of embodiments of the disclosure, a 5G system will be described by way of example, but the embodiments of the disclosure may also be applied to other communication systems having similar technical backgrounds or channel types. Examples of such communication systems may include LTE or LTE-A mobile communication systems and mobile communication technologies developed beyond 5G. Therefore, based on determinations by those skilled in the art, the embodiments of the disclosure may also be applied to other communication systems through some modifications without significantly departing from the scope of the disclosure. The contents of the disclosure may be applied to FDD, TDD, and XDD (or SBFD, full duplex) systems.

In the following description of the disclosure, upper layer signaling may refer to signaling corresponding to at least one signaling among the following signaling, or a combination of one or more thereof:
Master information block (MIB);
System information block (SIB) or SIB X (X=1, 2, . . . );
Radio resource control (RRC); and/or
Medium access control (MAC) control element (CE).

In addition, L1 signaling may refer to signaling corresponding to at least one signaling method among signaling methods using the following physical layer channels or signaling, or a combination of one or more thereof:
Physical downlink control channel (PDCCH);
Downlink control information (DCI);
UE-specific DCI;
Group common DCI;
Common DCI;
Scheduling DCI (for example, DCI used for the purpose of scheduling downlink or uplink data);
Non-scheduling DCI (for example, DCI not used for the purpose of scheduling downlink or uplink data);
Physical uplink control channel (PUCCH); and/or
Uplink control information (UCI).

As used herein, the term “slot” may generally refer to a specific time unit corresponding to a transmit time interval (TTI), may specifically refer to a slot used in a 5G NR system, or may refer to a slot or a subframe used in a 4G LTE system.

In the disclosure, deep sleep and ultra-deep sleep may be distinguished based on which components within a cell/base station can be turned off. For example, if a main radio (MR) is completely turned off, this may indicate that all components within the main radio are turned off. When the main radio is in a deep sleep state, an oscillator, a radio frequency-front end (RF-FE), and a baseband modem may be turned off, while a control processor and a double data rate (DDR) memory may be still turned on. When the main radio is in an ultra-deep sleep state, the oscillator, the radio frequency-front end (RF-FE), and the baseband modem may be turned off, and the control processor and the DDR memory may operate with very low power or may be turned off.

Embodiments of the disclosure may be applied to RRC idle, RRC inactive, and RRC connected UEs. Of course, the disclosure is not limited to the examples above.

In the disclosure, the fact that a specific cell is for data communication and/or only for data communication may include not only that the specific cell performs data communication, but also that the specific cell performs other signal transmission and reception. For example, signal transmission and reception other than sync and/or connection may be included in data communication.

In the disclosure, a cell being switched to a specific state may include that the cell maintains the specific state without changing the state. For example, a cell being switched to a deep sleep state or an ultra-deep sleep state may include that the cell maintains the deep sleep state or the ultra-deep sleep state.

Hereinafter, in the disclosure, the examples above are described via multiple embodiments. However, these are not independent, and one or more embodiments may be applied simultaneously or in combination.

As described above, in the 5G system, in order to achieve ultra-high-speed data services reaching several Gbps, ultra-wide bandwidth signal transmission and reception are supported or a spatial multiplexing method using multiple transmission/reception antennas is used, while various power saving modes are supported to reduce power consumption of a UE. On the other hand, excessive power consumption may also occur at a base station.

For example, the number of required power amplifiers (PAS) also increases in proportion to the number of transmission antennas provided in a base station or a UE. A maximum output of a base station and a UE depends on a characteristic of a power amplifier, and in general, a maximum output of a base station depends on a cell size covered by the base station. A maximum output is usually expressed in dBm. A maximum output of a UE is usually 23 dBm or 26 dBm.

As an example of a commercial 5G base station, the base station may be equipped with 64 transmission antennas and 64 corresponding power amplifiers in a 3.5 GHz frequency band and may operate with a bandwidth of 100 MHz. Accordingly, energy consumption of the base station increases in proportion to outputs and operation times of the power amplifiers.

When compared to an LTE base station, the 5G base station has a relatively high operating frequency band so as to have a wide bandwidth and a large number of transmission antennas. This characteristic is effective in increasing a data rate, but comes at the cost of increased base station energy consumption. Therefore, as there are more base stations constituting a mobile communication network, energy consumption of the entire mobile communication network may increase in proportion thereto.

As described above, energy consumption of a base station is largely dependent on a power amplifier operation. Since a power amplifier is involved in a base station transmission operation, downlink (DL) transmission of the base station is highly related to energy consumption of the base station. Relatively, an uplink (UL) reception operation of the base station does not account for a large portion of energy consumption of the base station. Physical channels and physical signals transmitted by a base station on a downlink are as follows:
Physical downlink shared channel (PDSCH): a downlink data channel including data to be transmitted to one or multiple UEs;
Physical downlink control channel (PDCCH): a downlink control channel including scheduling information for a PDSCH and a physical uplink control channel (PUSCH). Alternatively, a PDCCH may be transmitted alone without a PDSCH or PUSCH to be scheduled, and control information, such as a slot format and a power control command, may be transmitted on the PDCCH. The scheduling information includes resource information to which the PDSCH or PUSCH is mapped, hybrid automatic repeat request (HARQ)-related information, power control information, etc.;
Physical broadcast channel (PBCH): a downlink broadcast channel that provides a master information block (MIB) which is essential system information for transmission and reception of a data channel and a control channel of a UE;
Primary synchronization signal (PSS): a signal that serves as a reference for DL time and/or frequency (hereinafter, time/frequency) synchronization, and provides some information on a cell ID;
Secondary synchronization signal (SSS): a signal that serves as a reference for DL time/frequency synchronization and provides some remaining information on the cell ID;
Demodulation reference signal (DM-RS): a reference signal for channel estimation of a UE for each PDSCH, PDCCH, and PBCH;
Channel-state information reference signal (CSI-RS): a downlink signal that serves as a reference for downlink channel state measurement by a UE; and/or
Phase-tracking reference signal (PT-RS): a downlink signal for phase tracking.

From the perspective of base station energy saving, when a base station stops a downlink transmission operation, a power amplifier operation is stopped accordingly, which increases the effect of saving base station energy, and not only the operation of the power amplifier but also the operation of a remaining base station device, such as a baseband device, is reduced, which enables additional energy saving.

Similarly, even for an uplink reception operation which accounts for a relatively small portion of the total energy consumption of the base station, if the uplink reception is stoppable, additional energy savings may be achieved.

A downlink transmission operation of the base station basically depends on the amount of downlink traffic. For example, if there is no data to be transmitted to a UE via a downlink, the base station does not need to transmit a PDSCH and a PDCCH for scheduling of the PDSCH. Alternatively, if transmission can be suspended for a moment for a reason, such as data not being sensitive to a transmission delay, the base station may not transmit a PDSCH and/or a PDCCH.

On the other hand, physical channels and physical signals, such as PSS, SSS, PBCH, and CSI-RS, are transmitted repeatedly at a predetermined periodicity regardless of data transmission to the UE. Therefore, even if the UE does not receive data, the UE may continuously update downlink time/frequency synchronization, a downlink channel state, a radio link quality, etc. In other words, PSS, SSS, PBCH, and CSI-RS necessarily perform downlink transmission regardless of downlink data traffic, and may result in base station energy consumption. Therefore, base station energy savings may be achieved by controlling transmission of the PSS, SSS, PBCH, and CSI-RS signals, which are unrelated (or have low relevance) to data traffic, to occur less frequently. It is apparent that signals that are unrelated (or have low relevance) to data traffic are not limited to the PSS, SSS, PBCH, and CSI-RS.

According to an embodiment of the disclosure, during a time period when the base station does not perform downlink transmission via the aforementioned energy saving method, the effect of base station energy saving can be maximized by stopping or minimizing operations of power amplifiers of the base station and operations of an RF device, a baseband device, etc. related thereto.

In addition, according to an embodiment of the disclosure, energy consumption of the base station can be reduced by switching off some of the antennas or power amplifiers of the base station. In this case, as a counteraction to the energy saving effect of the base station, a negative effect, such as a decrease in cell coverage or a decrease in throughput, may be accompanied.

For example, for the base station which is equipped with 64 transmission antennas and corresponding 64 power amplifiers, and operates with a 100 MHz bandwidth in the 3.5 GHz frequency band as described above, if the base station activates only 4 transmission antennas and 4 power amplifiers, and switches off the rest for a predetermined time period in order to save base station energy, base station energy consumption will be reduced to approximately 1/16 (=4/64) during the time period, but due to the decrease in maximum transmission power and beamforming gain, it becomes difficult to achieve the existing cell coverage and throughput obtained when the 64 antennas and power amplifiers are assumed.

The aforementioned base station energy saving methods may be reclassified into three categories. The base station energy saving methods includes a base station energy saving method in a frequency domain, in which a BWP size is adjusted according to traffic of the base station, a base station energy saving method in a spatial domain, in which the number of antenna ports is adaptively decreased, and a base station energy saving method in a time domain, in which cycles of CSI-RS, SSB, and DRX are adjusted. These three types of base station energy saving methods may be used alone or in combination depending on the characteristics of the base station, such as base station traffic or coverage, and information changed according to the energy saving method may need to be shared with/transmitted to the UE.

In addition, according to an embodiment, the energy saving method may be performed in the same manner within a single base station or within multiple base stations. When the energy saving method is performed within a single base station, only very limited energy saving benefits may be obtained due to the presence of an idle UE. Therefore, when multiple base stations cooperate to perform base station energy saving, greater energy saving benefits may be obtained.

Hereinafter, the base station energy saving methods provided in the disclosure are described via specific embodiments. The first to third embodiments described below may be implemented separately and/or at least partially combined.

### First Embodiment

The first embodiment relates to downlink synchronization signal transmission for realizing energy saving.

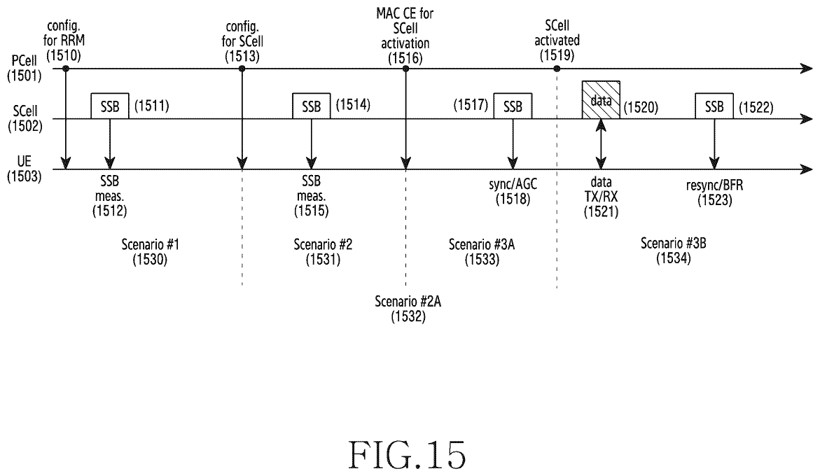

FIG. 15 illustrates an applicable SCell activation procedure according to an embodiment of the disclosure.

Referring to FIG. 15, a UE 1503 may receive, from a PCell 1501 that is a serving cell, a trigger indicating to connect to an SCell 1502 for carrier aggregation (CA). The UE 1503 may receive a configuration for RRM measurement from the PCell 1501 so as to receive downlink synchronization signals (e.g., an SSB 1511) from candidate cells to identify whether the SCell 1502 is a suitable cell, and the UE 1503 may measure 1512 power of the downlink synchronization signal 1511 (e.g., the SSB) from the SCell 1502. The PCell 1501 provides a configuration 1513 for the SCell to the UE, and the UE 1503 may measure 1515 a downlink synchronization signal 1514 coming from the target cell and perform synchronization. When a command 1516 for MAC-CE-based SCell activation is received from the PCell 1501, the UE 1503 may receive an SSB 1517 coming from the target cell and perform synchronization (sync) and automatic gain control (AGC) 1518. During this procedure, the SCell 1502 may transmit a CSI-RS for channel measurement to the UE, and the UE having received the CSI-RS may perform CSI feedback for the same so that the SCell 1502 may be activated 1519. The UE 1503 may transmit and receive 1521 data 1520 to and from the activated SCell 1502, and then may control 1523 synchronization (sync) and beam failure recovery (BFR) via a downlink synchronization signal 1522 that comes periodically. For the following descriptions, from 1510 to 1513 is configured as scenario #1 1530, from 1513 to 1516 is configured as scenario #2 1531, a time point of 1516 is configured as scenario #2A 1532, from 1516 to 1519 is configured as scenario #3A 1533, and a time after 1519 is configured as scenario #3B 1534.

The downlink synchronization signals (which may be, for example, SSBs and other types of signals that function similarly to the SSBs. For convenience, hereinafter, the signals are referred to as SSB) transmitted from the SCell of FIG. 15 may be configured as follows. Of course, the disclosure is not limited to the following example:
Normal SSB: has a reference SSB periodicity (e.g., 20 ms);
NES SSB: may have a longer periodicity (e.g., 160 ms) than a normal SSB; and/or
No SSB: may not transmit an SSB to save more base station energy compared to a NES SSB. Since the UE needs to receive an SSB unconditionally for activation of the SCell, a normal SSB or a NES SSB may be transmitted when a specific trigger is received from the PCell.

If the SCell operates using a normal SSB, the UE may have enough time before receiving data, so that there is no problem performing data decoding due to receiving multiple SSBs. However, the SCell may operate in a network energy saving (NES) mode so as to transmit an SSB with a longer periodicity than normal. In this case, the UE is unable to obtain sufficient synchronization from the SCell, so that data decoding may fail.

Therefore, according to an embodiment of the disclosure, when the SCell is operating with a long periodicity using a NES SSB or is not transmitting an SSB, the PCell may trigger an on-demand SSB to transmit downlink synchronization quickly and only for a short period of time. The on-demand SSB may be configured to have a periodicity that is equal to or shorter than that of a normal SSB. For configuration for this on-demand SSB, the PCell may configure, for the UE, a start point and a duration, a start point and an end point, or a start point and the number of SSB burst transmissions, for the on-demand SSB to be transmitted from the SCell.

According to an embodiment of the disclosure, a trigger message for the on-demand SSB may be configured via RRC, MAC-CE, or DCI, and since the SCell itself is able to operate in a NES mode, a common (i.e., group common) configuration may be transmitted to multiple UEs.

According to an embodiment of the disclosure, since a role of the on-demand SSB is to ensure smooth synchronization between the UE and the SCell, and also to ensure smooth decoding of data to be transmitted from the SCell in the NES mode, the start point for the on-demand SSB may be at or before the time point 1516 at which the command for MAC-CE-based SCell activation is received from the PCell 1501 in FIG. 15. That is, in scenario #2 and scenario #2A, the trigger for the on-demand SSB may be transmitted from the PCell.

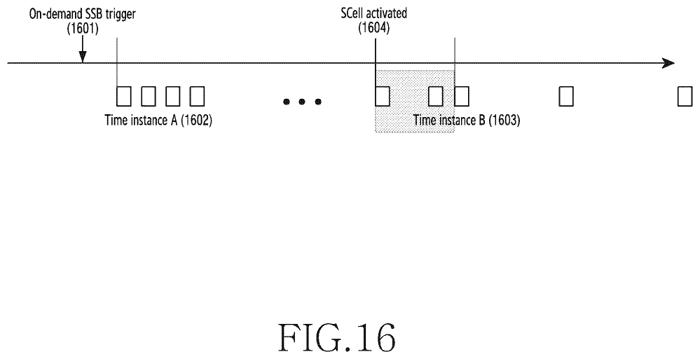

FIG. 16 illustrates a transmission of a normal synchronization signal by an SCell, which has not been transmitting a downlink synchronization signal, when a UE activates the SCell before a configured on-demand synchronization signal end time after an on-demand synchronization signal trigger, according to an embodiment of the disclosure.

In FIG. 16, when a UE receives an on-demand SSB trigger 1601 from a PCell, an SCell, which has been transmitting a NES SSB or which has not been transmitting any SSB, may prepare for on-demand SSB transmission. In addition, for configuration of a transmission period of an on-demand SSB, time instances A 1602 and B 1603 may be configured. The on-demand SSB may be transmitted between A and B, but when the SCell is activated 1604, the UE may sufficiently be synchronized with the SCell, so that there is no need to perform SSB monitoring with a short periodicity. In addition, in order to reduce unnecessary power, the SCell may transmit a normal SSB or a NES SSB instead of the on-demand SSB.

Therefore, according to an embodiment of the disclosure, without separate signaling from the PCell or the SCell, at the same time when the SCell is activated, the UE may expect no on-demand SSB to be transmitted from the SCell and determine to receive a normal SSB or a NES SSB, and may monitor a separate occasion or an occasion corresponding to a periodicity of the normal SSB or NES SSB.

That is, the UE may perform the following operations. Of course, the disclosure is not limited to the following example.

According to an embodiment of the disclosure, after the previously configured end time of the on-demand SSB, if the SCell is successfully activated at the UE, the UE may monitor an occasion according to an SSB configuration other than the on-demand SSB configuration. According to an embodiment of the disclosure, the other SSB configuration may include a configuration of determining whether the UE in a fallback mode monitors an SSB according to an occasion of a normal SSB or NES SSB after the end time of the on-demand SSB, and/or monitors a normal SSB or a NES SSB by receiving an additional indication from the PCell or the SCell.

According to an embodiment of the disclosure, after the previously configured end time of the on-demand SSB, if the SCell is not successfully activated at the UE, the UE may monitor an occasion according to the other SSB configuration, while expecting that the on-demand SSB will no longer be transmitted. According to an embodiment of the disclosure, the other SSB configuration may include a configuration of determining whether the UE in a fallback mode monitors an SSB according to an occasion of a normal SSB or NES SSB after the end time of the on-demand SSB, and/or monitors a normal SSB or a NES SSB via an additional indication from the PCell or the SCell.

According to an embodiment of the disclosure, before the previously configured end time of the on-demand SSB, if the SCell is successfully activated at the UE, the UE may monitor an occasion according to the other SSB configuration. According to an embodiment of the disclosure, the other SSB configuration may include a configuration of determining whether the UE in a fallback mode monitors an SSB according to an occasion of a normal SSB or NES SSB before the end time of the on-demand SSB, or monitors a normal SSB or a NES SSB via an additional indication from the PCell or the SCell.

According to an embodiment of the disclosure, before the previously configured end time of the on-demand SSB, if the SCell is not successfully activated at the UE, the UE may monitor an occasion according to the on-demand SSB configuration.

According to an embodiment of the disclosure, when determining an SSB to be monitored among a normal SSB and a NES SSB, the following operations may be possible. Of course, the disclosure is not limited to the following examples.

According to an embodiment, if the normal SSB and the NES SSB share configurations but only have different periodicities, an SSB periodicity may be configured via an RRC reconfiguration.

In addition, according to an embodiment, if SSBs for respective methods do not share configurations, the UE may fall back to the previously received configuration. If the UE receives both configurations, an SSB to be monitored may be indicated from the PCell or the SCell via RRC/MAC-CE/DCI.

According to an embodiment of the disclosure, when indicated via RRC, the UE may follow an SSB configuration that is RRC reconfigured. When configured by MAC-CE, an octet may be defined according to three configurations (the configurations of normal SSB, NES SSB, and on-demand SSB) or various combinations where each of the three configurations has a different periodicity, and the UE may monitor an SSB according to an activated configuration corresponding to the value 1 of the octet. The remaining configurations may correspond to the value 0. In the case of DCI, one field may be configured to one bit (for two configurations) or multi bits (for more than two configurations), the configuration may be defined according to the field, and the UE receives an SSB corresponding to the configuration indicated by the DCI.

In addition, as another method, it may be assumed that the UE receives a normal SSB or a NES SSB instead of the on-demand SSB via additional signaling from the PCell or SCell.

According to an embodiment of the disclosure, after the previously configured end time of the on-demand SSB, if the SCell is successfully activated at the UE, the UE may monitor an occasion according to an SSB configuration other than the on-demand SSB configuration. According to an embodiment of the disclosure, the other SSB configuration may include a configuration of determining whether the UE in a fallback mode monitors an SSB according to an occasion of a normal SSB or NES SSB after the end time of the on-demand SSB, and/or monitors a normal SSB or a NES SSB by receiving an additional indication from the PCell or the SCell.

According to an embodiment of the disclosure, after the previously configured end time of the on-demand SSB, if the SCell is not successfully activated at the UE, the UE may monitor an occasion according to the other SSB configuration, while expecting that the on-demand SSB will no longer be transmitted. According to an embodiment of the disclosure, the other SSB configuration may include a configuration of determining whether the UE in a fallback mode monitors an SSB according to an occasion of a normal SSB or NES SSB after the end time of the on-demand SSB, and/or monitors a normal SSB or a NES SSB via an additional indication from the PCell or the SCell.

According to an embodiment of the disclosure, before the previously configured end time of the on-demand SSB, if the SCell is successfully activated at the UE, the UE may monitor an occasion according to an SSB configuration other than the on-demand SSB configuration via additional signaling from the PCell or the SCell. According to an embodiment of the disclosure, the other SSB configuration may include a configuration of being indicated about whether the UE in a fallback mode monitors an SSB according to an occasion of a normal SSB or NES SSB before the end time of the on-demand SSB, or monitors a normal SSB or a NES SSB via signaling received from the PCell or the SCell. If no additional signaling is received from the PCell or the SCell, the UE may receive the on-demand SSB until the on-demand SSB end time.

Before the previously configured end time of the on-demand SSB, if the SCell is not successfully activated at the UE, the UE may monitor an occasion according to the on-demand SSB configuration.

According to an embodiment of the disclosure, when determining an SSB to be monitored among a normal SSB and a NES SSB, operations may be performed similarly to a case where early termination of the on-demand SSB is not notified by separate signaling from the PCell or the SCell, and one bit indicating early termination of the on-demand SSB may also be used and transmitted via MAC-CE or DCI.

In addition, according to an embodiment of the disclosure, for an operation on a single carrier in an unpaired spectrum for SSB reception, with respect to a set of symbols in a slot indicated to the UE by ssb-PositionsInBurst in SIB1 or ssb-PositionsInBurst in ServingCellConfigCommon, the UE may not transmit a physical uplink shared channel (PUSCH), a physical uplink control channel (PUCCH), and a physical random-access channel (PRACH) in the slot. SSB transmission may overlap with any symbol from the set of symbols, and the UE may not transmit a sounding reference signal (SRS) in the set of symbols in the slot. The UE may not expect that the set of symbols in the slot will be indicated for an uplink by tdd-UL-DL-ConfigurationCommon or tdd-UL-DLConfigurationDedicated when SSB transmission is provided.

According to an embodiment of the disclosure, since various SSB modes (e.g., normal, NES, and on-demand modes) are configured and the UE may monitor the various SSB modes, there is no need to configure a dropping rule for UL signals limited to SSB of SIB1. Therefore, the dropping rule for UL signals may also be updated according to a mode type of a monitored SSB, and consequently, based on which SSB the UL signals are updated may be determined according to the aforementioned method and correspond to the SSB monitored by the UE.

Therefore, the wording “by ssb-PositionsInBurst in SIB1 or ssb-PositionsInBurst in ServingCellConfigCommon” described above may be changed depending on the monitored SSB.

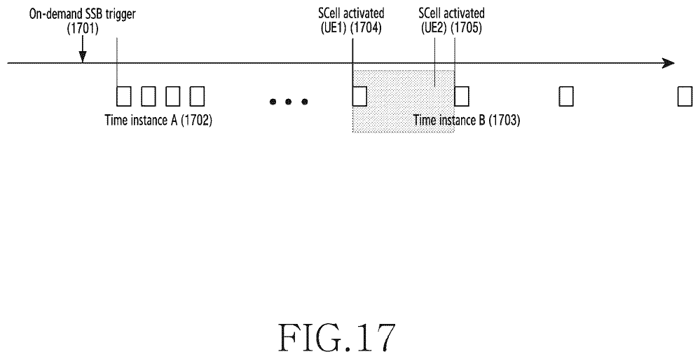

FIG. 17 is a diagram for a case where FIG. 16 is extended to multiple UEs.

In FIG. 17, when multiple UEs receive an on-demand SSB trigger 1701 from a PCell, an SCell, which has been transmitting a NES SSB or which has not been transmitting any SSB, may prepare for on-demand SSB transmission. It may be assumed that the on-demand SSB trigger 1701 is a group-specific signal supporting multiple UEs. In addition, for configuration of a transmission period of an on-demand SSB, time instances A 1702 and B 1703 may be configured. The on-demand SSB may be transmitted between A and B, but when the SCell is activated 1704 and 1705, the UEs may sufficiently be synchronized with the SCell, so that there is no need to perform SSB monitoring with a short periodicity. In addition, in order to reduce unnecessary power, the SCell may transmit a normal SSB or a NES SSB instead of the on-demand SSB.

However, if the SCell is first activated 1704 for UE 1, and then a normal SSB or a NES SSB is transmitted instead of the on-demand SSB as shown in FIG. 16, UE 2 is unable to identify on-demand SSB information, and may thus determine that a link to the SCell has been disconnected because there is no SSB in an on-demand SSB occasion. In order to solve this, if even one UE in the same group activates the SCell, the SCell may provide other UEs in the group with information on switching to a normal SSB. The information on switching to the normal SSB may be transmitted via MAC-CE, RRC, or DCI, like an SCell activation command. UEs which have not yet been deactivated and have received the information on switching to the normal SSB may receive the normal SSB instead of the on-demand SSB at a time when the information is received or after a specific time of m slots from a time when the command is received. Here, m slots may include a time to transmit HARQ ACK for the information on switching to the normal SSB.

### Second Embodiment

The second embodiment relates to a time when a UE receives an on-demand downlink synchronization signal and an occasion for each downlink synchronization signal when a trigger for the on-demand downlink synchronization signal is transmitted from a PCell.

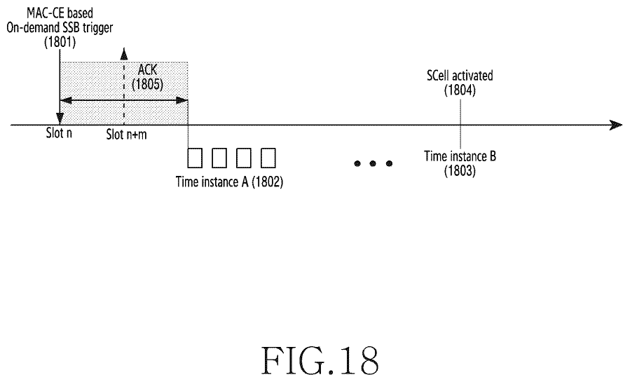

FIG. 18 illustrates a point in time when a UE receives an on-demand downlink synchronization signal after receiving an on-demand downlink synchronization signal trigger, according to an embodiment of the disclosure.

According to FIG. 18, a UE may receive an on-demand SSB trigger 1801. Along with the on-demand SSB trigger 1801, configuration information for an on-demand SSB may also be provided to the UE, and the configuration information for the on-demand SSB may include start point A 1802 and end point B 1803 as information on an on-demand SSB transmission period. According to an embodiment of the disclosure, a PCell may not directly inform the UE about start point A 1802. For example, when it is assumed that the on-demand SSB and a normal or NES SSB share the same SSB occasion, it may be implicitly known that the SSB is transmitted from an SSB occasion closest to the on-demand SSB trigger 1801. Alternatively, when the on-demand SSB trigger 1801 is transmitted via MAC CE, the UE may transmit HARQ ACK for the trigger. That is, when the on-demand SSB trigger is transmitted in an n-th slot, the UE may transmit ACK 1805 in an (n+m)th slot, and then the on-demand SSB may be transmitted from point A. Here, between slot (n+m) and slot A, the PCell may indicate an SCell to transmit the on-demand SSB after reception of the ACK. Therefore, this preparation time may be specified separately, or the UE may receive the on-demand SSB by performing monitoring from an SSB occasion closest to a time when the UE has transmitted the ACK.

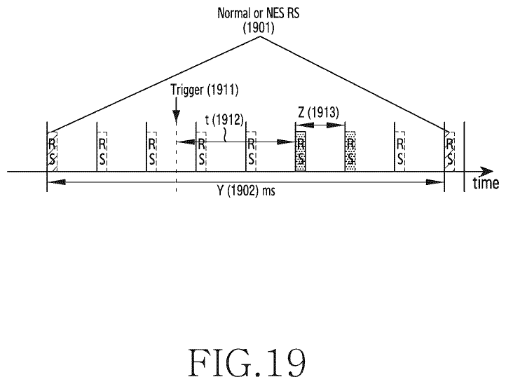

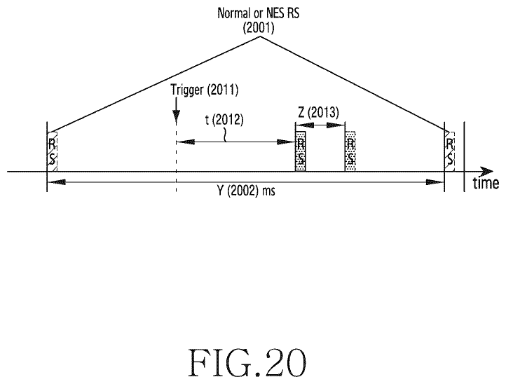

FIGS. 19 and 20 relate to occasions of on-demand SSBs, normal SSBs, and NES SSBs.

FIG. 19 illustrates a situation where occasions of on-demand downlink synchronization signals, normal downlink synchronization signals, and NES downlink synchronization signals are shared, according to an embodiment of the disclosure.

According to FIG. 19, a cell targeted as an SCell by a UE transmits a NES SSB 1901. The NES SSB 1901 is transmitted with a long periodicity of Y ms 1902. An occasion of an on-demand SSB transmitted in this cell may be shared with an occasion of the NES SSB. Therefore, although an occasion exists, the UE may identify a position at which an SSB is to be transmitted before resources are reserved, and when an on-demand SSB trigger 1911 is transmitted from a PCell, an SSB occasion may be reserved for an on-demand SSB from a configured period and transmitted. According to an embodiment of the disclosure, the configured period may indicate that the SSB is transmitted after time t 1912 from the triggering, and this may operate as in FIG. 18. Therefore, in this case, the configuration for the on-demand SSB may be kept very minimal while enabling transmission.

According to an embodiment of the disclosure, information on existing downlink synchronization signals may be configured as follows according to Table 37.

```
TABLE 37
SSB-Configuration::= SEQUENCE {
  ssb-Freq ARFCN-ValueNR,
  ssbSubcarrierSpacing SubcarrierSpacing,
  ssb-Periodicity ENUMERATED { ms5, ms10, ms20, ms40, ms80, ms160, spare2,spare1 }
  OPTIONAL, -- Need S
  ssb-PositionsInBurst CHOICE {
    shortBitmap BIT STRING (SIZE (4)),
    mediumBitmap BIT STRING (SIZE (8)),
    longBitmap BIT STRING (SIZE (64))
  }
  ss-PBCH-BlockPower INTEGER (−60..50) OPTIONAL -- Cond Pathloss
}
```

Here, ssb-Freq relates to an ARFCN value at which the current SSB is transmitted, and ssbSubcarrierSpacing and ssb-Periodicity relate to a subcarrier spacing and a periodicity used in the SSB, respectively. ss-PBCH-BlockPower relates to an average EPRE of resource elements for transferring an SSS at power (dBm) used for SSB transmission by a base station. According to an embodiment of the disclosure, if the on-demand SSB shares the occasion with the existing SSB, only periodicity information may be additionally configured. For example, a separate periodicity value may be directly transferred to the UE, or a value of 1/N times a normal SSB periodicity may be configured. An example of this may be configured as in Table 38.

```
TABLE 38
onDemandSSB-Configuration::= SEQUENCE {
  onDemandSsb-StartTime INTEGER (0..9},
  onDemandSsb-EndTime ENUMERATED { ms5, ms10, ms20, ms40, ms80, ms160,
  spare2,spare1 } OPTIONAL, -- Need S
  onDemandSsb-Periodicity ENUMERATED { 1, ½, ¼, ⅛, 1/16, spare2,spare1 }
  OPTIONAL, -- Need S
}
```

For example, for configuration information of onDemandSSB, a start point and an end point of on-demand SSB transmission may be configured as onDemandSsb-StartTime and onDemandSsb-EndTime, respectively, and a periodicity for this may be configured based on the periodicity of the normal SSB. If it is assumed that the normal SSB is transmitted at a periodicity of 20 ms and onDemandSsb-Periodicity is configured to ¼, the UE may perform SSB monitoring at a periodicity of 5 ms. In addition, according to an embodiment, the SSB configuration may be transmitted based on a minimum periodicity for the on-demand SSB, and a transmission periodicity for the normal or NES SSB may be indicated as a multiple of the on-demand SSB periodicity.

FIG. 20 illustrates a situation where occasions of on-demand downlink synchronization signals, normal downlink synchronization signals, and NES downlink synchronization signals are not shared, according to an embodiment of the disclosure.

According to FIG. 20, a cell targeted as an SCell by a UE transmits a NES SSB 2001. The NES SSB 2001 may be transmitted with a long periodicity of Y ms 2002. An occasion of an on-demand SSB transmitted in this cell may not be shared with an occasion of the NES SSB. For example, SSBs may be transmitted on the same sync raster, and a normal SSB may be transmitted as a cell-defining SSB, whereas a NES or on-demand SSB may be transmitted as a non-cell-defining SSB. In this case, it may be difficult to share SSB occasions because the SSBs need to be received at different frequencies.

Therefore, information on the occasions may be transmitted in advance via a PCell. To this end, configuration information for the SSB configuration in Table 37 needs to be transmitted identically for the on-demand SSB, so that the UE is able to recognize a separate SSB configuration and receive the SSB.

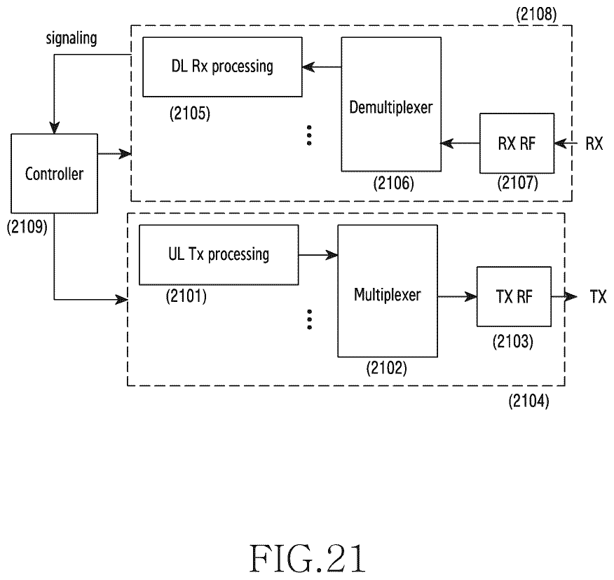

FIG. 21 illustrates a UE transceiving device according to an embodiment of the disclosure. For convenience of description, illustration and description of devices having no direct relevance to the disclosure may be omitted herein, according to an embodiment of the disclosure.

Referring to FIG. 21, the UE may include a transmitter 2104 including an uplink transmission processing block 2101, a multiplexer 2102, and a transmission RF block 2103, a receiver 2108 including a downlink reception processing block 2105, a demultiplexer 2106, and a reception RF block 2107, and a controller 2109. The controller 2209 may control the respective constituent blocks of the receiver 2108 for receiving data channels or control channels transmitted by the base station and the respective constituent blocks of the transmitter 2104 for transmitting uplink signals, as described above.

The uplink transmission processing block 2101 in the transmitter 2104 of the UE may generate signals to be transmitted, by performing processes such as channel coding and modulation. A signal generated by the uplink transmission processing block 2101 may be multiplexed with another uplink signal by the multiplexer 2102, signal-processed by the transmission RF block 2103, and then transmitted to the base station.

The receiver 2108 of the UE demultiplexes signals received from the base station and distributes the same to each downlink reception processing block. The downlink reception processing block 2105 may acquire control information or data transmitted by the base station by performing processes such as demodulation and channel decoding with regard to downlink signals from the base station. The receiver 2108 of the UE may apply the result of output from the downlink reception processing block to the controller 2109, thereby supporting the operation of the controller 2109.

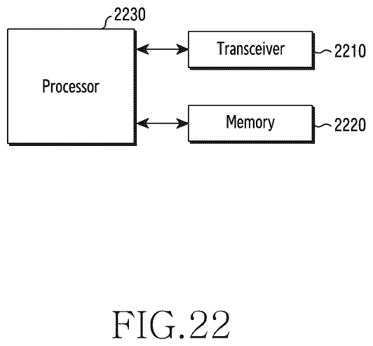

FIG. 22 illustrates a UE according to an embodiment of the disclosure.

As illustrated in FIG. 22, the UE of the disclosure may include a processor 2230, a transceiver 2210, and a memory 2220. However, components of the UE are not limited to the above-described example. For example, the UE may include a larger or smaller number of components than the above-described components. In addition, the processor 2230, the transceiver 2210, and the memory 2220 may be implemented in the form of a single chip. According to an embodiment, the transceiver 2210 of FIG. 22 may include the transmitter 2104 and the receiver 2108 of FIG. 21. Also, the processor 2230 of FIG. 22 may include the controller 2109 of FIG. 21.

According to an embodiment, the processor 2230 may control a series of processes such that the UE can operate according to the above-described embodiments of the disclosure. For example, according to an embodiment of the disclosure, the controller 2230 may control the components of the UE to perform transmission and reception methods of the UE according to whether the base station mode is a base station power saving mode or a base station normal mode. The processor 2230 may include one or multiple processors, and the processor 2230 may execute programs stored in the memory 2220 to perform transmission and reception operations of the UE in a wireless communication system employing the above-described operations of the disclosure.

The transceiver 2210 may transmit/receive signals with the base station. The signals transmitted/received with the base station may include control information and data. The transceiver 2210 may include an RF transmitter configured to up-convert and amplify the frequency of transmitted signals, an RF receiver configured to low-noise-amplify received signals and down-convert the frequency thereof, and the like. However, this is only an embodiment of the transceiver 2210, and the components of the transceiver 2210 are not limited to the RF transmitter and the RF receiver. In addition, the transceiver 2210 may receive signals through a radio channel, output the same to the processor 2230, and transmit signals output from the processor 2230 through the radio channel.

According to an embodiment, the memory 2220 may store programs and data necessary for the operation of the UE. In addition, the memory 2220 may store control information or data included in signals transmitted/received by the UE. The memory 2220 may include storage media such as a ROM, a RAM, a hard disk, a CD-ROM, and a DVD, or a combination of storage media. In addition, the memory 2220 may include multiple memories. According to an embodiment, the memory 2220 may store programs for performing transmission and reception operations of the UE according to whether the base station mode in the above-described embodiments of the disclosure is a base station power saving mode or a base station normal mode.

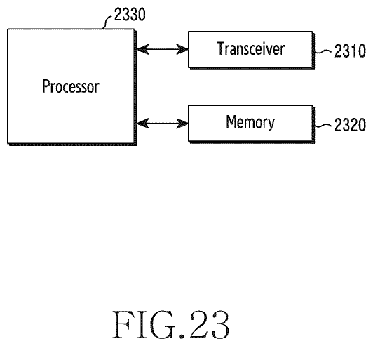

FIG. 23 illustrates a base station according to an embodiment of the disclosure.

As illustrated in FIG. 23, the base station of the disclosure may include a processor 2330, a transceiver 2310, and a memory 2320. However, components of the base station are not limited to the above-described example. For example, the base station may include a larger or smaller number of components than the above-described components. In addition, the processor 2330, the transceiver 2310, and the memory 2320 may be implemented in the form of a single chip.

The processor 2330 may control a series of processes such that the base station can operate according to the above-described embodiments of the disclosure. For example, according to an embodiment of the disclosure, the controller 2330 may control the components of the base station to perform UE scheduling methods according to whether the base station mode is a base station power saving mode or a base station normal mode. The processor 2330 may include one or multiple processors, and the processor 2330 may execute programs stored in the memory 2320 to perform transmission and reception operations of the UE in a wireless communication system employing the above-described operations of the disclosure.

The transceiver 2310 may transmit/receive signals with the UE. The signals transmitted/received with the UE may include control information and data. The transceiver 2310 may include an RF transmitter configured to up-convert and amplify the frequency of transmitted signals, an RF receiver configured to low-noise-amplify received signals and down-convert the frequency thereof, and the like. However, this is only an embodiment of the transceiver 2310, and the components of the transceiver 2310 are not limited to the RF transmitter and the RF receiver. In addition, the transceiver 2310 may receive signals through a radio channel, output the same to the processor 2330, and transmit signals output from the processor 2330 through the radio channel.

According to an embodiment, the memory 2320 may store programs and data necessary for operations of the base station. In addition, the memory 2320 may store control information or data included in signals transmitted/received by the base station. The memory 2320 may include storage media such as a ROM, a RAM, a hard disk, a CD-ROM, and a DVD, or a combination of storage media. In addition, the memory 2320 may include multiple memories. Furthermore, according to an embodiment, the memory 2320 may store programs for performing the above-described methods according to embodiments of the disclosure.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

In addition, the programs may be stored in an attachable storage device which can access the electronic device through communication networks such as the Internet, Intranet, local area network (LAN), wide LAN (WLAN), and storage area network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of embodiments of the disclosure and help understanding of embodiments of the disclosure, and are not intended to limit the scope of embodiments of the disclosure. That is, it will be apparent to those skilled in the art that other variants based on the technical idea of the disclosure may be implemented. Also, the above respective embodiments may be employed in combination, as necessary. For example, a part of one embodiment of the disclosure may be combined with a part of another embodiment to operate a base station and a terminal. As an example, a part of a first embodiment of the disclosure may be combined with a part of a second embodiment to operate a base station and a terminal. Moreover, although the above embodiments have been described based on the FDD LTE system, other variants based on the technical idea of the embodiments may also be implemented in other communication systems such as TDD LTE, and 5G, or NR systems.

In the drawings in which methods of the disclosure are described, the order of the description does not always correspond to the order in which steps of each method are performed, and the order relationship between the steps may be changed or the steps may be performed in parallel.

In the drawings in which methods of the disclosure are described, the order of the description does not always correspond to the order in which steps of each method are performed, and the order relationship between the steps may be changed or the steps may be performed in parallel.

In addition, in methods of the disclosure, some or all of the contents of each embodiment may be implemented in combination without departing from the essential spirit and scope of the disclosure.

Various embodiments of the disclosure have been described above. The above description of the disclosure is for the purpose of illustration, and is not intended to limit embodiments of the disclosure to the embodiments set forth herein. Those skilled in the art will appreciate that other specific modifications and changes may be easily made to the forms of the disclosure without changing the technical idea or essential features of the disclosure. The scope of the disclosure is defined by the appended claims, rather than the above detailed description, and the scope of the disclosure should be construed to include all changes or modifications derived from the meaning and scope of the claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a terminal in a wireless communication system, the method comprising:
receiving, from a first base station, configuration information on an on-demand synchronization signal block (SSB);
receiving, from the first base station, a first message indicating a reception of the on-demand SSB;
transmitting, to the first base station, an acknowledgement message in response to receiving the first message; and
receiving, from a second base station, the on-demand SSB based on the configuration information after at least one slot from a slot in which the acknowledgement message is transmitted.

2. The method of claim 1, wherein the message indicating the reception of the on-demand SSB is a radio resource control (RRC) message or a medium access control (MAC) control element (CE) message.

3. The method of claim 1, further comprising:
receiving, from the first base station, a second message for deactivating the on-demand SSB.

4. The method of claim 1, wherein a time location of the on-demand SSB does not overlap with a time location of another SSB, and
wherein the configuration information includes information on resources for the reception of the on-demand SSB.

5. The method of claim 1, wherein the first base station is associated with a primary cell (PCell), and
wherein the second base station is associated with a secondary cell (SCell).

6. A method performed by a first base station in a wireless communication system, the method comprising:
transmitting, to a terminal, configuration information on an on-demand synchronization signal block (SSB);
transmitting, to the terminal, a first message indicating a transmission of the on-demand SSB; and
receiving, from the terminal, an acknowledgement message in response to transmitting the first message,
wherein the on-demand SSB based on the configuration information is transmitted after at least one slot from a slot in which the acknowledgement message is received.

7. The method of claim 6, wherein the message indicating the transmission of the on-demand SSB is a radio resource control (RRC) message or a medium access control (MAC) control element (CE) message.

8. The method of claim 6, further comprising:
transmitting, to the terminal, a second message for deactivating the on-demand SSB.

9. The method of claim 6, wherein a time location of the on-demand SSB does not overlap with a time location of another SSB, and
wherein the configuration information includes information on resources for reception of the on-demand SSB.

10. The method of claim 6, wherein the first base station is associated with a primary cell (PCell), and
wherein a second base station is associated with a secondary cell (SCell).

11. A terminal in a wireless communication system, the terminal comprising:
a transceiver; and
at least one processor coupled with the transceiver and configured to:
receive, from a first base station, configuration information on an on-demand synchronization signal block (SSB),
receive, from the first base station, a first message indicating a reception of the on-demand SSB,
transmit, to the first base station, an acknowledgement message in response to receiving the first message, and
receive, from a second base station, the on-demand SSB based on the configuration information after at least one slot from a slot in which the acknowledgement message is transmitted.

12. The terminal of claim 11, wherein the message indicating the reception of the on-demand SSB is a radio resource control (RRC) message or a medium access control (MAC) control element (CE) message.

13. The terminal of claim 11, wherein the at least one processor is further configured to:
receive, from the first base station, a second message for deactivating the on-demand SSB.

14. The terminal of claim 11, wherein a time location of the on-demand SSB does not overlap with a time location of another SSB, and
wherein the configuration information includes information on resources for the reception of the on-demand SSB.

15. The terminal of claim 11, wherein the first base station is associated with a primary cell (PCell), and
wherein the second base station is associated with a secondary cell (SCell).

16. A first base station in a wireless communication system, the base station comprising:
a transceiver; and
at least one processor coupled with the transceiver and configured to:
transmit, to a terminal, configuration information on an on-demand synchronization signal block (SSB),
transmit, to the terminal, a first message indicating a transmission of the on-demand SSB, and
receive, from the terminal, an acknowledgement message in response to transmitting the first message,
wherein the on-demand SSB based on the configuration information is transmitted after at least one slot from a slot in which the acknowledgement message is received.

17. The first base station of claim 16, wherein the message indicating the transmission of the on-demand SSB is a radio resource control (RRC) message or a medium access control (MAC) control element (CE) message.

18. The first base station of claim 16, wherein the at least one processor is further configured to:
transmit, to the terminal, a second message for deactivating the on-demand SSB.

19. The first base station of claim 16, wherein a time location of the on-demand SSB does not overlap with a time location of another SSB, and
wherein the configuration information includes information on resources for reception of the on-demand SSB.

20. The first base station of claim 16, wherein the first base station is associated with a primary cell (PCell), and
wherein a second base station is associated with a secondary cell (SCell).
